(19) United States
(12) Patent Application Publication
(10) Pub. No.: US 2016/0237302 A1
(43) Pub. Date: Aug. 18, 2016

(54) WATERBORNE COMPOSITIONS

(71) Applicants: Alison Margaret DAINES, Kelson, Lower Hutt (NZ); VICTORIA LINK LIMITED, Wellington (NZ)

(72) Inventors: Cameron James Tristram, Lower Hutt (NZ); Mark Glenny, Porirua (NZ); Simon Frances Robert Hinkley, Lower Hutt (NZ); Alison Margaret Daines, Lower Hutt (NZ)

(21) Appl. No.: 15/021,614

(22) PCT Filed: Sep. 12, 2014
(86) PCT No.: PCT/NZ2014/000200

§ 371 Date: Mar. 11, 2016

(30) Foreign Application Priority Data
Sep. 12, 2013 (NZ) 615465

(51) Int. Cl. C09D 161/20; C08G 12/00

(52) U.S. Cl. CPC C09D 161/20; C08G 12/00

(57) ABSTRACT

The present invention provides for compositions comprising at least one polyketone; and at least one acyl hydrazide; wherein, the polyketone comprises at least two levulinic acid moieties. The present inventions also provide for novel polyhydrazone compounds. Examples of completely water-soluble compositions comprising acyl hydrazide and polyketone that form polyhydrazones compounds are provided herein. The compositions and polyhydrazones of the present invention are useful in the preparation of coating materials and the formation of films.

### TECHNICAL FIELD

This invention relates to compositions comprising polyketones synthesised from levulinic acid derivable from renewable sources and acyl hydrazides, a process for their preparation, and uses of these compositions.

### BACKGROUND

Acyl hydrazides have been used extensively to cross-link acrylic films. Acyl hydrazides form covalent bonds between different polymer chains and can be used to modify properties of such polymer based films, for example modifying the mechanical strength and hardness (Kessel, Illsley et al. 2008).

Levulinic acids have been investigated for some time for their use as plasticizers. Such compounds range from ethyl-levulinate to longer-alkyl esters, polyols and benzyl derivatives (Leonard 1956). A series of alkyl (e.g. butyl, lauryl and benzyl) and polyol (e.g. 1,4-butandiol, glyceryl and ethylene glycol) derivatives were reported as suitable plasticizers for cellulose acetate and polyvinylchloride (Hachihama and Hayashi 1953).

Ketone-containing derivatives have also been proposed as cross-linking components of resins to modify film forming characteristics. One such example, discloses reacting carbonyls of diacetone acrylamide with hydrazides and the application of this product in waterborne coatings (Nakayama 2004). Another example is the use of acetoacetoxyethyl methacrylate-linked (see below) resins as cross-linkable acrylics in waterborne coatings (Esser, Devona et al. 1999).

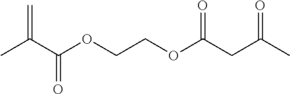

The synthesis of poly(acylhydrazones) containing pyridine moieties were also described by Oikawa and Tamura et al. [(1995) J. Appl. Polym. Sci., 58, 1205-1219]. The poly(acylhydrazones) were synthesized from 2,6-pyridinedicarboxaldehyde and each of five dihydrazides. The polymer synthesis was completed in the organic solvent DMSO to generate, in some cases, tough films. These films were assessed for their permeation selectivity using reverse osmosis or pervaporation (permeation/evaporation).

Kim et. al. [(1985) J. Korean Chem. Soc., 29, 543-551] describe a class of polyhydrazones that have been synthesised by solution polycondensation from equimolecular amounts of aromatic dialdehydes, such as para, meta, ortho-phthaldehyde, 5,5′-methylene-bis-salicyl aldehyde (PPTA, MPTA, OPTA, MBSA) and dihydrazides, 5,5′-methylene-bis-salicylic dihydrazide (MBSDH), terephthalic dihydrazides (TDH), sebacic dihydrazide (SDH) in DMF-CH₃COOH solution. The solubility characteristics, spectral, and thermal properties of the synthesised polyhydrazones and their metal chelates were also studied. These polyhydrazones and their metal chelates, except the polyhydrazone prepared from OPTA-MBSDH, were described as insoluble in common organic solvents such as methanol, acetone, chloroform, tetrahydrofuran and dimethylsulfoxide.

Hirose, Hatakeyama and Hatakeyama [(1983) Sen'i Gakkaishi 39, T496-T500] reported the synthesis of polyhydrazones from bis-methoxybenzaldehydes with dihydrazides in DMSO at 80° C. The polymers were reported as crystalline and preliminary thermal analysis was completed detailing glass-transition and decomposition temperatures.

Roberts and Thomas [(1981) Makromol. Chem., 182, 2611-2617] investigated the synthesis of poly(acylhydrazones) from aldarodihydrazides, principally D-glucarodihydrazide. Polymers were produced by reaction of the dihydrazides with dialdehydes, aliphatic ketoaldehydes or diketones. However, aromatic ketoaldehydes or aromatic diketones were not investigated. The polymers had only limited solubilities and were not appreciably improved by co-polymerization. The polymers underwent a tautomeric change on treatment with acid or alkali and gave yellow-coloured polymers. Of the poly(acylhydrazones) prepared, the product from D-glucarodihydrazide and 2,3-butanedione were shown to have the best overall properties that resulted in strong, flexible, colourless films when cast from a DMSO solution. However, the main focus of their teachings was the generation of a glucarate derived diacylhydrazide (below) which formed insoluble polymers.

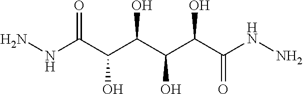 [SMILES: NNC(=O)[C@@H](O)[C@@H](O)[C@H](O)[C@@H](O)C(=O)NN]

Korshak, Krongauz et. al. [Bulletin of the academy of sciences of the USSR. Division of the Chemical Sciences (1964) 13 (7): 1187-1192] formed a polyhydrazone which was precipitated to form a powder. This powder was treated at increased temperature and under vacuum to eliminate water to form a pyrazole ring polymer (see below) in quantitative yields. The polyhydrazones were all generated by reaction with adipic acid diacylhydrazide (ADH) and aromatic ketones. The reaction was performed in ethanol and the polymer had a tendency to precipitate or separate out of solution if it became too large.

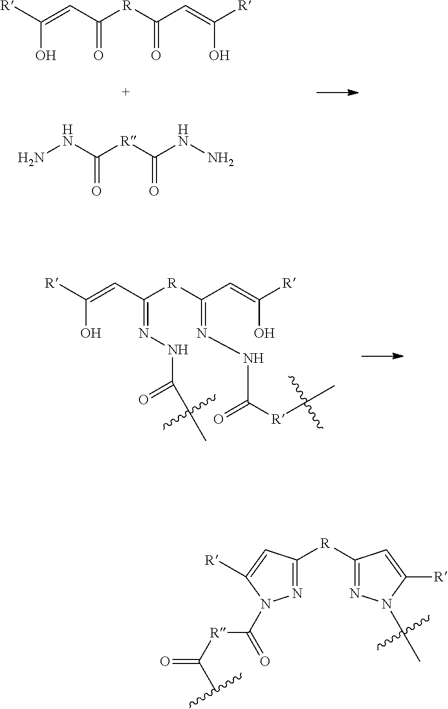

The polyhydrazones were of low molecular weight and formed powders which were soluble in standard organic solvents such as ethanol.

Michel and Murphey [(1963) J. Appl. Polym. Sci., 7, 617-624], taught that a series of linear poly(acylhydrazones) that were prepared by the condensation of equivalent quantities of dihydrazides with dialdehydes at room temperature in carefully purified solvents, providing polymer solutions of about 10%. Generally, the polymers produced were of low molecular weights and the films that were formed showed only moderate hydrolytic and thermal stabilities. However, the films had to be cast from non-aqueous high-toxicity solvents such as hexamethyl phosphoramide and DMSO. These films were also treated with cupric acetate, to render them insoluble.

Hirose and Hatakeyama, [(1982) Japanese Patent 57088156A; Chem. Abstr., 97, 163707.] also demonstrate a series of linear polyacylhydrazones formed from methoxy bisbenzyl aldehydes and alkyl acylhydrazides as heat-resistant materials, however synthesis required above ambient temperatures and organic solvents (dimethylacetamide (DMAc), DMSO).

Emmons [(1980) U.S. Pat. No. 4,210,565; (1980) Chem. Abstr. 60, 75763] described coating compositions that contained solutions of aqueous dispersions of a polymer formed from aldehydes, α, β-unsaturated acids and alkyl esters of methacrylic acid and acrylic acid. The ambient or low temperature curable coating compositions were adapted to coat a rigid substrate, where the substrate comprises: a polymer made from a polymerisable aldehyde, a ethyleneically unsaturated monomer; and curing agents selected from dicarboxylic acid bis-hydrazides, dicarboxylic acid bis-hydrazones, acrylic oligomers, and low molecular weight acrylic solution polymers that contained a plurality of pendant hydrazide or hydrazone groups and dicarboxylic acid dihydrazides. The polymers provided low temperature curable solutions for industrial coatings, furniture, appliances and automobile finishes.

U.S. Pat. No. 3,124,559 related to synthetic linear polymers and methods for preparing them. Specifically, the polymers formed by the reaction of dihydrazide derivatives of dibasic acids with dialdehydes. U.S. Pat. No. 3,124,559 details examples of polymers synthesised in ethanol and an acetic acid catalyst by reaction between sebacic dihydrazide and gluteraldehyde; sebacic dihydrazide and terephthalaldehyde; and succinic dihydrazide and glyoxal. However, the application of such polymers as coating components was alluded to without exemplification.

U.S. Pat. No. 3,354,122 provided a process for preparing tractable polyacylhydrazones from aldehydes that had inherent viscosity of at least 0.4. This process reacted equimolar amounts of a dicarboxylic acid dihydrazide with a dialdehyde in organic solvents (including dimethylsulfoxide). It was reported that polymers made from diketones alone (as opposed to mixtures with dialdehydes) were unsuitable due to the observation of “molecular weights below the lower limits of this invention.” We interpret this to imply that an inherent viscosity of 0,4 was not achieved and similarly compounds of high molecular weight, which was the object of the invention.

Levrand et al. describe the reaction of ketone and aldehyde species with acylhydrazides and polyacylhydrazides in organic solvents including methanol, ethanol and ethanol:water solutions, for the fragrance industry. The dynamic nature of the hydrazone linkage is argued to generate a controlled release environment where the volatile ketone or aldehyde component is slowly evaporated (Levrand, Fieber et al. 2007). This work does not utilize larger molecules, such as polyketone species nor those generated from poly-levulinyl polyesters.

Deng and Tang et al. [(2010) Macromolecules 43(3): 1191-1194] taught that gels that had covalent and reversible non-covalent interactions formed three-dimensional polymer gels. The polymer networks were based on acylhydrazone covalent bonds that were stable under ambient conditions. These gels showed typical properties of chemical gels that could be switched back to their starting materials by treatment with base.

Ono, Fujii, Nobori and Lehn [(2007) Chemical Communications (1): 46-48] investigated the mechanical properties of acylhydrazone dynamic polymers, which were converted from soft polymers to hard polymers by incorporation of rigid monomeric components into the polymer backbone. This involved synthesis of siloxane derived spacer units. This work by Ono was continued by Chow, Fujii and Li [(2007) Angewandte Chemie 119(26): 5095-5098] who taught the preparation of neutral metallosupramolecular flexible polymer films by coordinating neutral supramolecular polymers, made from aldehydes, with metal ions, which could be rationally designed in a self-assembled manner. The dynamic coordination polymers were capable of interchanging the ligands or metal ions, which allowed for further fine tuning of the polymer film's features.

Deng and Li et. al. [(2012) ACS Macro Letters 1(2): 275-279] reported that dynamic polymer hydrogels were prepared by combining acylhydrazone and disulphide bonds, and that these polymers had an environmental self-healing ability. The hydrogel was able to automatically self-repair damage, at either acidic or basic pH (but not neutral), through acylhydrazone exchange to disulfide exchange reactions. The application of the hydrogels and their self-healing abilities were explored with a tridentate pegylated species, which utilised the flexibility observed with PEG constituents.

To date, all film forming agents for water soluble polyhydrazone compounds that utilise polyhydrazones (as the principle film forming agent) prepared from acyl hydrazides and polyketones in compositions are generated from synthetic sources rather than renewable resources.

In today's modern environmentally aware age there is a need for environmentally friendly, low toxicity compounds and compositions that can be prepared easily from renewable sources, and which avoid the use of petrochemically derived, volatile and/or toxic organic solvents.

The chemistry of polyhydrazones from the prior art is surprisingly variable and unpredictable. The chemistry depends on the reagents used, the linearity, and the crosslinking of the polymers prepared. In addition, the present inventors have not found any prior art that specifically teaches for:
a) the use of acyl hydrazides in the formation of polyhydrazones as the principle component in polymer forming mechanisms using the renewable ingredient levulinic acid as a principal component;
b) the use of levulinic acid's ketone as the reactive moiety;
c) a polyester-linkage in the polymer backbone coupled with a polyhydrazone as the polymer composition; and
d) water as the solvent.

It is therefore an object of the invention to provide compositions from which glossy, resilient, films can be generated, or to at least provide the public with a useful alternative

It is also an object of the invention, to provide polyhydrazone compounds in a waterborne solution, from which glossy, resilient films can be generated, or to at least provide the public with a useful alternative.

It is another object of the invention of the invention to provide a process for preparing compositions comprising polyhydrazone compounds in a waterborne solution, from which glossy, resilient, films can be formed, or to at least provide the public with a useful alternative.

A further object of the invention is to provide polyhydrazone compounds and compositions derived from renewable levulinic acid that can be used in coating compositions, or to at least provide the public with a useful alternative to current coating compositions.

It is yet another object of the invention to provide polyhydrazone compounds that are formed from renewable ingredients, or to at least provide the public with a useful alternative.

Any discussion of the prior art throughout the specification should in no way be considered as an admission that such prior art is widely known or forms part of the common general knowledge in the field.

### SUMMARY OF THE INVENTION

The present invention provides compositions comprising polyketones derived from levulinic acid, and acyl hydrazides. The compositions are particularly useful for use as water-borne coating compositions.

### DETAILED DESCRIPTION OF THE INVENTION

It has been found by the present inventors that coupling levulinic acid's ketone to acyl hydrazides occurs rapidly in solution, even in water. It is considered that this process in water differs from the well-known crosslinking application processes of using adipic acid diacylhydrazide (ADH) in architectural coating technologies. That is, in current film forming reactions using ADH as the crosslinking agent, the acrylic (or other latex), which is in emulsion form, does not come into contact with ADH until application onto the surface to be coated and the film formation process is underway. Acrylic crosslinking systems are often reactive only with the evaporation of water and this is due to the water solubility of the acrylic cross-linker adipic dihydrazide, which does not react with the polymer resin when it is an emulsion.

Examples of completely water-soluble compositions comprising acyl hydrazide and polyketone that form polyhydrazones compounds are provided herein.

In a first aspect, the present invention provides a composition comprising:
i) at least one polyketone; and
ii) at least one acyl hydrazide;
   wherein, the polyketone comprises at least two levulinic acid moieties.

The polyketone of the first aspect may be of Formula (I)

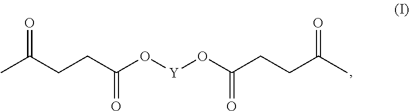

wherein Y is a C₂₋₃₀ alkylene, C₂₋₁₀ alkenyl, C₃₋₁₂ carbocycle or C₅₋₁₂ aryl, wherein any one of the C₂₋₃₀ alkylene, C₂₋₁₀ alkenyl, C₃₋₁₂ carbocycle or C₅₋₁₂ aryl may be independently optionally substituted with any one or more substituents selected from R.

R is selected from C₁₋₁₀ aliphatic, amino, (C₁₋₁₀ aliphatic)amino, amido, (C₁₋₁₀ aliphatic)amido, aryl, (C₁₋₁₀ aliphatic)aryl, cyano, carbonyl, heteroatoms (O, N, S, P, wherein the heteroatoms may be further substituted with hydrogen, aliphatic, amino, aryl, heteroaryl, heterocyclyl), hydroxy, halogen (Cl, F, Br, I) heteroaryl, and nitro, wherein aliphatic means any independently selected, optionally substituted, branched or straight chain C₁₋₁₀ alkylene, C₂₋₁₀ alkenyl, C₂₋₁₀ alkynyl.

Y may be independently selected from a branched or straight chain C₂₋₃₀ alkylene, wherein any one of the branched or straight C₂₋₃₀ alkylene may be optionally substituted with any one or more of R.

Alternatively, Y is an optionally substituted C₅₋₁₂aryl. Preferably the optional substituents are straight or branched chain C₁₋₁₀ aliphatic. Preferably, the optional substituent is selected from C₁₋₁₀ alkylene moiety. Preferably the optionally substituted C₅₋₁₂aryl is

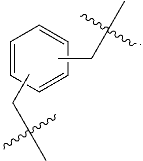

Preferably, Y is an independently selected, optionally substituted, branched or straight chain C₂₋₂₀ alkylene. More preferably, Y is an independently selected, optionally substituted, branched or straight chain C₂₋₁₀ alkylene. Y may also be an independently selected, optionally substituted, branched or straight chain C₂₋₆ alkylene. Yet even more preferably, the C₂₋₃₀ alkylene is selected from:

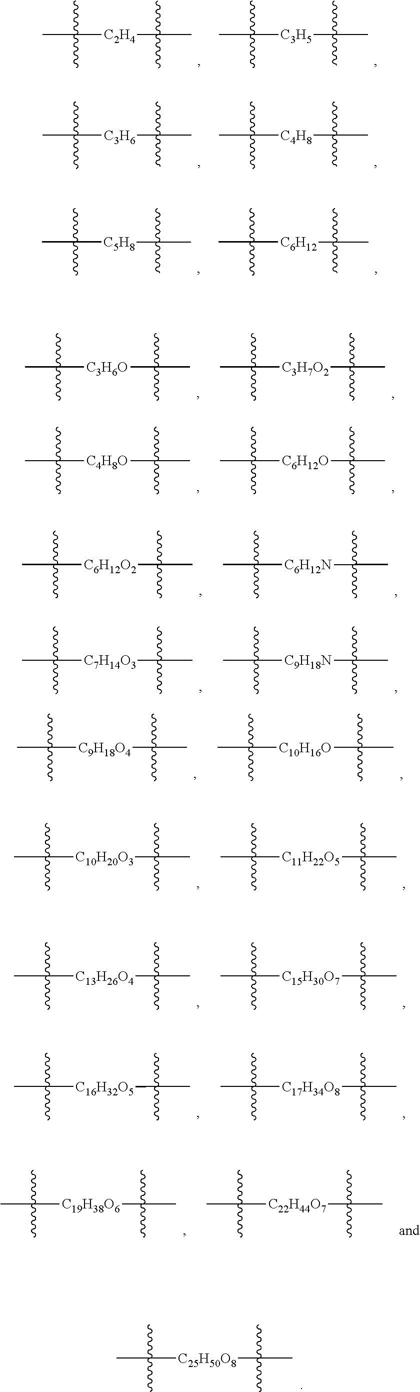

Even more preferably, Y is selected from:

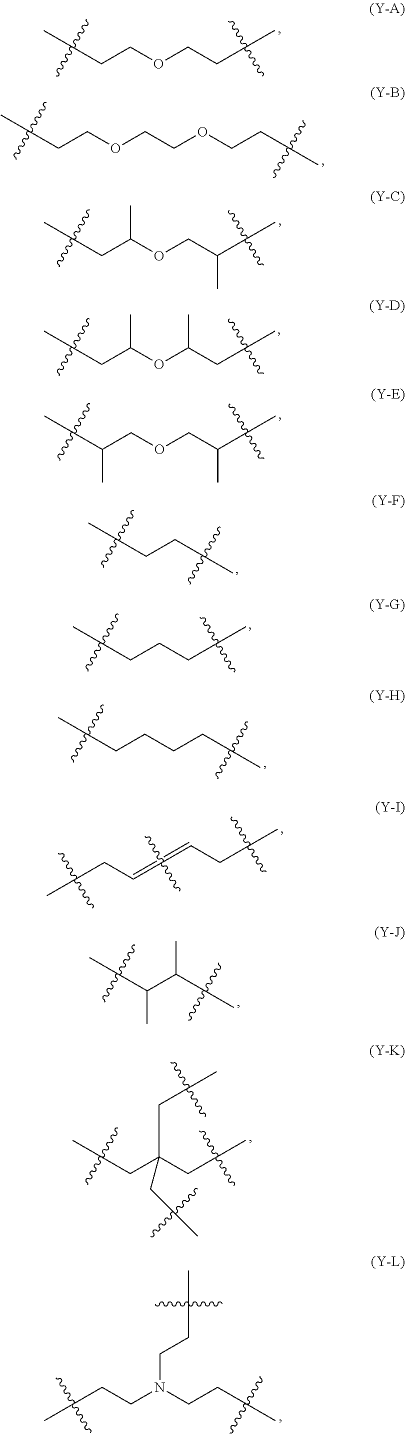

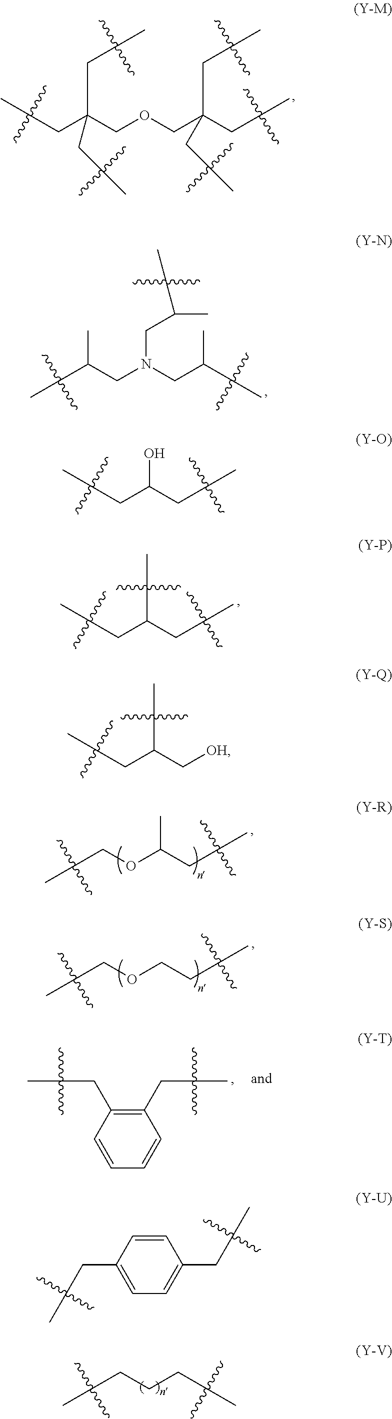

wherein n′ is from 3 to 8 repeating units.

Y may also be independently selected from a branched or straight chain C₂₋₂₀ alkenyl, wherein the double bond may be E or Z, and the alkenyl chain may be optionally substituted with any one or more substituents selected from R. Preferably, Y is an independently selected optionally substituted branched or straight chain C₂₋₁₀ alkenyl. Yet even more preferably, Y is an independently selected optionally substituted branched or straight chain C₂₋₁₀ alkenyl of formula:

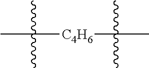

Even more preferably, Y is

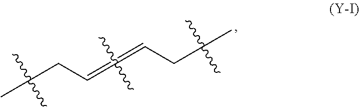

wherein

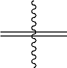

means E or Z carbon-carbon double bond isomers.

In some embodiments of the first aspect, Y is independently selected from an optionally substituted C₅₋₁₂ aryl wherein any one of the C₅₋₁₂ aryl may be optionally substituted with any one or more substituents selected from R.

In some embodiments of the first aspect, the compound of Formula (I) is selected from:

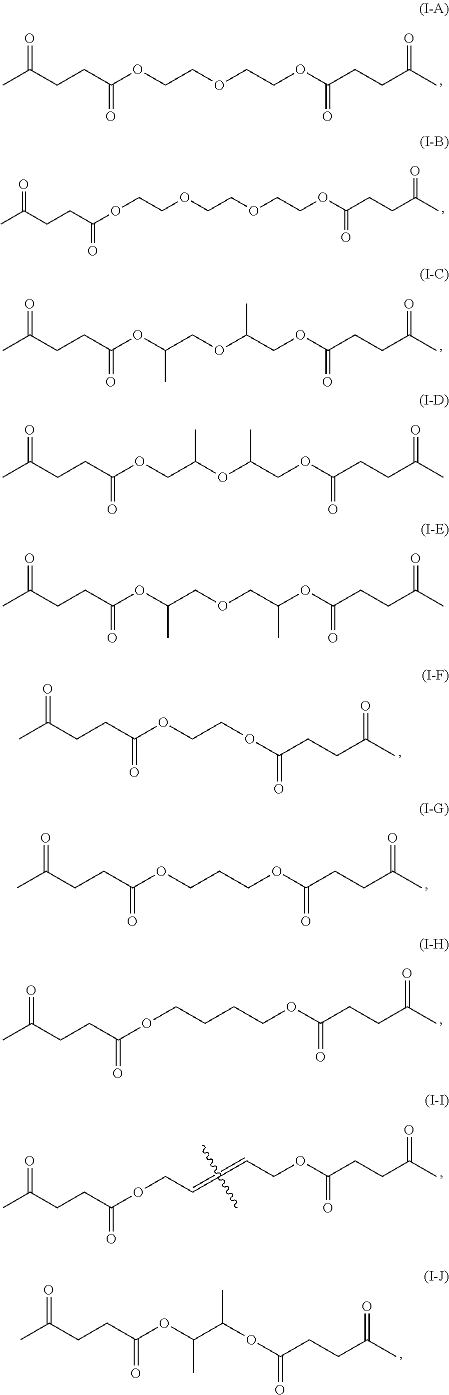

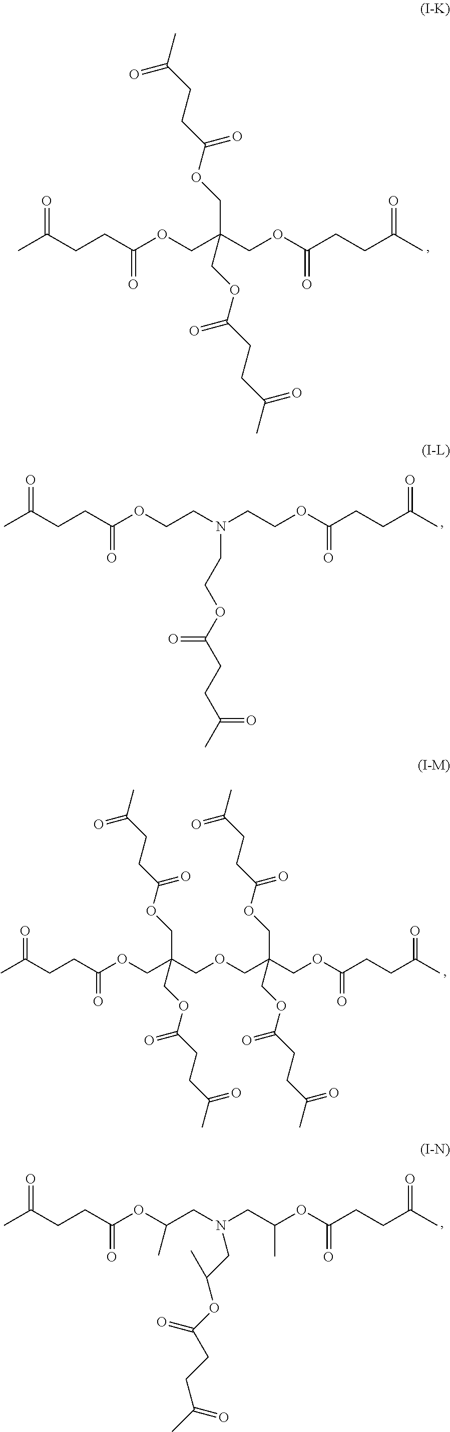

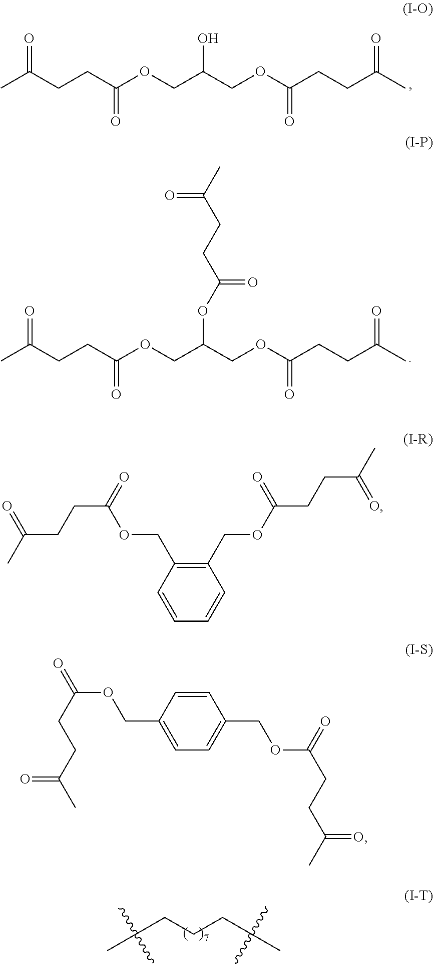

wherein

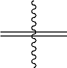

means E or Z carbon-carbon double bond isomers.

In an embodiment of the first aspect, the polyketone is derived from renewable levulinic acid.

In further embodiments of the first aspect, the acyl hydrazide is a of general Formula (II)

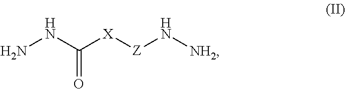

wherein X is absent, or is selected from a branched, straight chain C₁₋₂₀ alkylene, C₂₋₂₀ alkenyl, C₃₋₁₂ carbocycle or C₅₋₁₂ aryl. Preferably, X is a C₂₋₁₀ alkylene, C₂₋₁₀ alkenyl, or C₅₋₁₂ aryl wherein any of C₂₋₁₀ alkylene, C₂₋₁₀ alkenyl, C₂₋₁₀ alkynyl, or C₅₋₁₂ aryl may be optionally substituted with any one or more substituents selected from R.

R is selected from C₁₋₁₀ aliphatic, amino, (C₁₋₁₀ aliphatic)amino, amido, (C₁₋₁₀ aliphatic)amido, aryl, (C₁₋₁₀ aliphatic)aryl, cyano, carbonyl, heteroatoms (O, N, S, P, wherein the heteroatoms may be further substituted with hydrogen, aliphatic, amino, aryl, heteroaryl, heterocyclyl), hydroxy, wherein aliphatic means any independently selected, optionally substituted, branched or straight chain C₁₋₁₀ alkylene, C₂₋₁₀ alkenyl, C₂₋₁₀ alkynyl.

X may be independently selected from a branched or straight chain C₁₋₂₀ alkylene, wherein any one of the C₁₋₂₀ alkylene may be optionally substituted with any one or more substituents selected from R. Preferably, X is an independently selected, optionally substituted, branched or straight chain C₂₋₁₀ alkylene. X may also be an independently selected, optionally substituted, branched or straight chain C₂₋₆ alkylene. Preferably, the independently selected, optionally substituted C₂₋₆ alkylene is

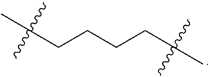 [SMILES: *CCCC*]

### Alternatively, X is

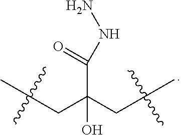 [SMILES: *CC(O)(C*)C(=O)NN]

In another embodiment of the first aspect, X is independently selected from a branched or straight chain C₂₋₁₀ alkenyl, wherein any one of the C₂₋₁₀ alkenyl may be optionally substituted with any one or more substituents selected from R. Preferably, X is an independently selected, optionally substituted, branched or straight chain C₂₋₁₀ alkenyl. X may also be an independently selected, optionally substituted, branched or straight chain C₂₋₆ alkenyl.

In yet further embodiments of the first aspect, X may be independently selected from an optionally substituted C₅₋₁₂ aryl wherein any one of the C₅₋₁₂ aryl may be optionally substituted with any one or more substituents selected from R. Preferably, the independently selected optionally substituted C₅₋₁₂ aryl is

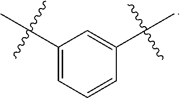 [SMILES: *c1cccc(*)c1]

In an embodiment of the first aspect, Z is absent or is C═O.

In another embodiment of the first aspect, when X is

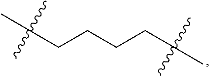 [SMILES: *CCCC*]

### Z is (C═O).

In another embodiment of the first aspect, when X is

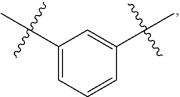 [SMILES: *c1cccc(*)c1]

### Z is (C═O).

In another embodiment of the first aspect, when X is

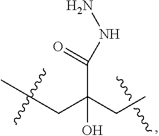

### Z is (C═O)

In another embodiment of the first aspect, when X is absent, Z is (C═O).

In another embodiment of the first aspect, X and Z are both absent.

In an embodiment of the first aspect, the compound of Formula (II) may be selected from:

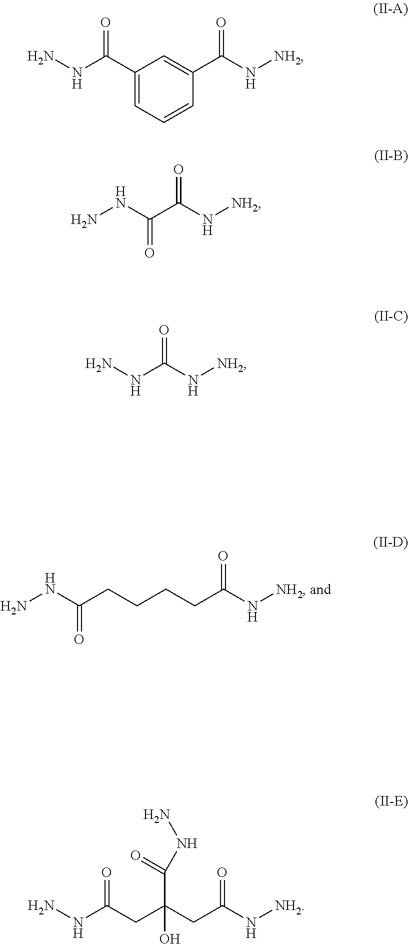 [SMILES: NNC(=O)c1cccc(C(=O)NN)c1 ; NNC(=O)C(=O)NN ; NNC(=O)NN ; NNC(=O)CCCCC(=O)NN ; NNC(=O)CC(O)(CC(=O)NN)C(=O)NN]

The acyl hydrazide and the polyketone of the first aspect may form the composition in a solvent. The solvent may be a polar solvent and/or water miscible. Preferably, the solvent is water or a water miscible solvent, or combinations thereof. Water miscible polar solvents include but are not limited to acetonitrile, dioxane, DMSO, DMAc, DMF, diethylene glycol, ethylene glycol, Texanol™ (chemical name-2,2,4-trimethyl-1,3-pentanediol monoisobutyrate), tetrahydrofuran, water or combinations thereof. Preferably the composition is a water-borne composition.

In an embodiment of the first aspect, the composition is non-toxic or is of low toxicity.

In an embodiment of the first aspect, the composition forms a gel in solution. Preferably the gel comprises a polyhydrazone compound.

In some embodiments of the first aspect, the composition comprises a reactive group ratio of acyl hydrazide:polyketone of about 90:10 to about 10:90. Preferably, a reactive group ratio of acyl hydrazide:polyketone of about 70:30 to about 30:70. Even more preferably, a reactive group ratio of acyl hydrazide:polyketone of about 47:53.

In some embodiments of the first aspect, the composition forms a gel in solution or a suspension. Preferably, the gel is formed in a solution or suspension of about 10 to about 80% w/v, even more preferably about 30 to about 60% w/v.

In an embodiment of the first aspect, the composition forms a film when the gel is applied to a surface, and the gel dries on the surface. Preferably, the film forms at a temperature of about 10° C. to about 50° C. Preferably, the gel dries to form the film over a period of from about 1 hour to about 24 hours, even more preferably, from about 1 hour to about 4 hours. Preferably, the film is a flexible film. Alternatively the film is a rigid film.

In some embodiments of the first aspect of the invention, the composition forms a film that has a glass transition temperature (T_{g}) of about 20° C. to about 130° C., preferably about 50° C. to about 100° C., preferably about 50° C. to about 80° C., preferably about 60° C. to about 80° C. Preferably the T_{g} is measured by differential scanning calorimetry (DSC).

In a second aspect, the invention provides a polyhydrazone compound of structural formula (III):

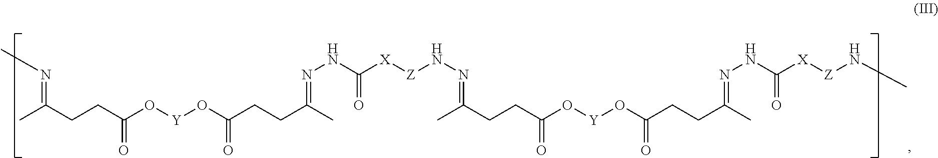

wherein
Y is an independently selected, optionally substituted, branched, straight chain, C₂₋₃₀ alkylene, C₂₋₂₀ alkenyl, a C₃₋₁₂ carbocycle, or C₅₋₁₂ aryl;
X is absent, or is an independently selected, optionally substituted branched, straight chain C₁₋₂₀ alkylene, C₂₋₂₀ alkenyl, or C₅₋₁₂ aryl;
Z is absent, or one or more carbonyl groups;
wherein the optional substituents are selected from one or more occurrences of R.

R is selected from C₁₋₁₀ aliphatic, amino, (C₁₋₁₀ aliphatic)amino, amido, (C₁₋₁₀ aliphatic)amido, aryl, (C₁₋₁₀ aliphatic)aryl, cyano, carbonyl, heteroatoms (O, N, S, P, wherein the heteroatoms may be further substituted with hydrogen, aliphatic, amino, aryl, heteroaryl, heterocyclyl), hydroxy, halogen (Cl, F, Br, I) heteroaryl, and nitro, wherein aliphatic means any independently selected, optionally substituted, branched or straight chain C₁₋₁₀ alkylene, C₂₋₁₀ alkenyl, C₂₋₁₀ alkynyl.

Y may be independently selected from a branched or straight chain C₂₋₃₀ alkylene, wherein any one of the branched or straight C₂₋₃₀ alkylene may be optionally substituted with any one or more of R.

Alternatively, Y is an optionally substituted C₅₋₁₂aryl. Preferably the optional substituents are straight or branched chain C₁₋₁₀ aliphatic. Preferably, the optional substituent is selected from C₁₋₁₀ alkylene moiety. Preferably the optionally substituted C₅₋₁₂aryl is

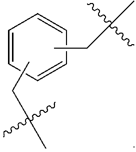

Preferably, Y is an independently selected, optionally substituted, branched or straight chain C₂₋₂₀ alkylene. Preferably, Y is an independently selected, optionally substituted, branched or straight chain C₂₋₁₀ alkylene. Y may also be an independently selected, optionally substituted, branched or straight chain C₂₋₆ alkylene. Yet even more preferably, the C₂₋₃₀ alkylene is selected from:

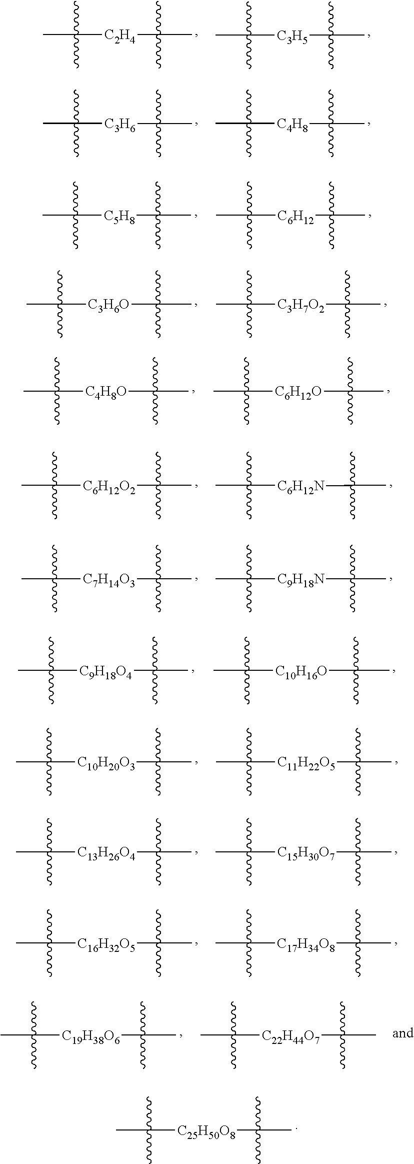

Even more preferably, Y is selected from:

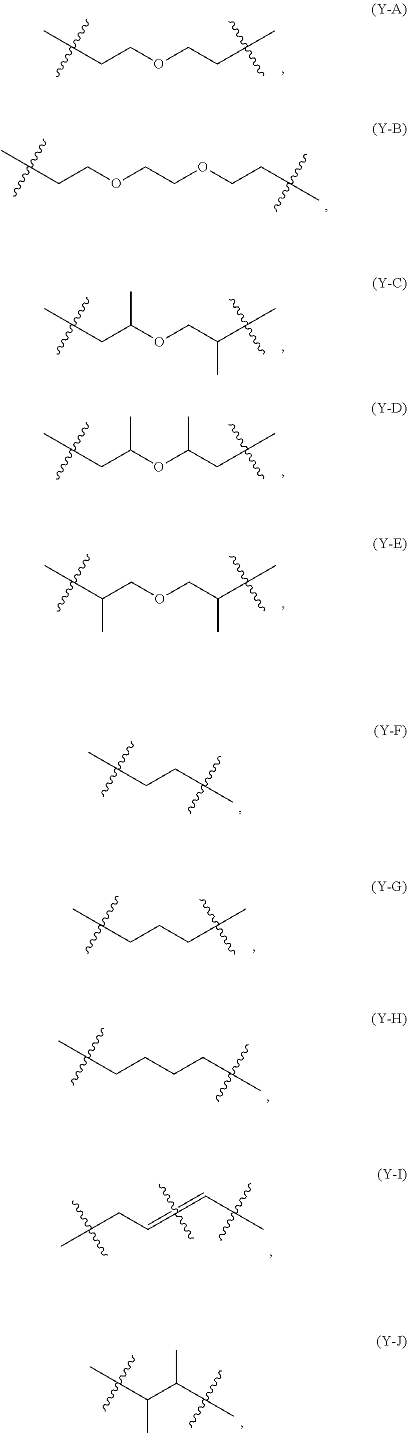

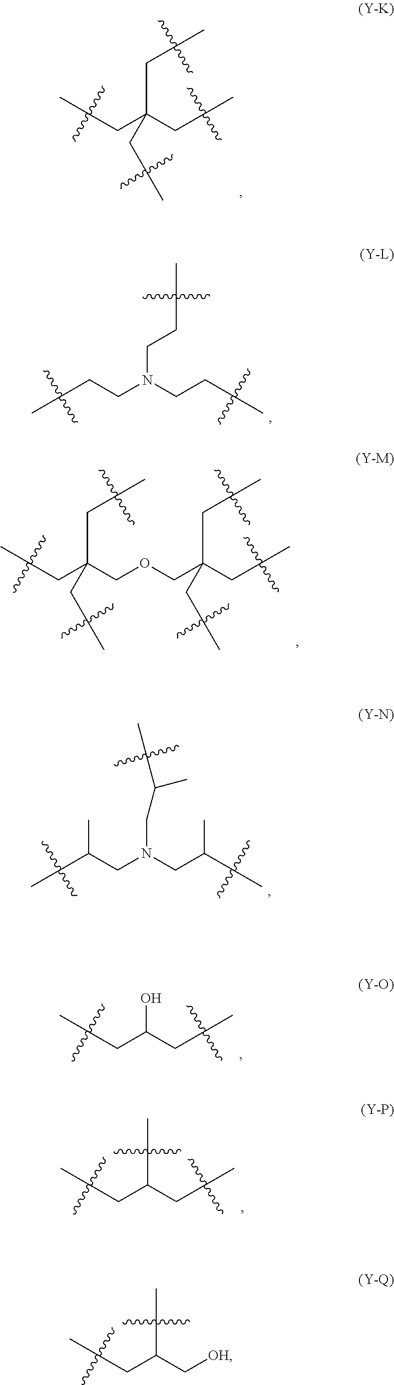

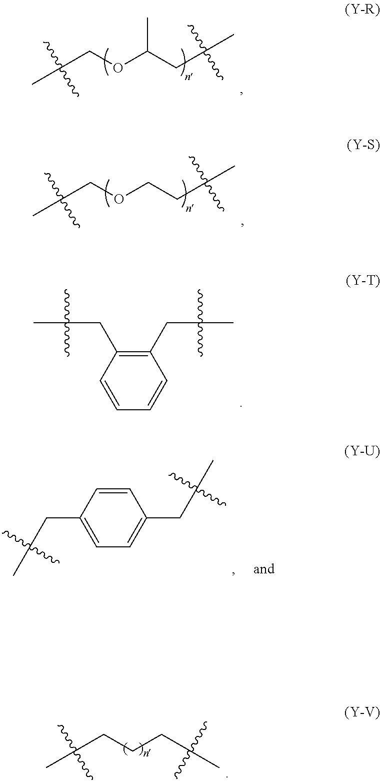

wherein n′ is from 3 to 8 repeating units.

Y may also be independently selected from a branched or straight chain C₂₋₂₀ alkenyl, wherein the double bond may be E or Z, and the alkenyl chain may be optionally substituted with any one or more substituents selected from R.

Preferably, Y is an independently selected optionally substituted branched or straight chain C₂₋₁₀ alkenyl. Yet even more preferably, Y is an independently selected optionally substituted branched or straight chain C₂₋₁₀ alkenyl of formula:

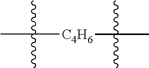

Even more preferably, Y

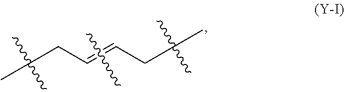

wherein

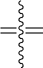

means E or Z carbon-carbon double bond isomers.

In some embodiments of the second aspect, Y is independently selected from an independently selected, optionally substituted C₅₋₁₂ aryl wherein any one of the C₅₋₁₂ aryl may be optionally substituted with any one or more substituents selected from R.

In an embodiment of the second aspect, the polyhydrazone is derived from renewable levulinic acid.

In further embodiments of the second aspect, the acyl hydrazide is a of general Formula (II)

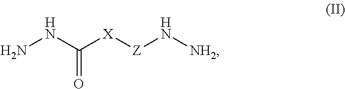

wherein X is absent, or is selected from a branched, straight chain C₁₋₂₀ alkylene, C₂₋₂₀ alkenyl, C₃₋₁₂ carbocycle or C₅₋₁₂ aryl. Preferably, X is a C₂₋₁₀ alkylene, C₂₋₁₀ alkenyl, or C₅₋₁₂ aryl wherein any of C₂₋₁₀ alkylene, C₂₋₁₀ alkenyl, C₂₋₁₀ alkynyl, or C₅₋₁₂ aryl may be optionally substituted with any one or more substituents selected from R.

R is selected from C₁₋₁₀ aliphatic, amino, (C₁₋₁₀ aliphatic)amido, amido, (C₁₋₁₀ aliphatic)amido, aryl, (C₁₋₁₀ aliphatic)aryl, cyano, carbonyl, heteroatoms (O, N, S, P, wherein the heteroatoms may be further substituted with hydrogen, aliphatic, amino, aryl, heteroaryl, heterocyclyl), hydroxy, wherein aliphatic means any independently selected, optionally substituted, branched or straight chain C₁₋₁₀ alkylene, C₂₋₁₀ alkenyl, C₂₋₁₀ alkynyl.

X may be independently selected from a branched or straight chain C₁₋₂₀ alkylene, wherein any one of the C₁₋₂₀ alkylene may be optionally substituted with any one or more substituents selected from R. Preferably, X is an independently selected, optionally substituted, branched or straight chain C₂₋₁₀ alkylene. X may also be an independently selected, optionally substituted, branched or straight chain C₂₋₆ alkylene. Preferably, the independently selected, optionally substituted C₂₋₆ alkylene is

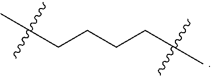 [SMILES: *CCCC*]

### Alternatively, X is

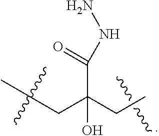

In another embodiment of the second aspect, X is independently selected from a branched or straight chain C₂₋₁₀ alkenyl, wherein any one of the C₂₋₁₀ alkenyl may be optionally substituted with any one or more substituents selected from R. Preferably, X is an independently selected, optionally substituted, branched or straight chain C₂₋₁₀ alkenyl. X may also be an independently selected, optionally substituted, branched or straight chain C₂₋₆ alkenyl.

In yet further embodiments of the second aspect, X may be independently selected from an optionally substituted C₅₋₁₂ aryl wherein any one of the C₅₋₁₂ aryl may be optionally substituted with any one or more substituents selected from R. Preferably, the independently selected optionally substituted C₅₋₁₂ aryl is

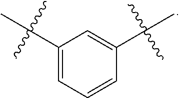 [SMILES: *c1cccc(*)c1]

In an embodiment of the second aspect, Z is absent or is one or more C═O.

In another embodiment of the second aspect, when X is

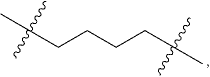 [SMILES: *CCCC*]

### Z is (C═O).

In another embodiment of the second aspect, when X is

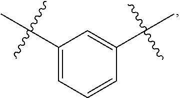 [SMILES: *c1cccc(*)c1]

### Z is (C═O).

In another embodiment of the second aspect, when X is

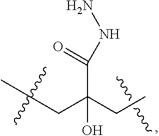

### Z is (C═O)

In another embodiment of the second aspect, when X is absent, Z is (C═O).

In another embodiment of the second aspect, X and Z are both absent.

In another embodiment of the second aspect, the invention provides a polyhydrazone compound of Formula (IV):

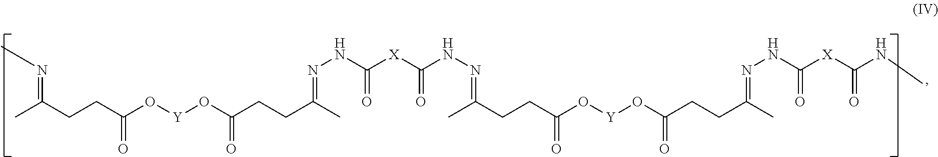

wherein
Y is an independently selected, optionally substituted, branched, straight chain, C₂₋₃₀ alkylene, C₂₋₂₀ alkenyl, a C₃₋₁₂ carbocycle, or C₅₋₁₂ aryl;
X is absent, or is an independently selected, optionally substituted branched, straight chain C₁₋₂₀ alkylene, C₂₋₂₀ alkenyl, or C₅₋₁₂ aryl;
   wherein the optional substituents are selected from one or more occurrences of R, and wherein X and Y are as hereinbefore described.

In an embodiment of the second aspect, the polyhydrazone may be linear, branched, or macrocyclic in structure.

In an embodiment of the second aspect, the polyhydrazone forms a gel in solution.

In an embodiment of the second aspect, the polyhydrazone is water soluble.

In a third aspect, the invention provides a process for preparing a composition, wherein the process comprises contacting:
i) at least one polyketone; and
ii) at least one acyl hydrazide,
   wherein, the polyketone comprises at least two levulinic acid moieties.

The polyketone of the third aspect may be of Formula (I)

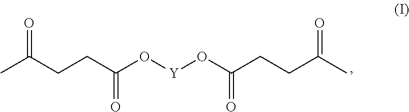

wherein Y is a C₂₋₃₀ alkylene, C₂₋₁₀ alkenyl, C₃₋₁₂ carbocycle or C₅₋₁₂ aryl, wherein any one of the C₂₋₃₀ alkylene, C₂₋₁₀ alkenyl, C₃₋₁₂ carbocycle or C₅₋₁₂ aryl may be independently optionally substituted with any one or more substituents selected from R.

R is selected from C₁₋₁₀ aliphatic, amino, (C₁₋₁₀ aliphatic)amino, amido, (C₁₋₁₀ aliphatic)amido, aryl, (C₁₋₁₀ aliphatic)aryl, cyano, carbonyl, heteroatoms (O, N, S, P, wherein the heteroatoms may be further substituted with hydrogen, aliphatic, amino, aryl, heteroaryl, heterocyclyl), hydroxy, wherein aliphatic means any independently selected, optionally substituted, branched or straight chain C₁₋₁₀ alkylene, C₂₋₁₀ alkenyl, C₂₋₁₀ alkynyl.

Y may be independently selected from a branched or straight chain C₂₋₃₀ alkylene, wherein any one of the branched or straight C₂₋₃₀ alkylene may be optionally substituted with any one or more of R.

Alternatively, Y is an optionally substituted C₅₋₁₂aryl. Preferably the optional substituents are straight or branched chain C₁₋₁₀ aliphatic. Preferably, the optional substituent is selected from C₁₋₁₀ alkylene moiety. Preferably the optionally substituted C₅₋₁₂aryl is

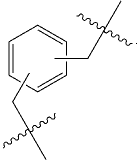

Preferably, Y is an independently selected, optionally substituted, branched or straight chain C₂₋₂₀ alkylene. Preferably, Y is an independently selected, optionally substituted, branched or straight chain C₂₋₁₀ alkylene. Y may also be an independently selected, optionally substituted, branched or straight chain C₂₋₆ alkylene. Yet even more preferably, the C₂₋₃₀ alkylene is selected from:

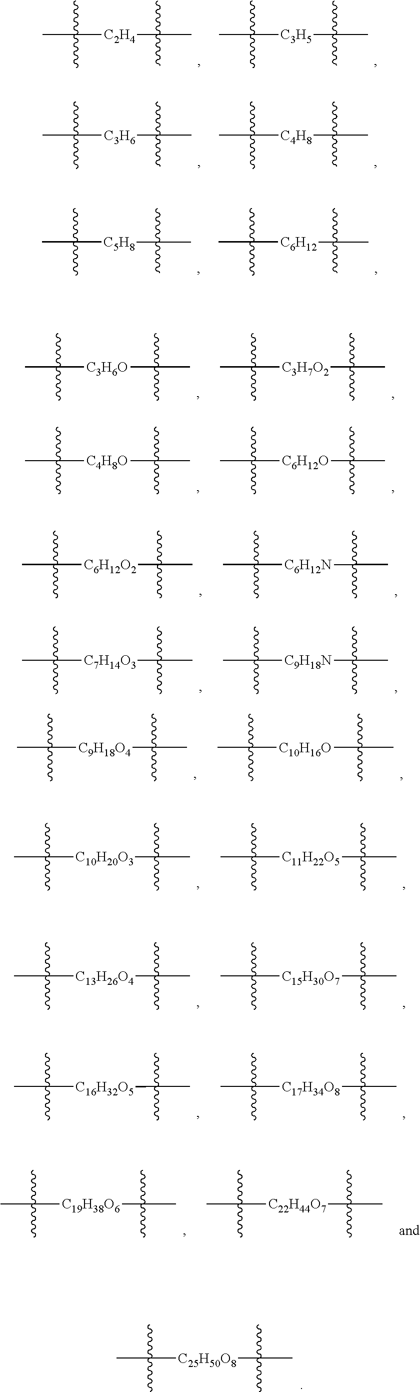

Even more preferably, Y is selected from:

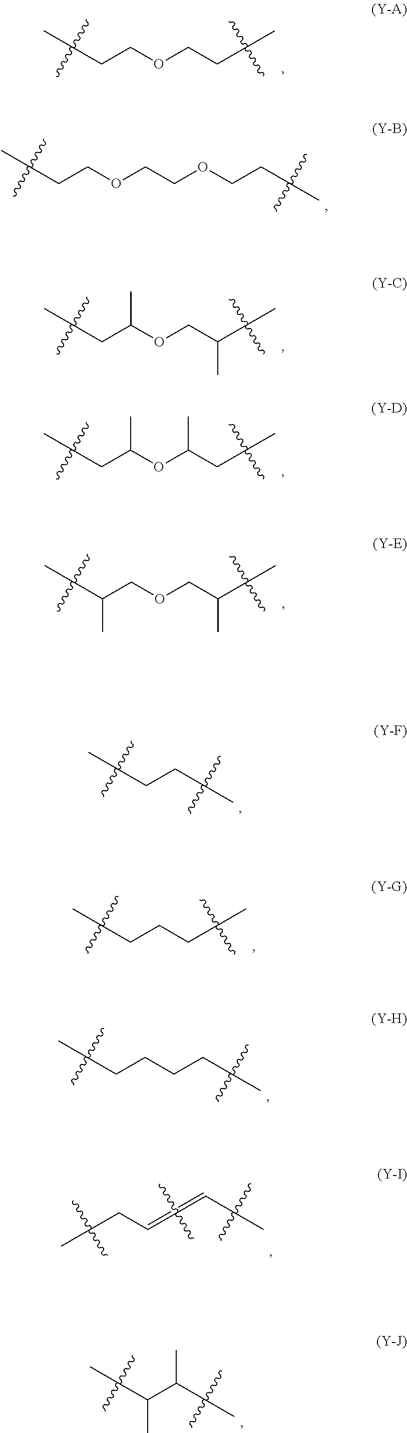

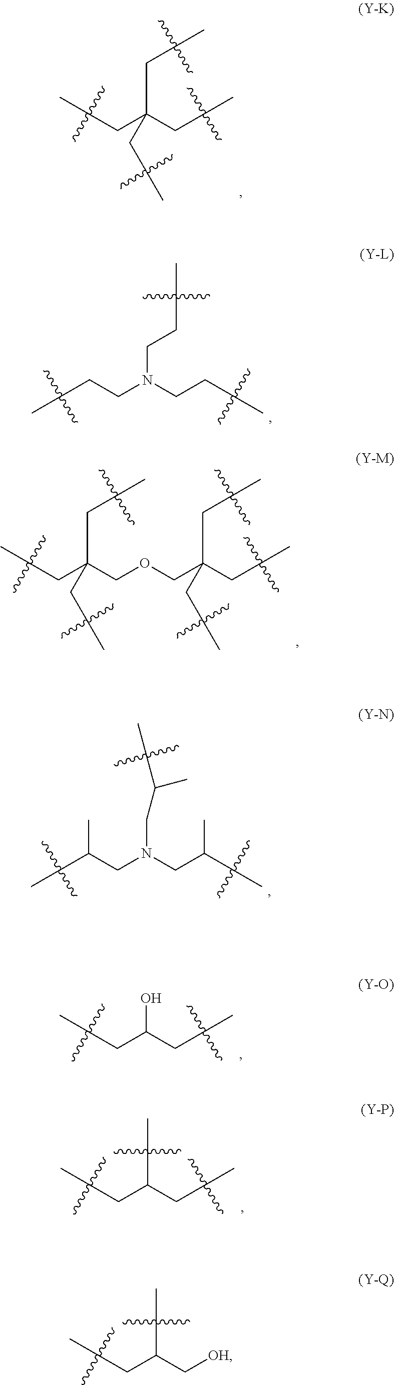

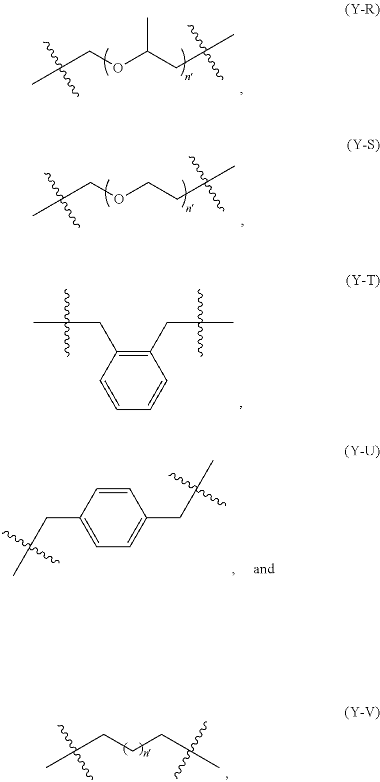

wherein n′ is from 3 to 8 repeating units.

Y may also be independently selected from a branched or straight chain C₂₋₂₀ alkenyl, wherein the double bond may be E or Z, and the alkenyl chain may be optionally substituted with any one or more substituents selected from R. Preferably, Y is an independently selected optionally substituted branched or straight chain C₂₋₁₀ alkenyl. Yet even more preferably, Y is an independently selected optionally substituted branched or straight chain C₂₋₁₀ alkenyl of formula:

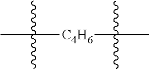

Even more preferably, Y is

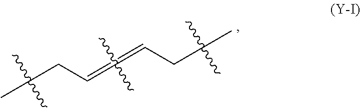

wherein

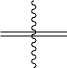

means E or Z carbon-carbon double bond isomers.

In some embodiments of the third aspect, Y is independently selected from an independently selected, optionally substituted C₅₋₁₂ aryl wherein any one of the C₅₋₁₂ aryl may be optionally substituted with any one or more substituents selected from R.

In some embodiments of the third aspect, the compound of Formula (I) is selected from:

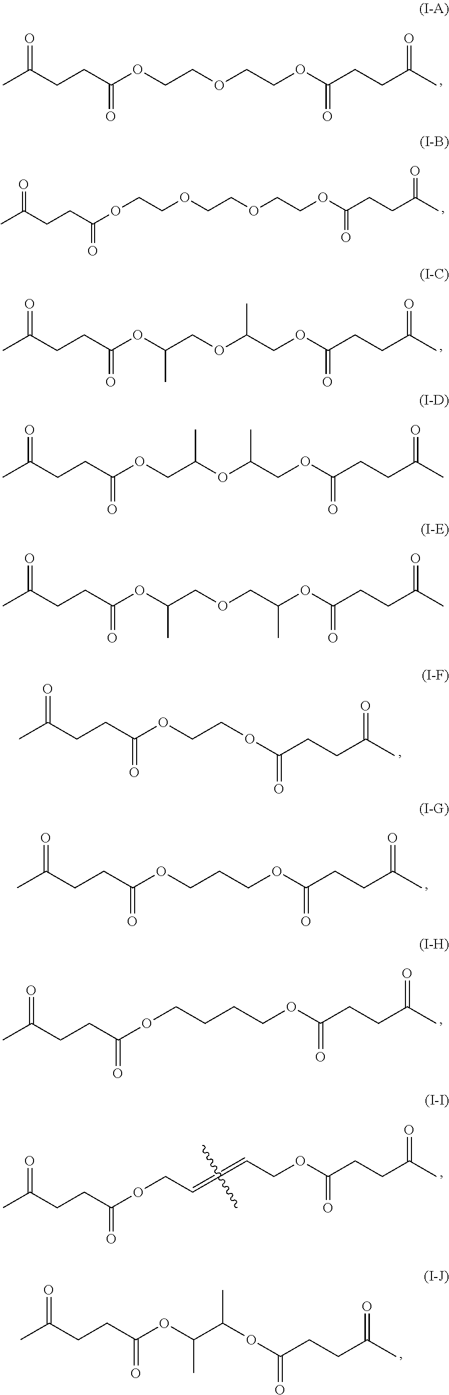

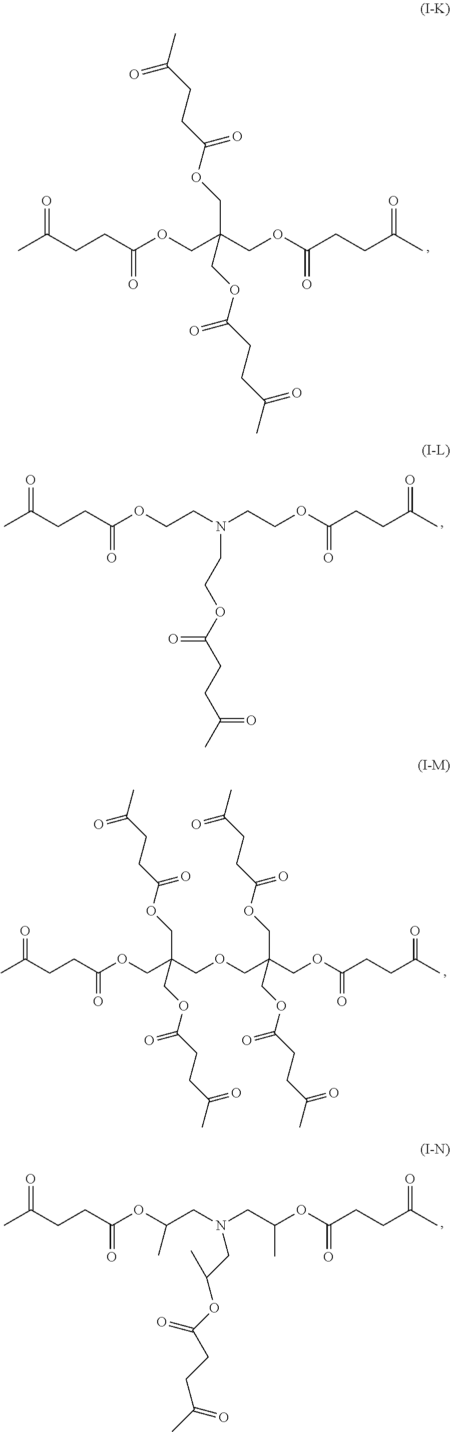

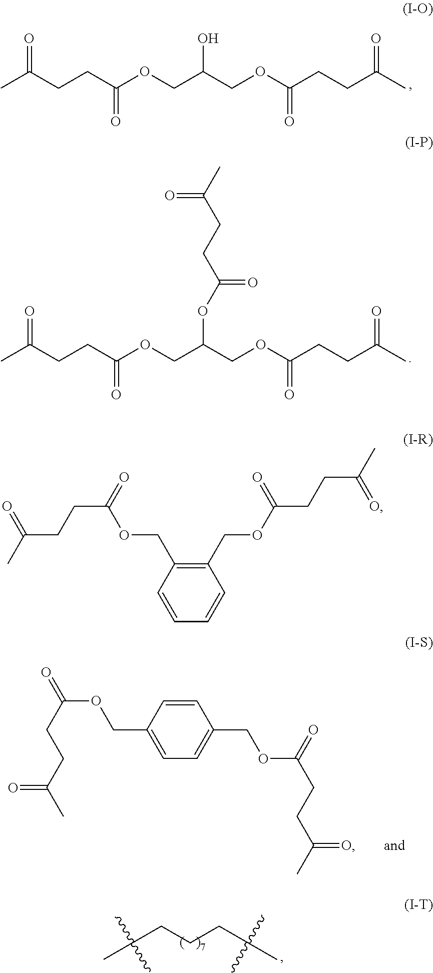

wherein

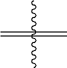

means E or Z carbon-carbon double bond isomers.

In an embodiment of the third aspect, the polyketone is derived from renewable levulinic acid.

In further embodiments of the third aspect, the acyl hydrazide is a of general Formula (II)

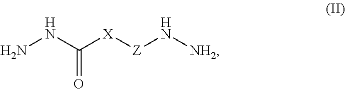

X is absent, or is selected from a branched, straight chain C₁₋₂₀ alkylene, C₂₋₂₀ alkenyl, C₃₋₁₂ carbocycle or C₅₋₁₂ aryl. Preferably, X is a C₂₋₁₀ alkylene, C₂₋₁₀ alkenyl, or C₅₋₁₂ aryl wherein any of C₂₋₁₀ alkylene, C₂₋₁₀ alkenyl, C₂₋₁₀ alkynyl, or C₅₋₁₂ aryl may be optionally substituted with any one or more substituents selected from R.

R is selected from C₁₋₁₀ aliphatic, amino, (C₁₋₁₀ aliphatic)amino, amido, (C₁₋₁₀ aliphatic)amido, aryl, (C₁₋₁₀ aliphatic)aryl, cyano, carbonyl, heteroatoms (O, N, S, P, wherein the heteroatoms may be further substituted with hydrogen, aliphatic, amino, aryl, heteroaryl, heterocyclyl), hydroxy, wherein aliphatic means any independently selected, optionally substituted, branched or straight chain C₁₋₁₀ alkylene, C₂₋₁₀ alkenyl, C₂₋₁₀ alkynyl.

X may be independently selected from a branched or straight chain C₁₋₂₀ alkylene, wherein any one of the C₁₋₂₀ alkylene may be optionally substituted with any one or more substituents selected from R. Preferably, X is an independently selected, optionally substituted, branched or straight chain C₂₋₁₀ alkylene. X may also be an independently selected, optionally substituted, branched or straight chain C₂₋₆ alkylene. Preferably, the independently selected, optionally substituted C₂₋₆ alkylene is

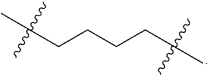 [SMILES: *CCCC*]

### Alternatively, X is

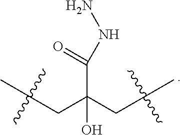 [SMILES: *CC(O)(C*)C(=O)NN]

In another embodiment of the third aspect, X is independently selected from a branched or straight chain C₂₋₁₀ alkenyl, wherein any one of the C₂₋₁₀ alkenyl may be optionally substituted with any one or more substituents selected from R. Preferably, X is an independently selected, optionally substituted, branched or straight chain C₂₋₁₀ alkenyl. X may also be an independently selected, optionally substituted, branched or straight chain C₂₋₆ alkenyl.

In yet further embodiments of the third aspect, X may be independently selected from an optionally substituted C₅₋₁₂ aryl wherein any one of the C₅₋₁₂ aryl may be optionally substituted with any one or more substituents selected from R. Preferably, the independently selected optionally substituted C₅₋₁₂ aryl is

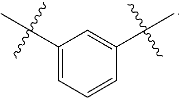 [SMILES: *c1cccc(*)c1]

In an embodiment of the third aspect, Z is absent or is one or more C═O.

In another embodiment of the third aspect, when X

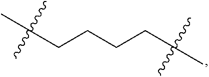 [SMILES: *CCCC*]

### is Z is (C═O).

In another embodiment of the third aspect, when X is

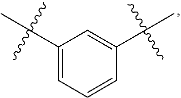 [SMILES: *c1cccc(*)c1]

### Z is (C═O).

In another embodiment of the third aspect, when X

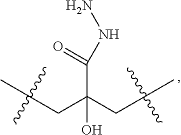 [SMILES: *CC(O)(C*)C(=O)NN]

### is Z is (C═O)

In another embodiment of the third aspect, when X is absent, Z is (C═O).

In another embodiment of the third aspect, X and Z are both absent.

In an embodiment of the third aspect, the compound of Formula (II) may be selected from:

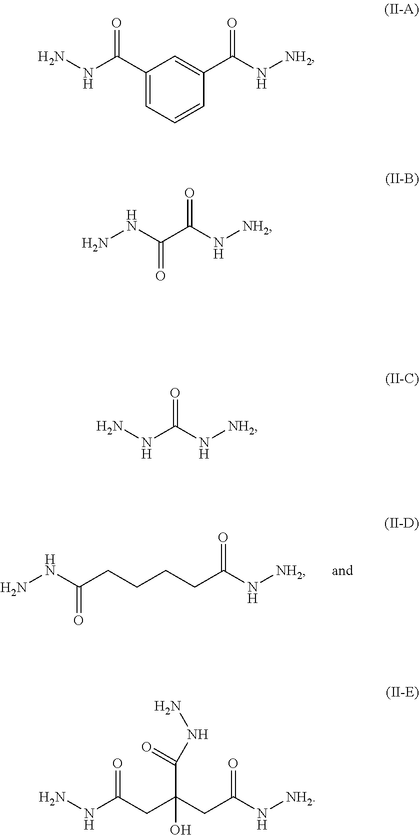 [SMILES: NNC(=O)c1cccc(C(=O)NN)c1 ; NNC(=O)C(=O)NN ; NNC(=O)NN ; NNC(=O)CCCCC(=O)NN ; NNC(=O)CC(O)(CC(=O)NN)C(=O)NN]

In some embodiments of the third aspect, the hydrazide and polyketone are contacted in a reactive group ratio of acyl hydrazide:polyketone of about 90:10 to about 10:90. Preferably, in a reactive group ratio of acyl hydrazide:polyketone of about 70:30 to about 30:70. Even more preferably, in a reactive group ratio of acyl hydrazide:polyketone of about 47:53.

The acyl hydrazide and the polyketone of the third aspect may be contacted in a solvent. The solvent may be a polar solvent and/or water miscible. Preferably, the solvent is water or a water miscible solvent, or combinations thereof. Water miscible polar solvents include but are not limited to acetonitrile, dioxane, DMSO, DMF, DMAc, diethylene glycol, ethylene glycol, Texanol™ (chemical name 2,2,4-trimethyl-1,3-pentanediol monoisobutyrate), tetrahydrofuran, water or combinations thereof.

The acyl hydrazide and the polyketone of the third aspect may be contacted at a temperature of about 0° C. to about 100° C. Preferably, the temperature is about 20° C. to about 80° C., even more preferably the temperature is about 25° C. to about 50° C.

In a further embodiment of the third aspect, the acyl hydrazide and the polyketone are contacted at a temperature of about 0° C. to about 100° C. Preferably, the temperature is about 20° C. to about 80° C., even more preferably the temperature is about 25° C. to about 50° C. in the presence of solvent. Preferably, the solvent is a polar solvent and/or water miscible polar solvent, more preferably, the solvent is water or a water miscible polar solvent. Water miscible polar solvents include but are not limited to acetonitrile, dioxane, DMSO, DMAc, DMF, diethylene glycol, ethylene glycol, Texanol™ (chemical name 2,2,4-trimethyl-1,3-pentanediol monoisobutyrate), tetrahydrofuran, water or combinations thereof. Even more preferably the solvent is water.

The acyl hydrazide and the polyketone of the third aspect may form a composition in a solvent. The solvent may be a polar solvent and/or water miscible. Preferably, the solvent is water or a water miscible solvent, or combinations thereof. Water miscible polar solvents include but are not limited to acetonitrile, dioxane, DMSO, DMAc, DMF, diethylene glycol, ethylene glycol, Texanol™ (chemical name 2,2,4-trimethyl-1,3-pentanediol monoisobutyrate), tetrahydrofuran, water or combinations thereof. Preferably the composition is a water-borne composition.

In an embodiment of the third aspect, the composition forms a gel in solution. Preferably the gel comprises a polyhydrazone compound.

In some embodiments of the third aspect, the composition comprises a reactive group ratio of acyl hydrazide:polyketone of about 90:10 to about 10:90. Preferably, a reactive group ratio of acyl hydrazide:polyketone of about 70:30 to about 30:70. Even more preferably, a reactive group ratio of acyl hydrazide:polyketone of about 47:53.

In some embodiments of the third aspect of the invention, the composition prepared by the process has a glass transition temperature (T_{g}) of about 20° C. to about 130° C., preferably about 50° C. to about 100° C., preferably about 50° C. to about 80° C., preferably about 60° C. to about 80° C. Preferably the T_{g} is measured by differential scanning calorimetry (DSC).

In some embodiments of the third aspect, the composition prepared by the process forms a gel in solution or a suspension. Preferably, the gel is formed in a solution of about 10 to about 80% w/v, even more preferably about 30 to about 60% w/v.

In an embodiment of the third aspect, the composition prepared by the process forms a film when the gel is applied to a surface, and the gel dries on the surface. Preferably, the film forms at a temperature of about 10° C. to about 50° C. Preferably, the gel dries to form the film over a period of from about 1 hour to about 24 hours, even more preferably, from about 1 hour to about 4 hours. Preferably, the film is a flexible film. Alternatively the film is a rigid film.

In another embodiment of the third aspect, the composition prepared by the process forms a gel in solution or in a suspension. Preferably the gel is formed in a solution or suspension of about 25% w/v to about 60% w/v, of polyhydrazone/solvent. The gel may be applied to a surface. Preferably the surface is sealed or unsealed glass, wall board, plasterboard, pre-prepared timber or concrete substrate. Most preferably the surface is a sealed wall board substrate.

In a further embodiment of the third aspect, the composition prepared by the process forms a film when the water evaporates from the gel. Preferably the film forms at a temperature of about 10° C. to about 50° C. Preferably the film is a flexible film. Alternatively, preferably the film is a rigid film.

In a fourth aspect, the present invention provides for the use of a composition comprising:
i) at least one polyketone; and
ii) at least one acyl hydrazide.
   wherein, the polyketone comprises at least two levulinic acid moieties.

The composition may be used in the manufacture of aqueous suspension, gel, or emulsion. Preferably the composition is an aqueous gel or aqueous suspension.

The composition may be used in the manufacture of suspension, gel, or emulsion, wherein the suspension, gel or emulsion is an aqueous suspension, aqueous gel or aqueous emulsion, and wherein the composition is for use as a coating material.

The composition may be used in a suspension, gel, or emulsion, wherein the composition is an aqueous suspension, aqueous gel, or emulsion, and wherein the composition is for use a coating material and forms a protective film on a surface.

The surface may be, for example, include but is not limited to internal or external walls, or fences.

Alternatively, the surface may be the skin of a human or non-human animal. Preferably the surface is the skin of a human. Alternatively, preferably, the surface of the skin of the non-human animal is a domesticated pet or livestock.

The polyketone of the fourth aspect may be of Formula (I)

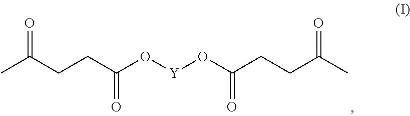

wherein Y is a C₂₋₃₀ alkylene, C₂₋₁₀ alkenyl, C₃₋₁₂ carbocycle or C₅₋₁₂ aryl, wherein any one of the C₂₋₃₀ alkylene, C₂₋₁₀ alkenyl, C₃₋₁₂ carbocycle or C₅₋₁₂ aryl may be independently optionally substituted with any one or more substituents selected from R.

R is selected from C₁₋₁₀ aliphatic, amino, (C₁₋₁₀ aliphatic)amino, amido, (C₁₋₁₀ aliphatic)amido, aryl, (C₁₋₁₀ aliphatic)aryl, cyano, carbonyl, heteroatoms (O, N, S, P, wherein the heteroatoms may be further substituted with hydrogen, aliphatic, amino, aryl, heteroaryl, heterocyclyl), hydroxy, wherein aliphatic means any independently selected, optionally substituted, branched or straight chain C₁₋₁₀ alkylene, C₂₋₁₀ alkenyl, C₂₋₁₀ alkynyl.

Y may be independently selected from a branched or straight chain C₂₋₃₀ alkylene, wherein any one of the branched or straight C₂₋₃₀ alkylene may be optionally substituted with any one or more of R.

Alternatively, Y is an optionally substituted C₅₋₁₂aryl. Preferably the optional substituents are straight or branched chain C₁₋₁₀ aliphatic. Preferably, the optional substituent is selected from C₁₋₁₀ alkylene moiety. Preferably the optionally substituted C₅₋₁₂aryl is

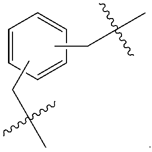

Preferably, Y is an independently selected, optionally substituted, branched or straight chain C₂₋₂₀ alkylene. Preferably, Y is an independently selected, optionally substituted, branched or straight chain C₂₋₁₀ alkylene. Y may also be an independently selected, optionally substituted, branched or straight chain C₂₋₆ alkylene. Yet even more preferably, the C₂₋₃₀ alkylene is selected from:

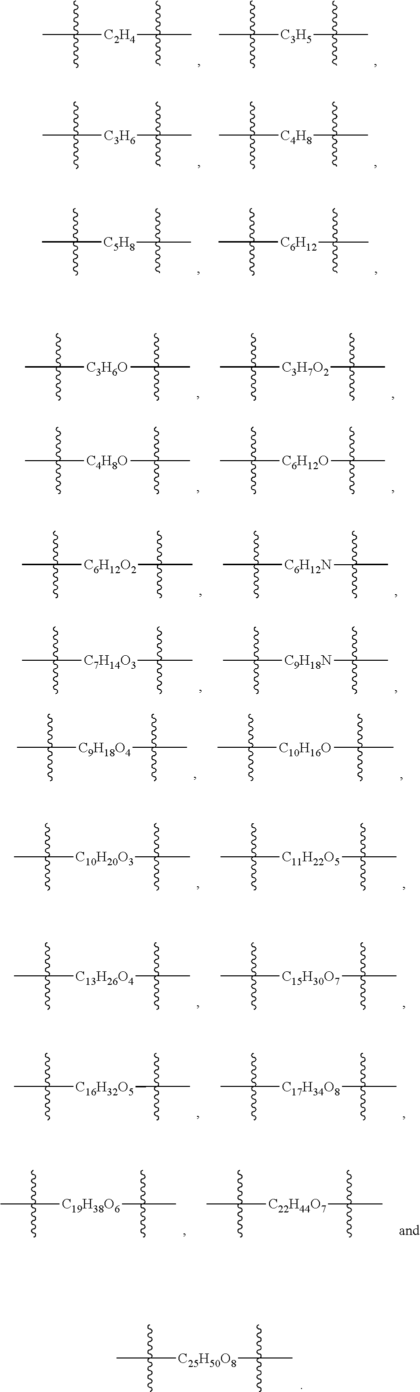

Even more preferably, Y is selected from:

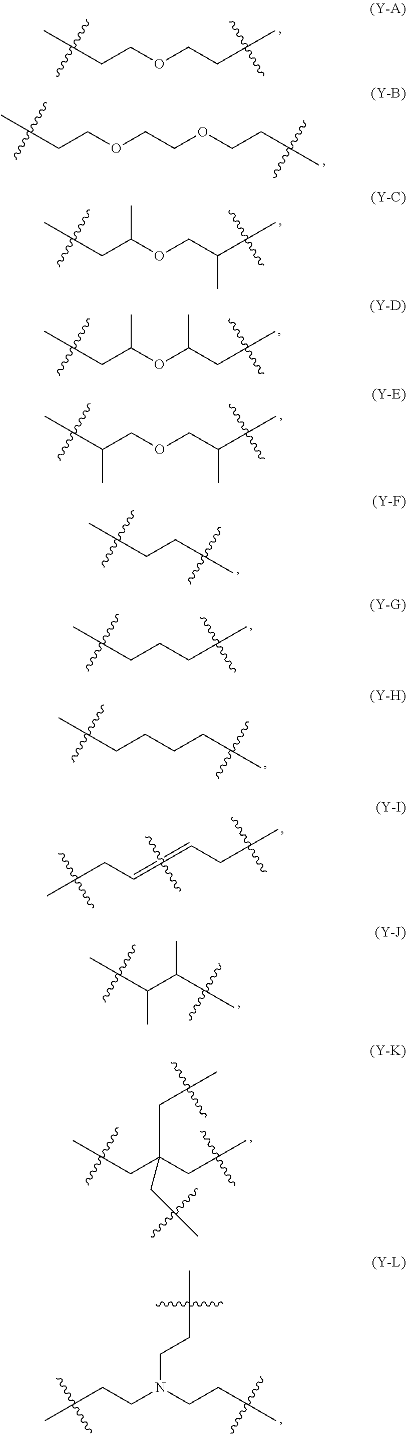

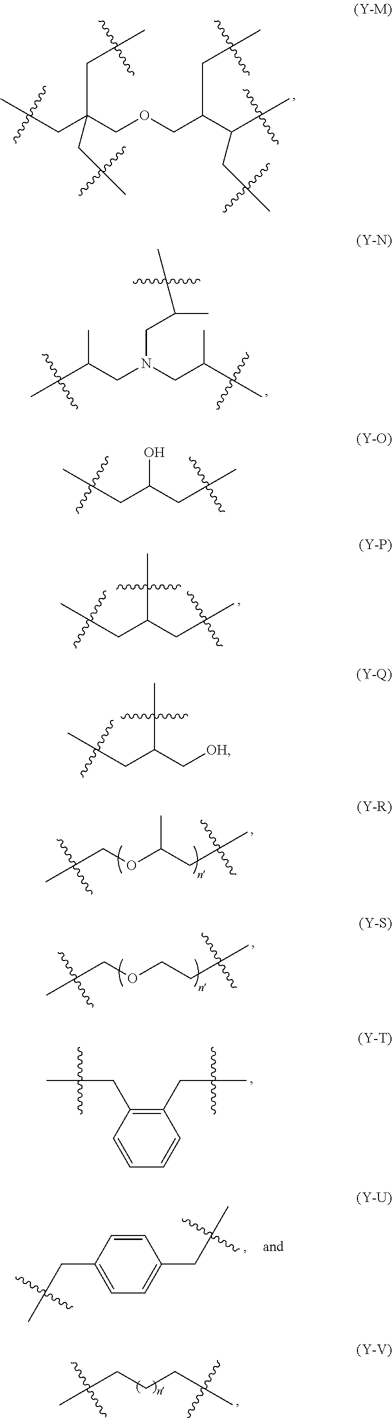

wherein n′ is from 3 to 8 repeating units.

Y may also be independently selected from a branched or straight chain C₂₋₂₀ alkenyl, wherein the double bond may be E or Z, and the alkenyl chain may be optionally substituted with any one or more substituents selected from R. Preferably, Y is an independently selected optionally substituted branched or straight chain C₂₋₁₀ alkenyl. Yet even more preferably, Y is an independently selected optionally substituted branched or straight chain C₂₋₁₀ alkenyl of formula:

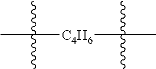

Even more preferably, Y is

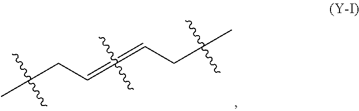

wherein

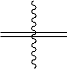

means E or Z carbon-carbon double bond isomers

In some embodiments of the fourth aspect, Y is independently selected from an independently selected, optionally substituted C₅₋₁₂ aryl wherein any one of the C₅₋₁₂ aryl may be optionally substituted with any one or more substituents selected from R.

In some embodiments of the fourth aspect, the compound of Formula (I) is selected from:

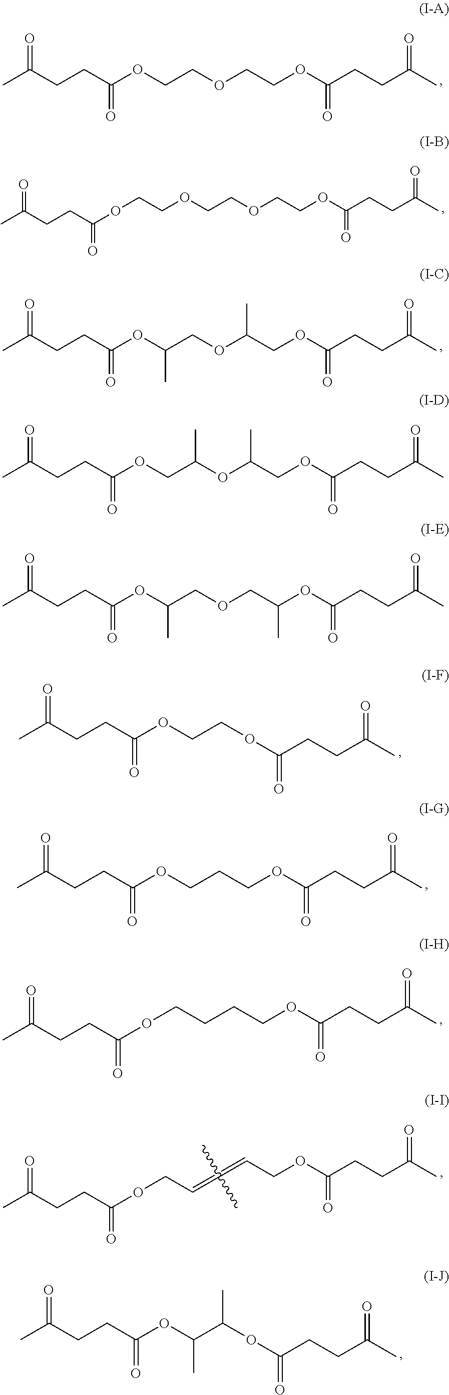

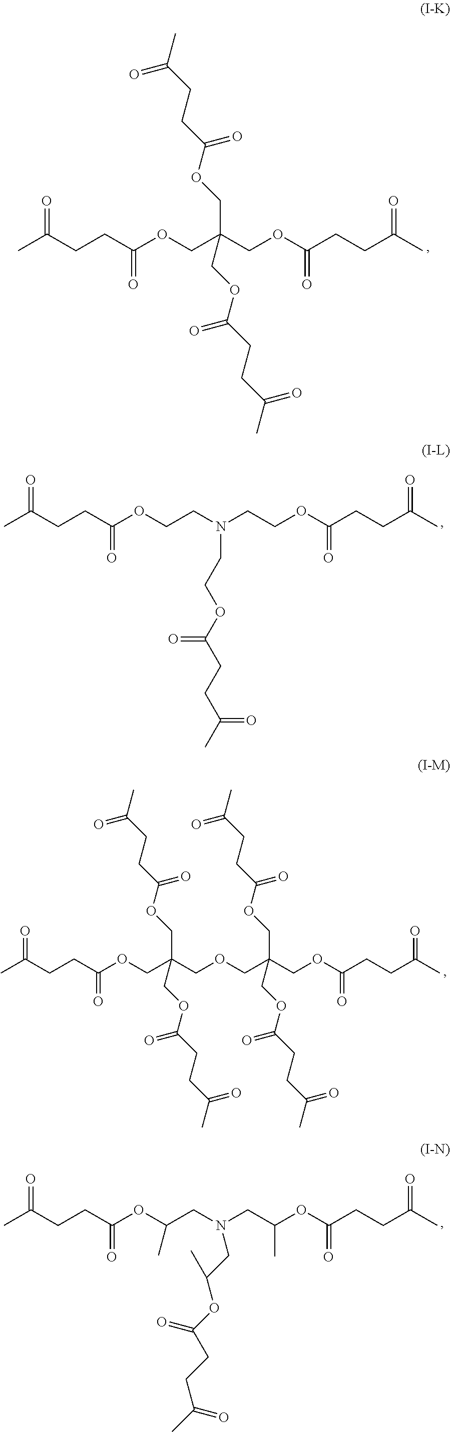

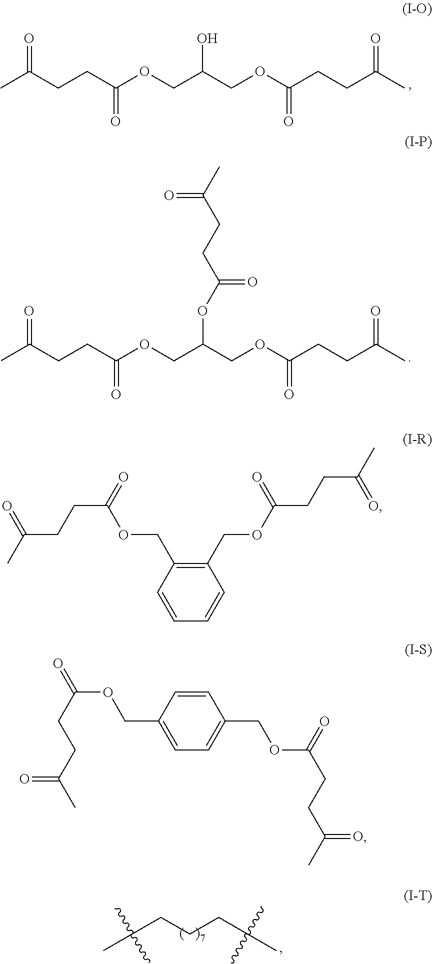

wherein

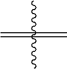

means E or Z carbon-carbon double bond isomers.

In an embodiment of the fourth aspect, the polyketone is derived from renewable levulinic acid.

In further embodiments of the fourth aspect, the acyl hydrazide is a of general Formula (II)

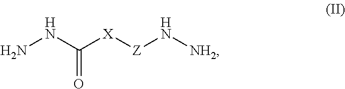

X is absent, or is selected from a branched, straight chain C₁₋₂₀ alkylene, C₂₋₂₀ alkenyl, C₃₋₁₂ carbocycle or C₅₋₁₂ aryl. Preferably, X is a C₂₋₁₀ alkylene, C₂₋₁₀ alkenyl, or C₅₋₁₂ aryl wherein any of C₂₋₁₀ alkylene, C₂₋₁₀ alkenyl, C₂₋₁₀ alkynyl, or C₅₋₁₂ aryl may be optionally substituted with any one or more substituents selected from R.

R is selected from C₁₋₁₀ aliphatic, amino, (C₁₋₁₀ aliphatic)amino, amido, (C₁₋₁₀ aliphatic)amido, aryl, (C₁₋₁₀ aliphatic)aryl, cyano, carbonyl, heteroatoms (O, N, S, P, wherein the heteroatoms may be further substituted with hydrogen, aliphatic, amino, aryl, heteroaryl, heterocyclyl), hydroxy, wherein aliphatic means any independently selected, optionally substituted, branched or straight chain C₁₋₁₀ alkylene, C₂₋₁₀ alkenyl, C₂₋₁₀ alkynyl.

X may be independently selected from a branched or straight chain C₁₋₂₀ alkylene, wherein any one of the C₁₋₂₀ alkylene may be optionally substituted with any one or more substituents selected from R. Preferably, X is an independently selected, optionally substituted, branched or straight chain C₂₋₁₀ alkylene. X may also be an independently selected, optionally substituted, branched or straight chain C₂₋₆ alkylene. Preferably, the independently selected, optionally substituted C₂₋₆ alkylene is

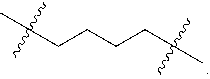 [SMILES: *CCCC*]

### Alternatively, X is

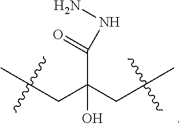 [SMILES: *CC(O)(C*)C(=O)NN]

In another embodiment of the fourth aspect, X is independently selected from a branched or straight chain C₂₋₁₀ alkenyl, wherein any one of the C₂₋₁₀ alkenyl may be optionally substituted with any one or more substituents selected from R. Preferably, X is an independently selected, optionally substituted, branched or straight chain C₂₋₁₀ alkenyl. X may also be an independently selected, optionally substituted, branched or straight chain C₂₋₆ alkenyl.

In yet further embodiments of the fourth aspect, X may be independently selected from an optionally substituted C₅₋₁₂ aryl wherein any one of the C₅₋₁₂ aryl may be optionally substituted with any one or more substituents selected from R. Preferably, the independently selected optionally substituted C₅₋₁₂ aryl is

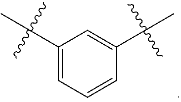 [SMILES: *c1cccc(*)c1]

In an embodiment of the fourth aspect, Z is absent or is one or more C═O.

In another embodiment of the fourth aspect, when X

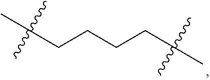 [SMILES: *CCCC*]

### is Z is (C═O).

In another embodiment of the fourth aspect, when X is

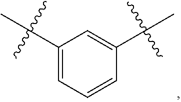 [SMILES: *c1cccc(*)c1]

### Z is (C═O).

In another embodiment of the fourth aspect, when X is

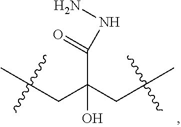 [SMILES: *CC(O)(C*)C(=O)NN]

### Z is (C═O)

In another embodiment of the fourth aspect, when X is absent, Z is (C═O).

In another embodiment of the fourth aspect, X and Z are both absent.

In an embodiment of the fourth aspect, the compound of Formula (II) may be selected from:

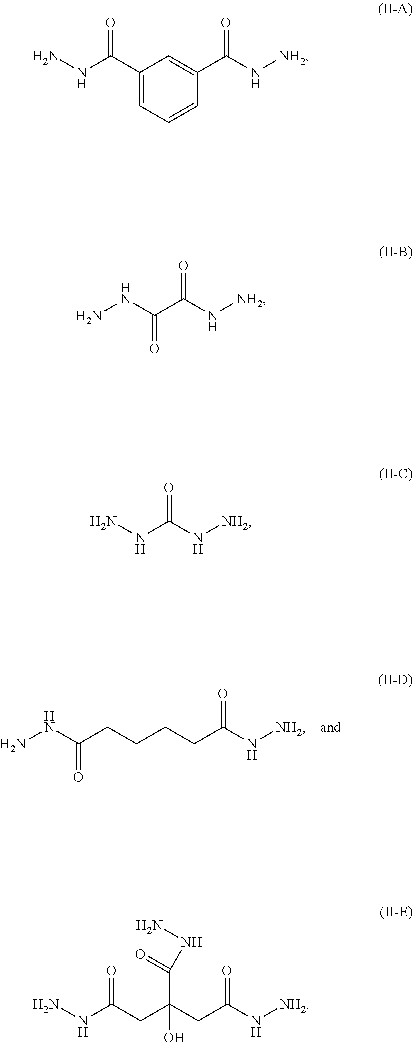 [SMILES: NNC(=O)c1cccc(C(=O)NN)c1 ; NNC(=O)C(=O)NN ; NNC(=O)NN ; NNC(=O)CCCCC(=O)NN ; NNC(=O)CC(O)(CC(=O)NN)C(=O)NN]

The acyl hydrazide and the polyketone of the fourth aspect may form the composition in a solvent. The solvent may be a polar solvent and/or water miscible. Preferably, the solvent is water or a water miscible solvent, or combinations thereof. Water miscible polar solvents include but are not limited to acetonitrile, dioxane, DMSO, DMAc, DMF, diethylene glycol, ethylene glycol, Texanol™ (chemical name 2,2,4-trimethyl-1,3-pentanediol monoisobutyrate), tetrahydrofuran, water or combinations thereof. Preferably the composition is a water-borne composition.

In an embodiment of the fourth aspect, the composition is a gel in solution. Preferably the gel comprises a polyhydrazone compound.

In some embodiments of the fourth aspect, the composition comprises a reactive group ratio of acyl hydrazide:polyketone of about 90:10 to about 10:90. Preferably, a reactive group ratio of acyl hydrazide:polyketone of about 70:30 to about 30:70. Even more preferably, a reactive group ratio of acyl hydrazide:polyketone of about 47:53.

In some embodiments of the fourth aspect, the composition is a gel in solution or a suspension. Preferably, the gel is formed in a solution of about 10 to about 80% w/v, even more preferably about 30 to about 60% w/v.

In an embodiment of the fourth aspect, the composition forms a film when the gel is applied to a surface, and the gel dries on the surface. Preferably, the film forms at a temperature of about 10° C. to about 50° C. Preferably, the gel dries to form the film over a period of from about 1 hour to about 24 hours, even more preferably, from about 1 hour to about 4 hours. Preferably, the film is a flexible film. Alternatively the film is a rigid film.

In some embodiments of the fourth aspect of the invention, the composition has a glass transition temperature (T_{g}) of about 20° C. to about 130° C., preferably about 50° C. to about 100° C., preferably about 50° C. to about 80° C., preferably about 60° C. to about 80° C. Preferably the T_{g} is measured by differential scanning calorimetry (DSC).

In an embodiment of any one of the first to fourth aspects of the invention, the composition forms or comprises a polyhydrazone compound selected from:

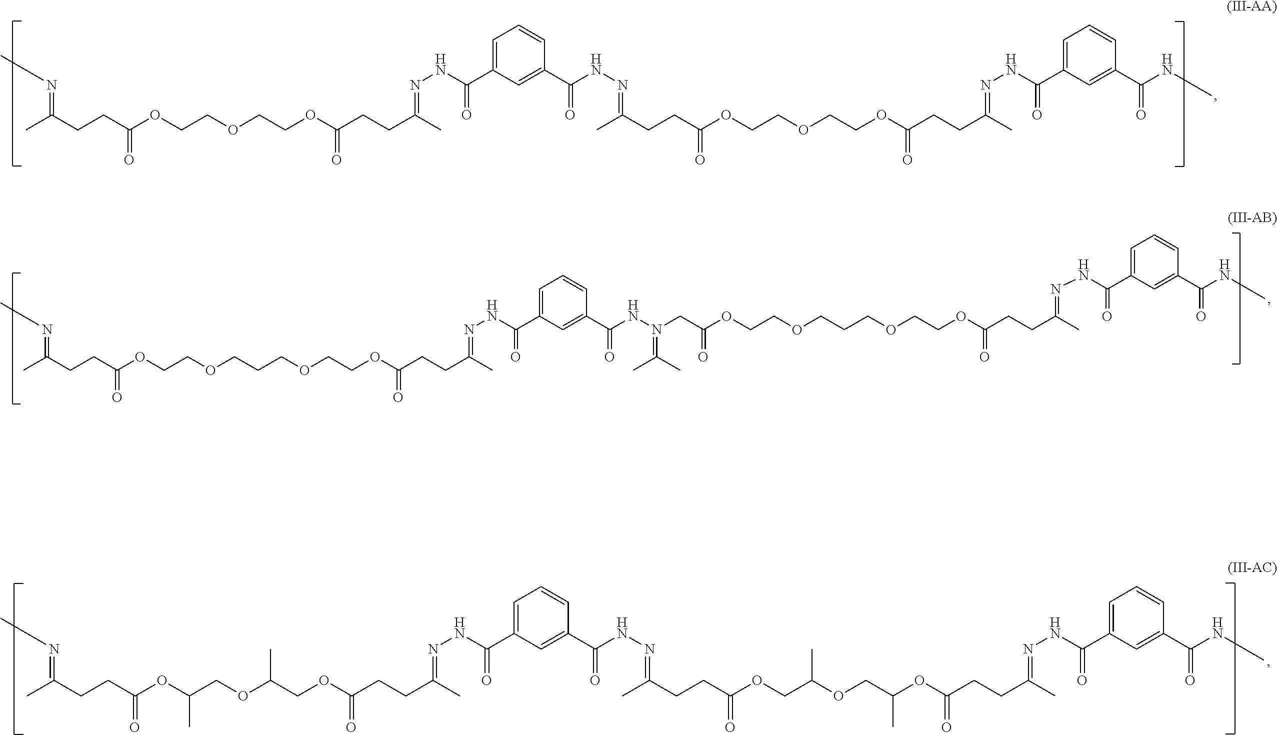

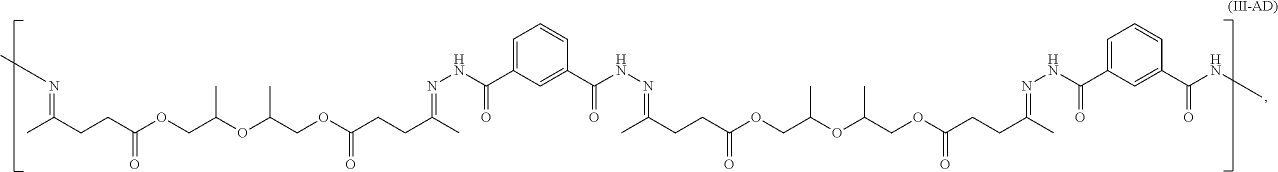

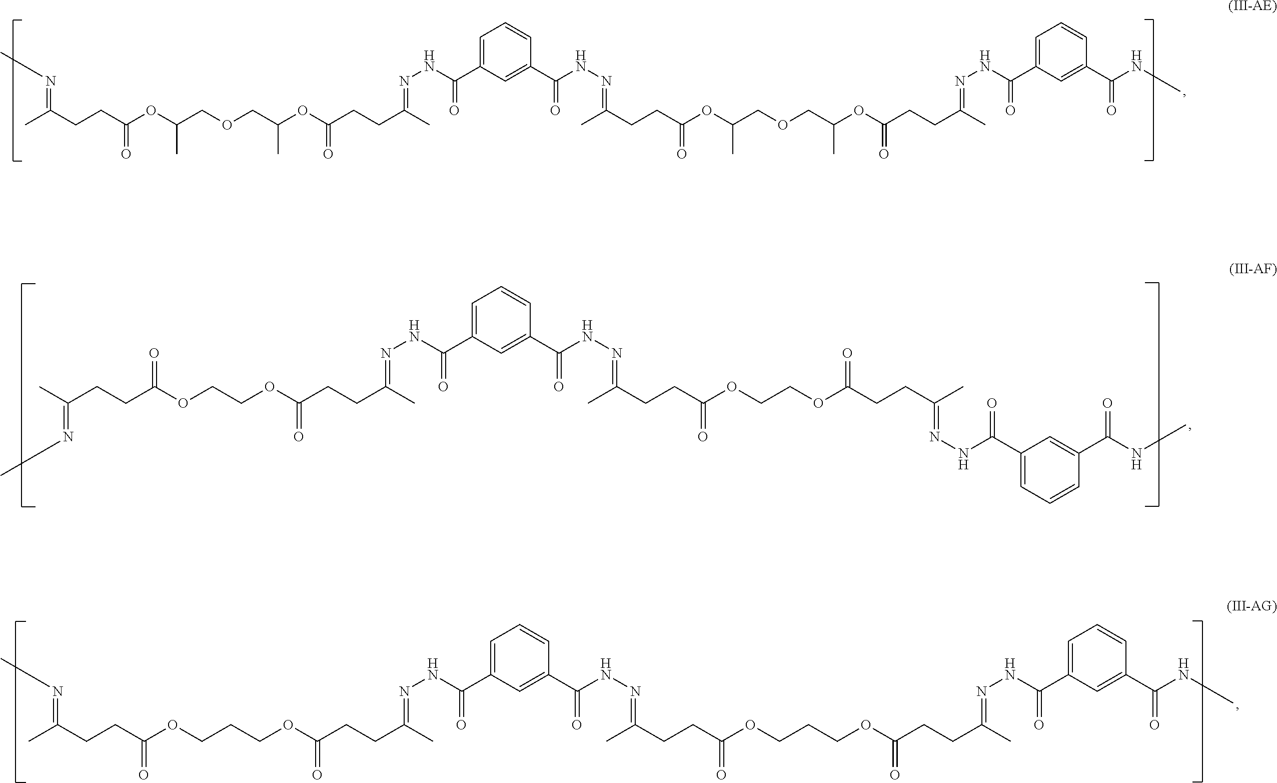

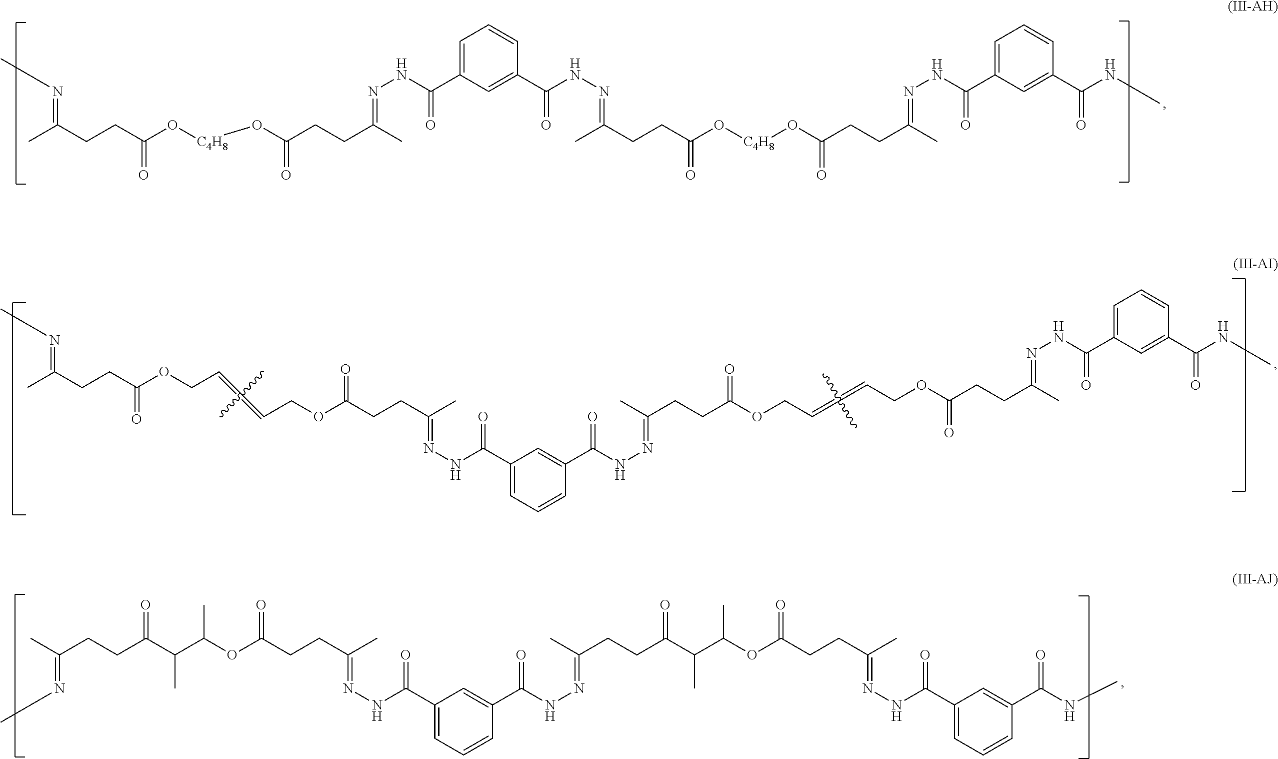

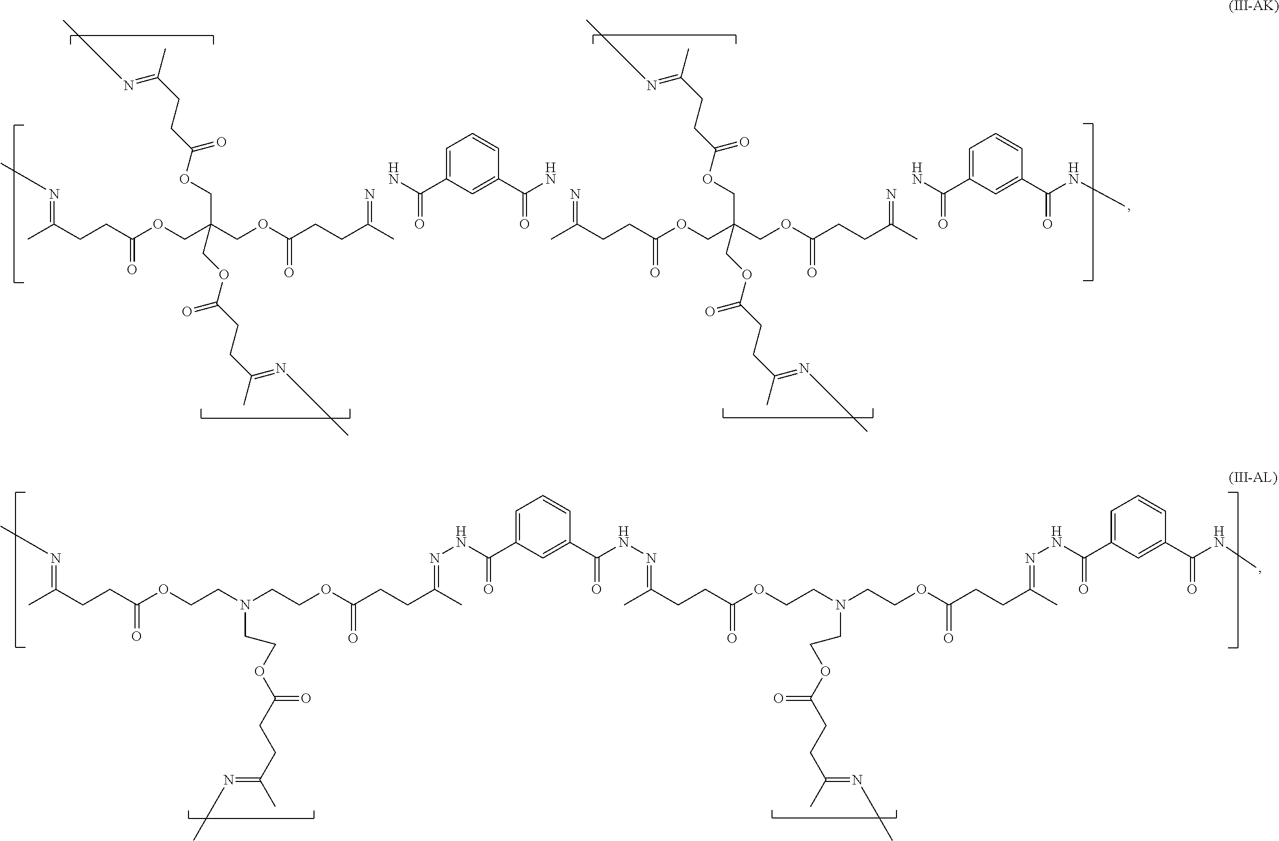

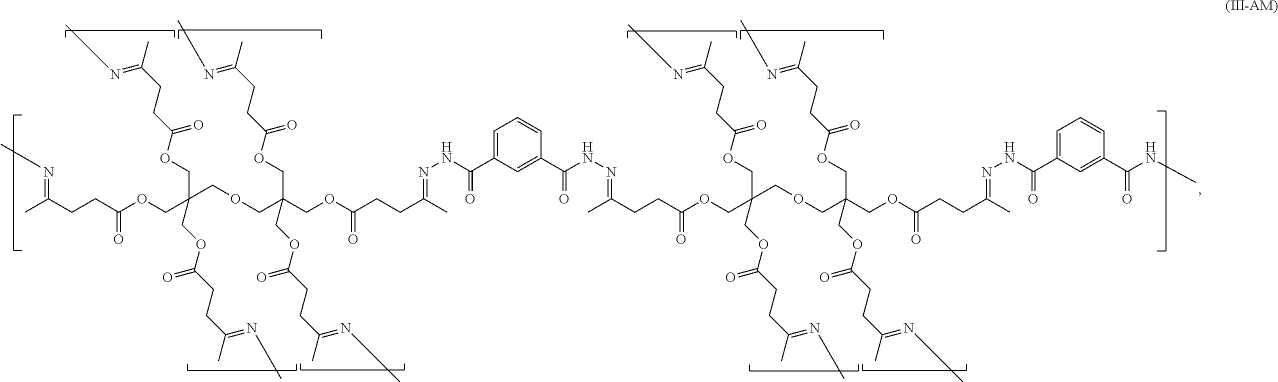

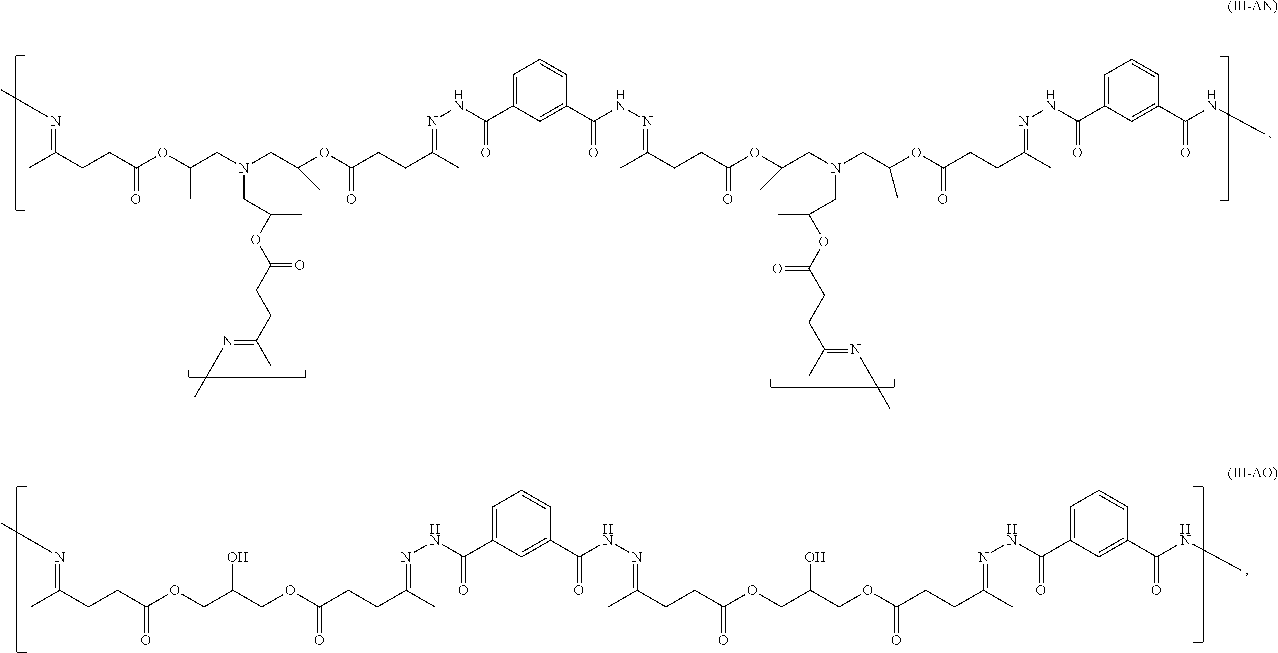

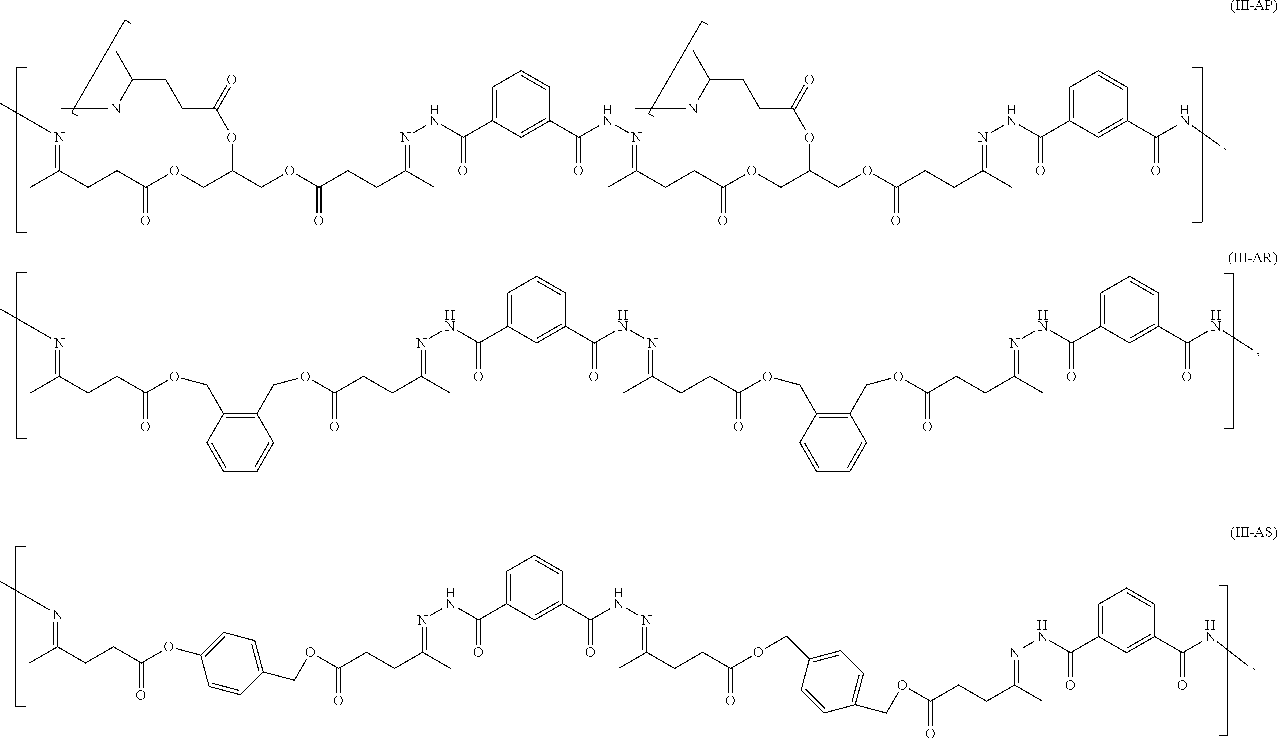

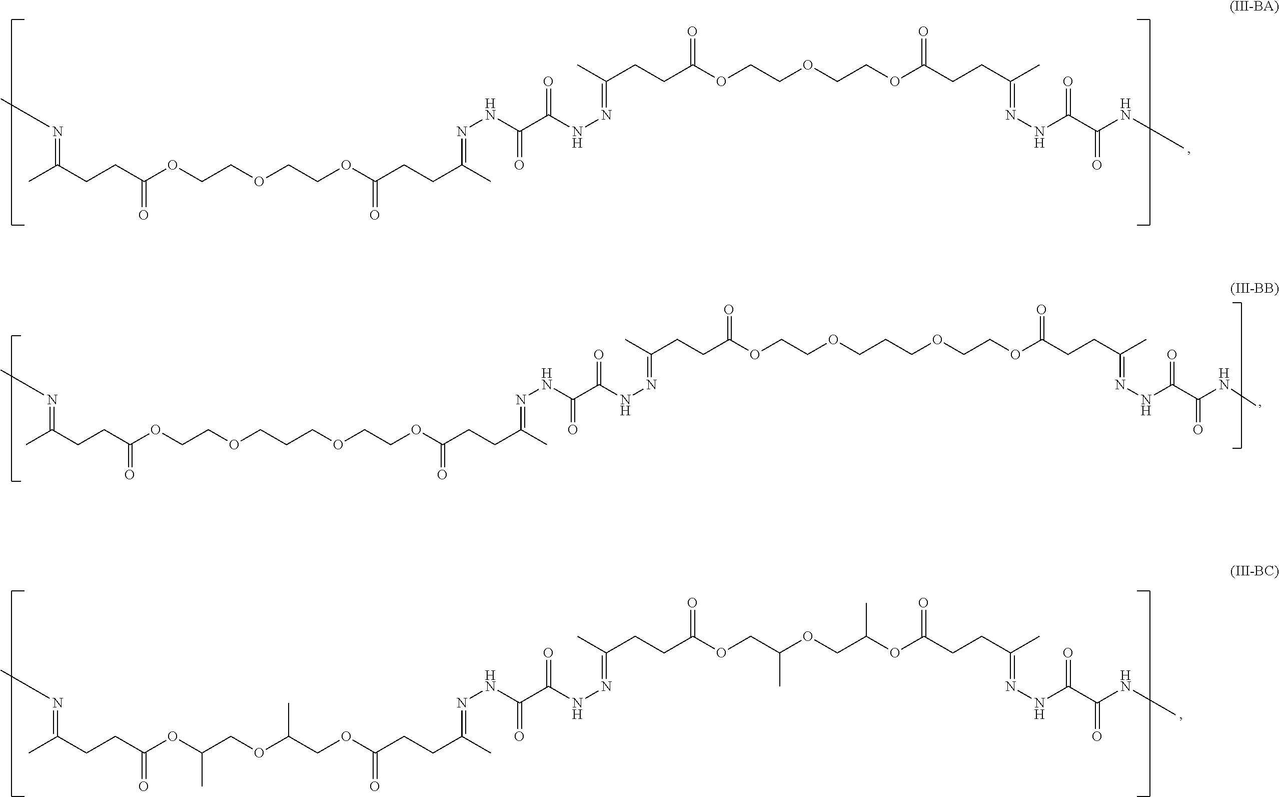

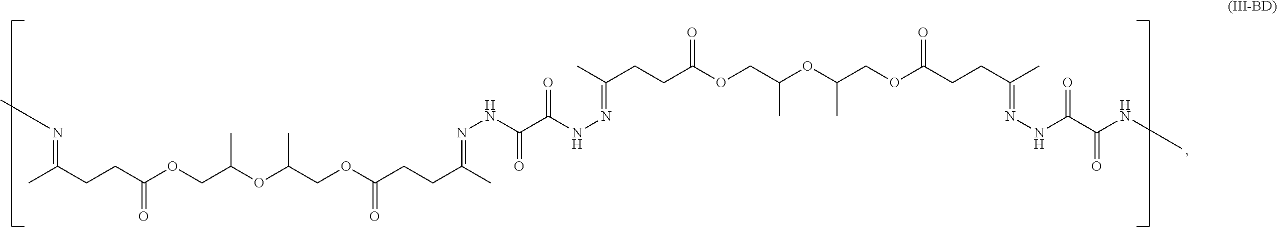

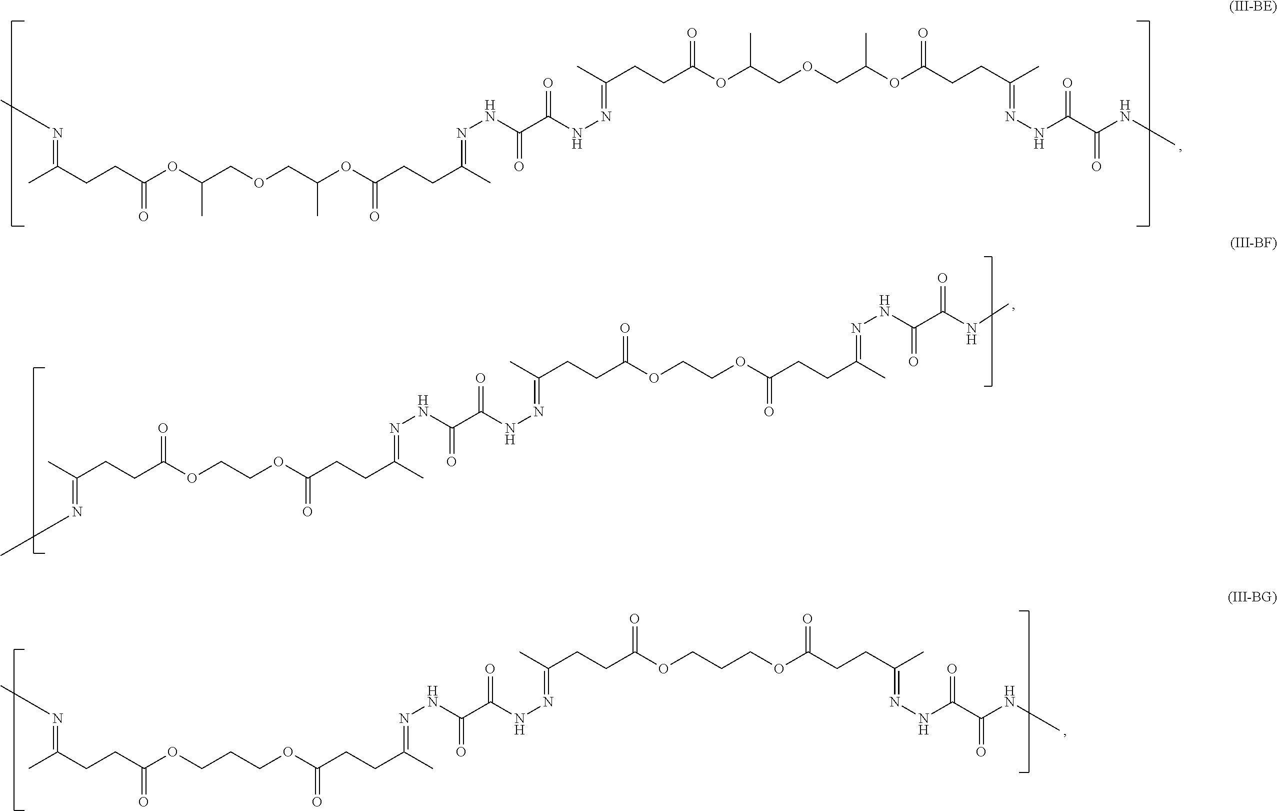

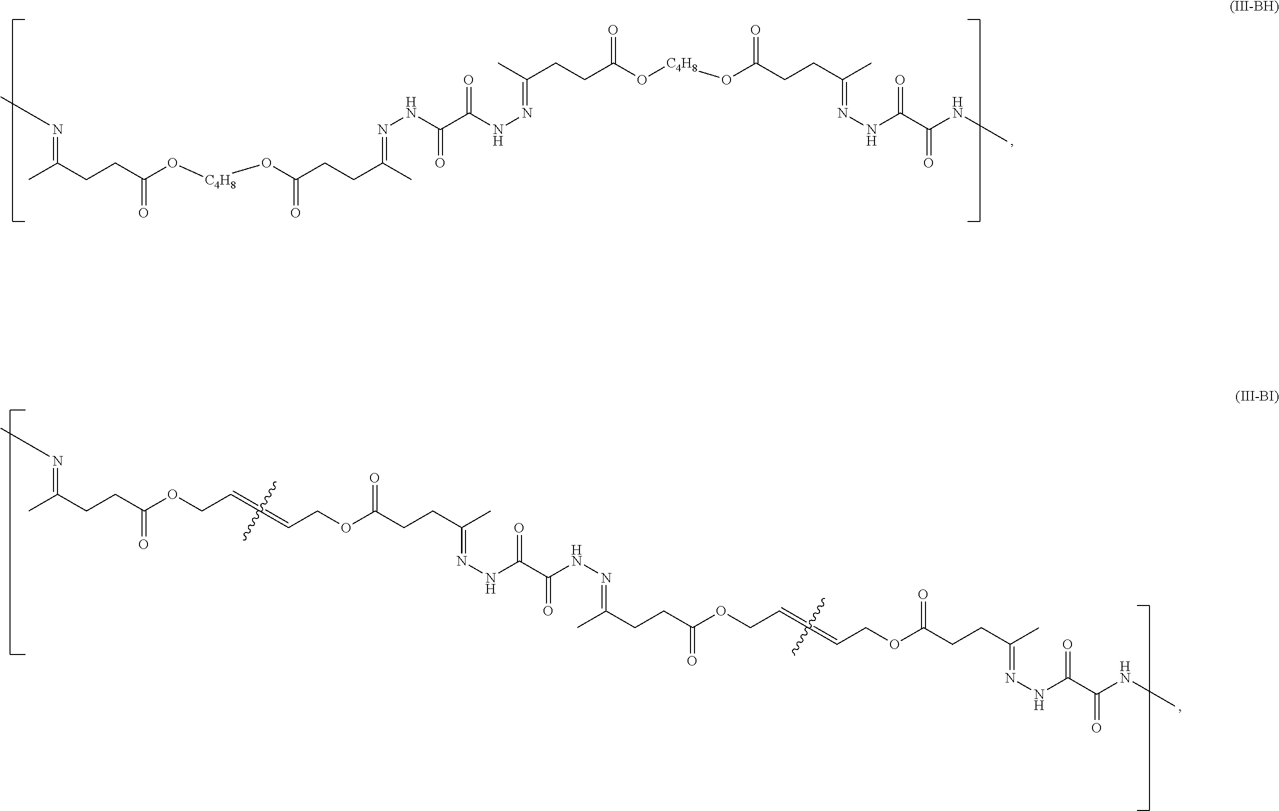

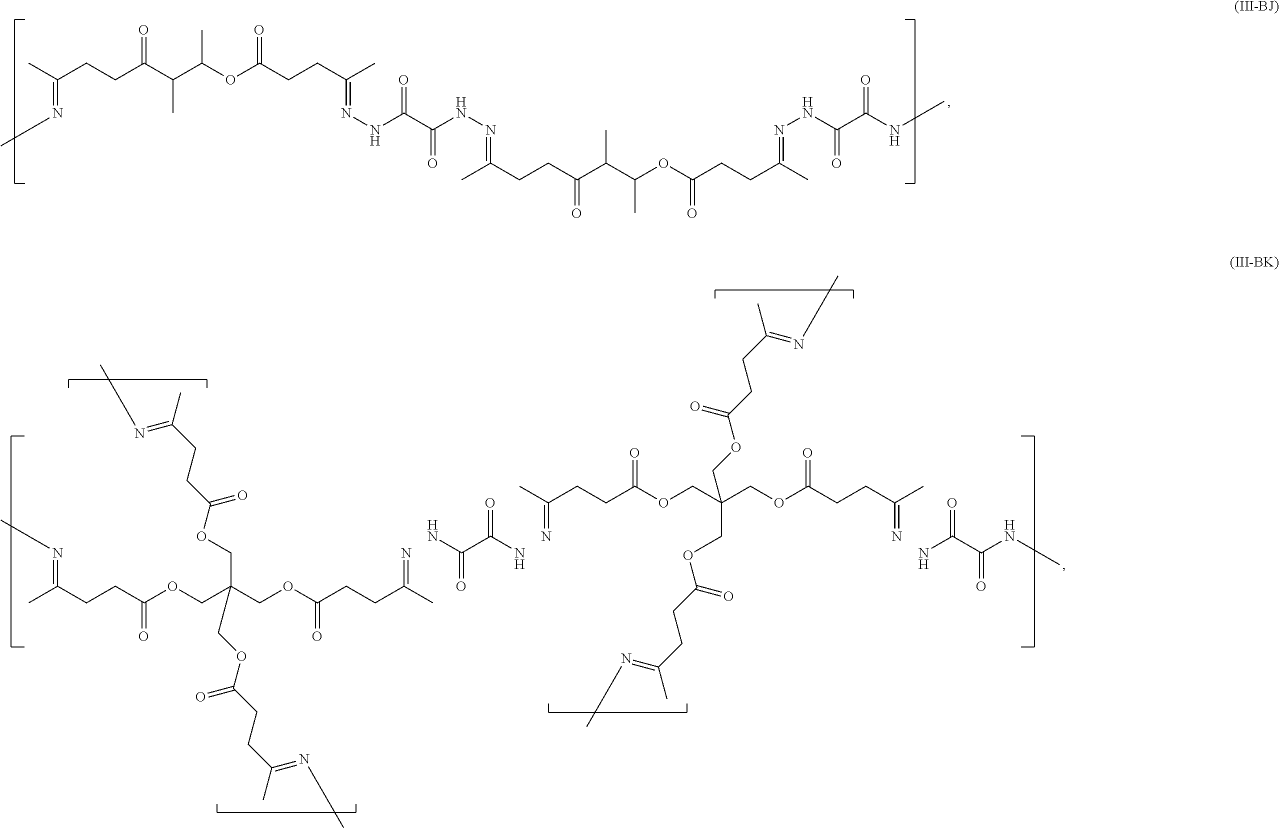

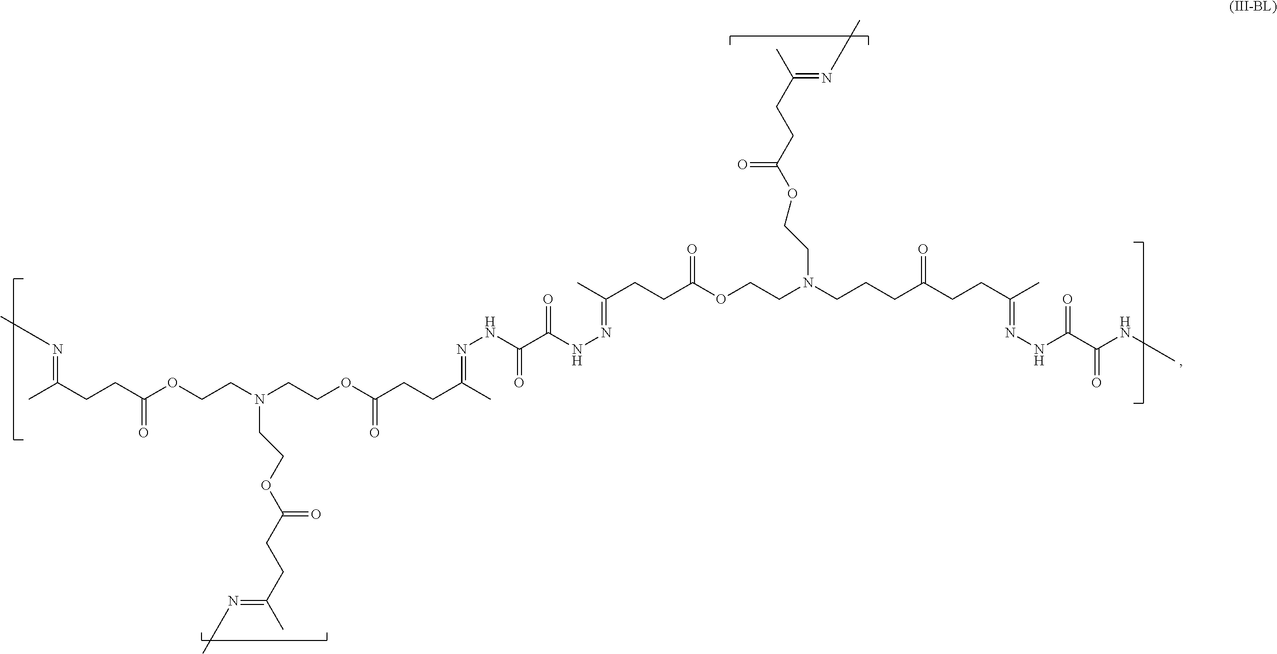

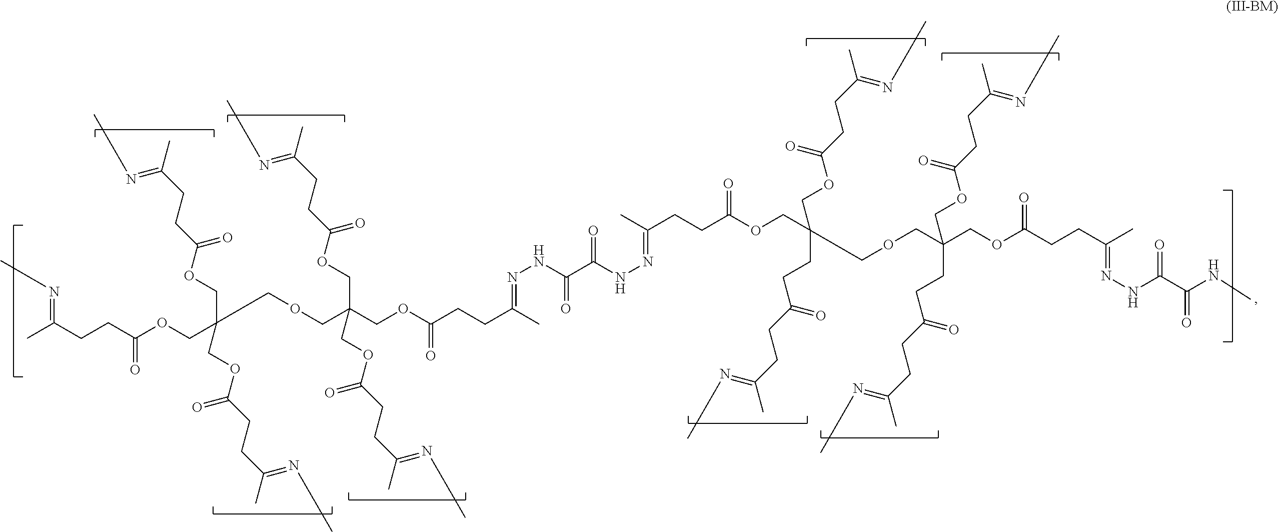

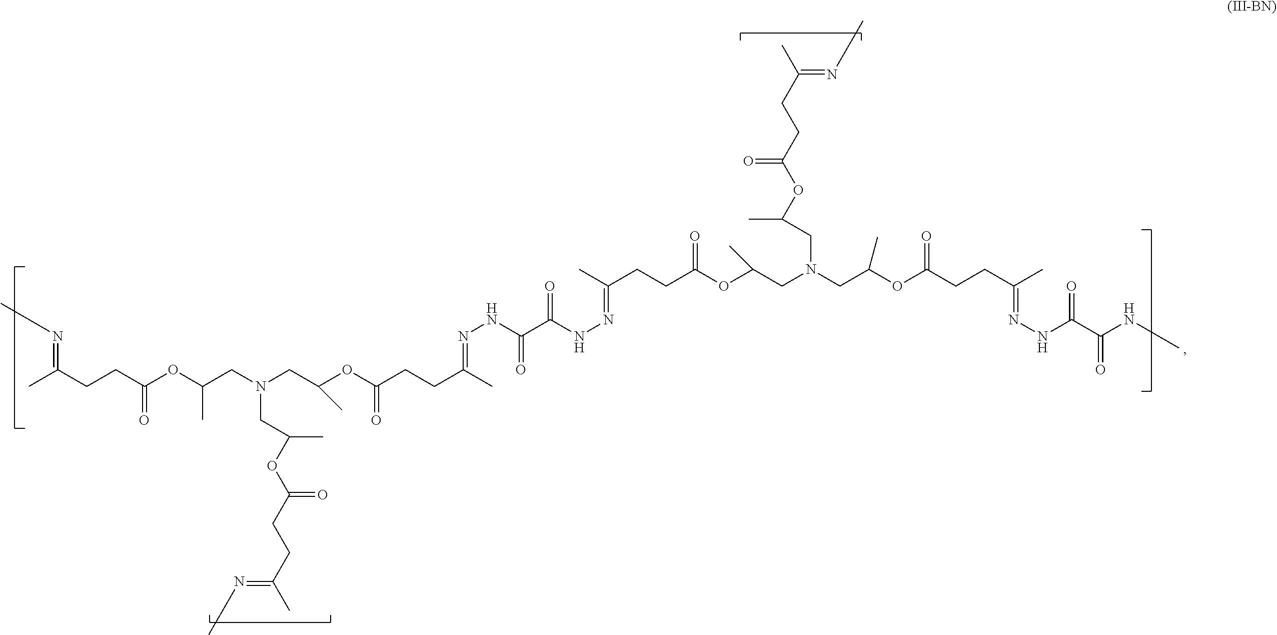

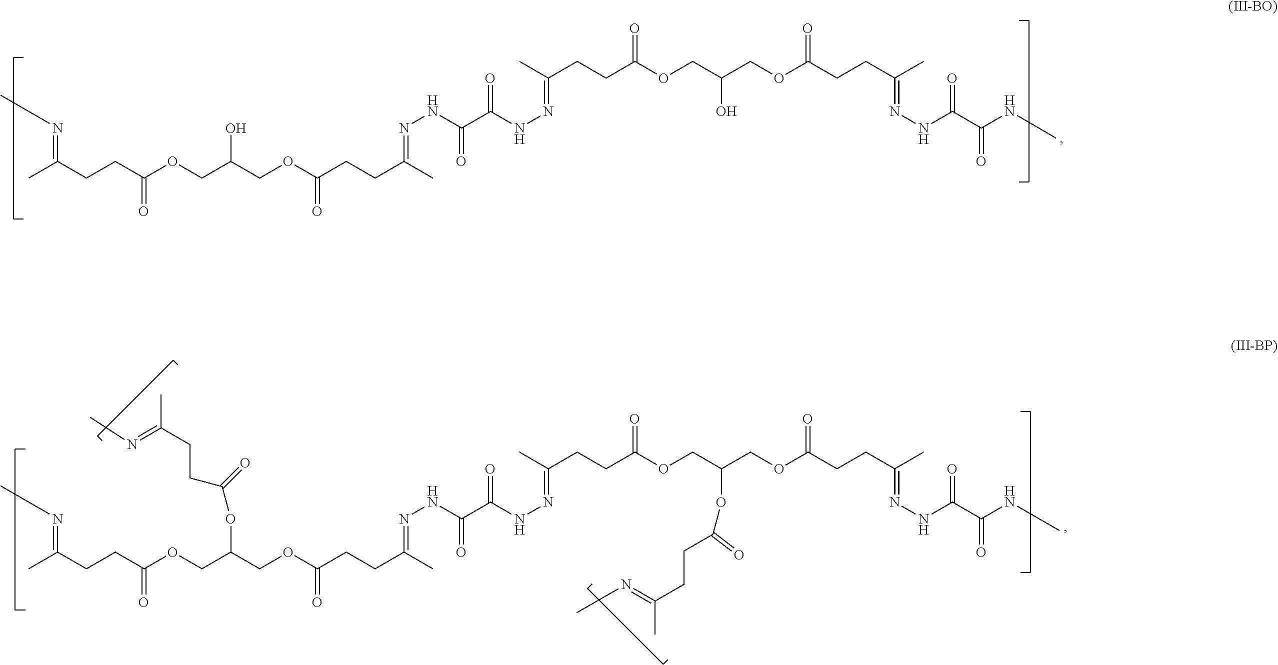

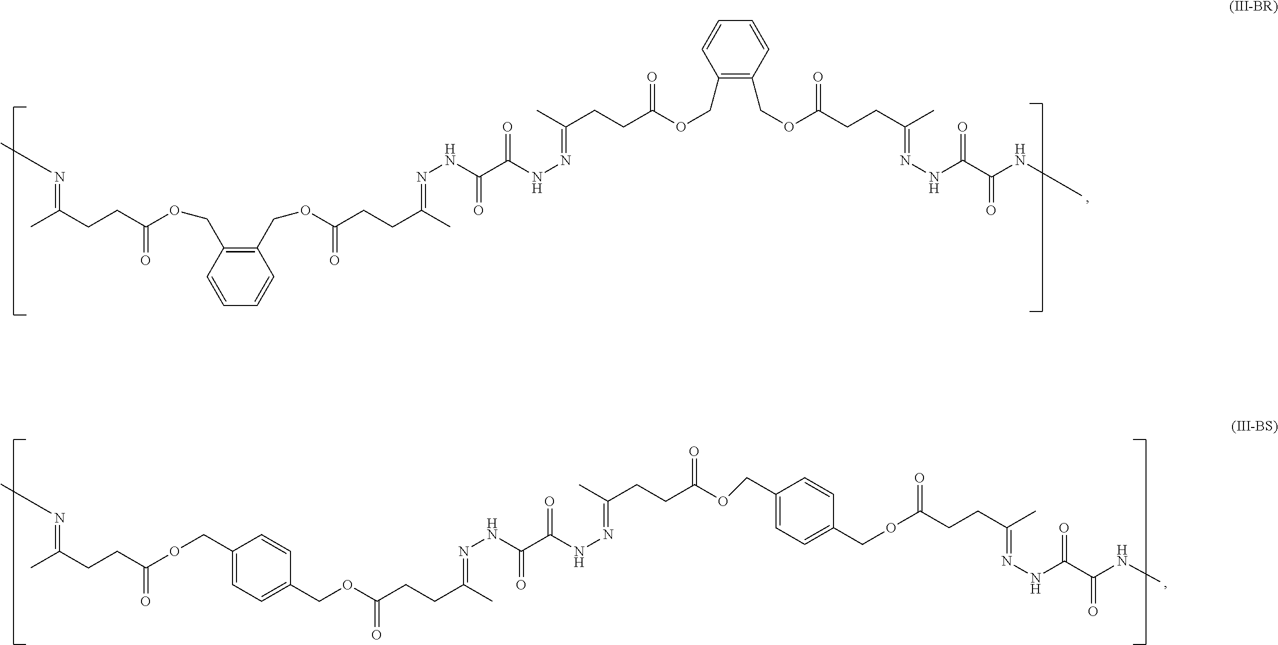

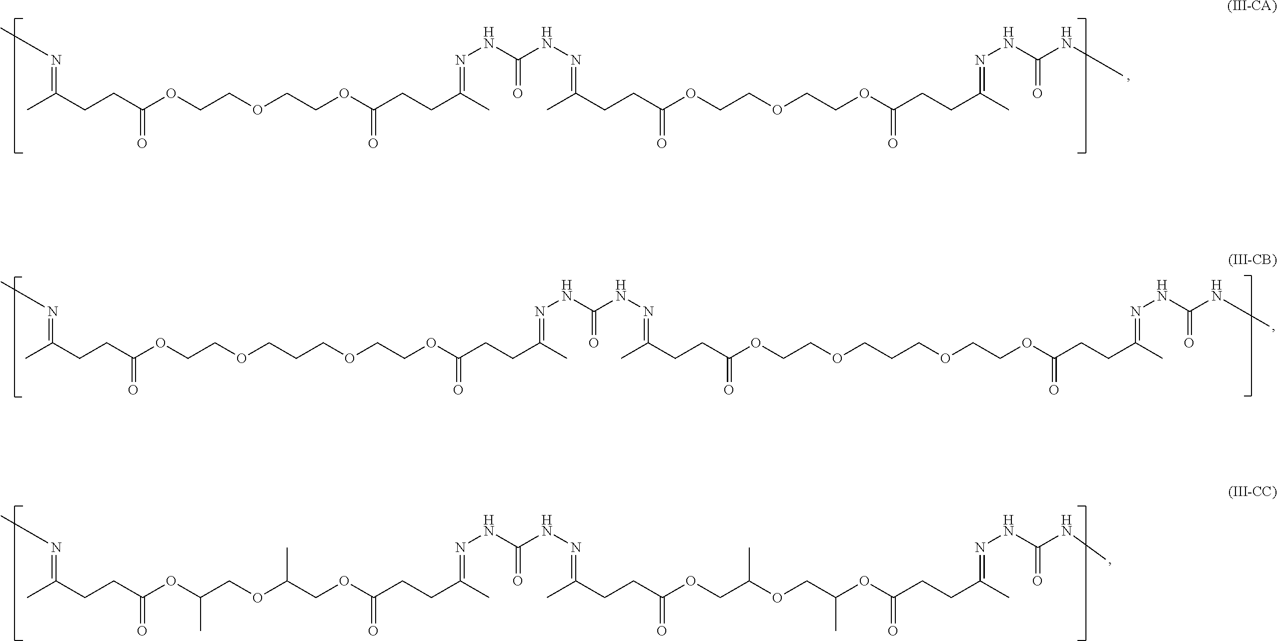

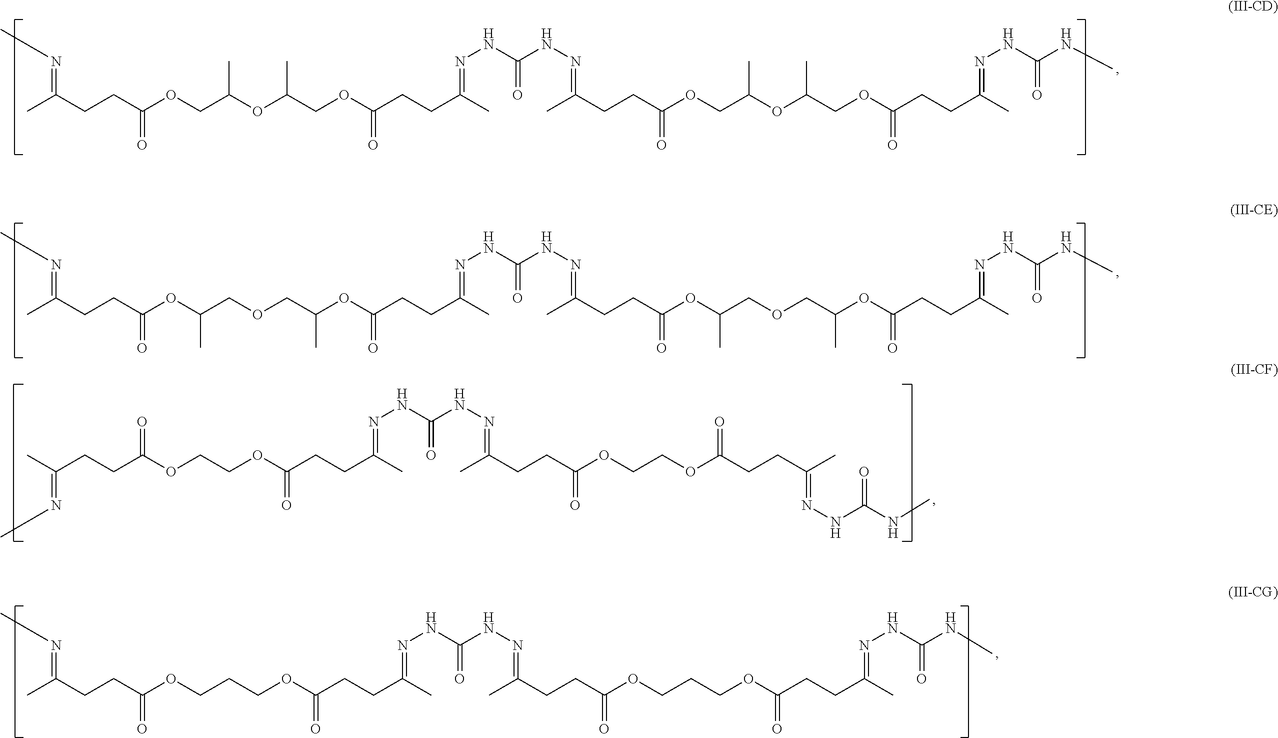

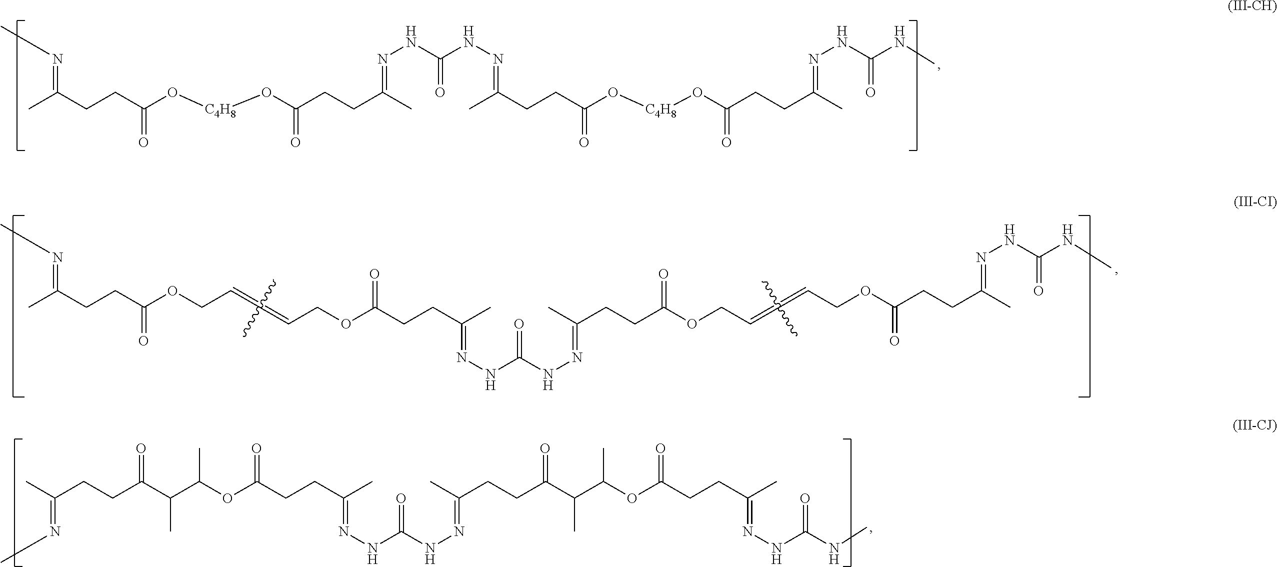

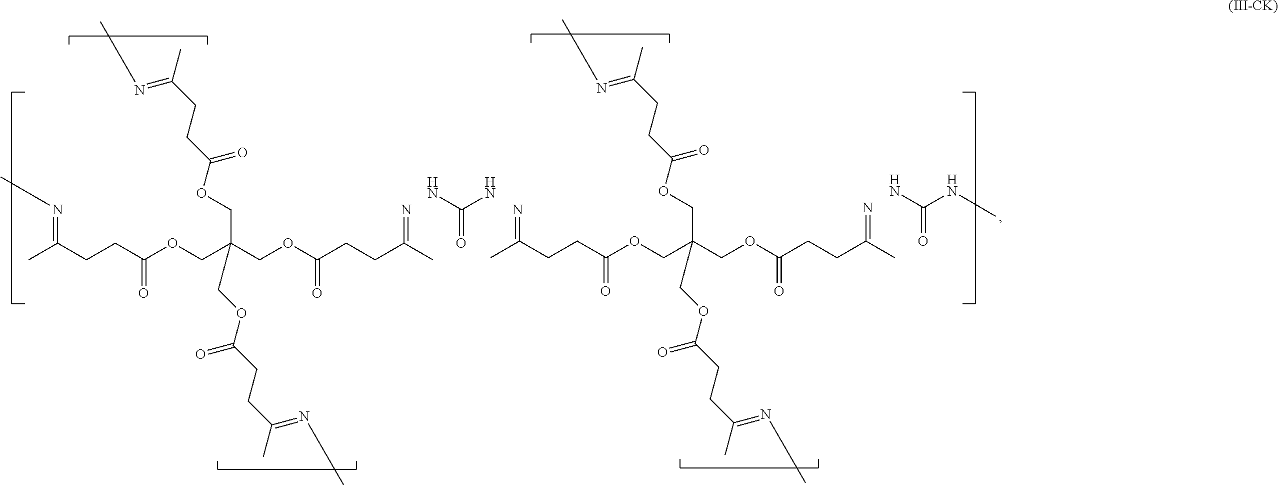

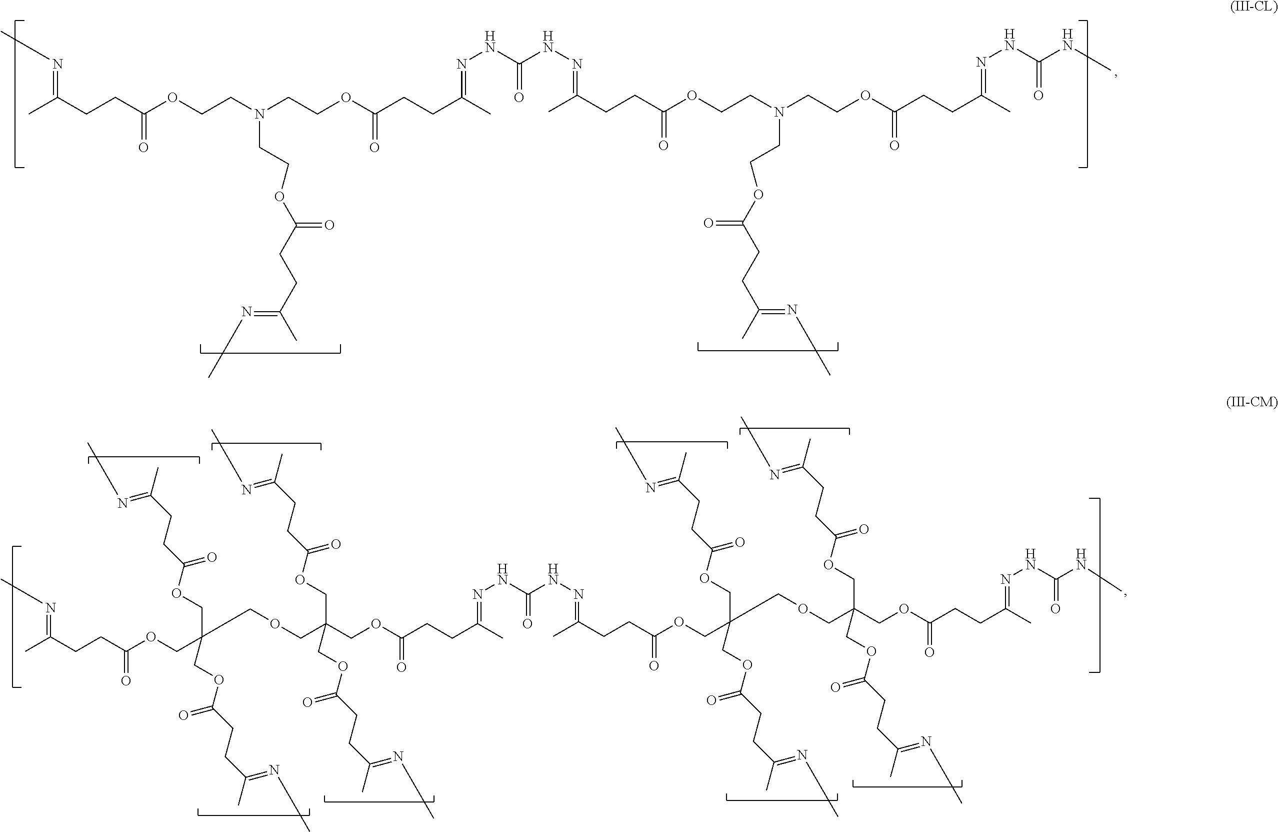

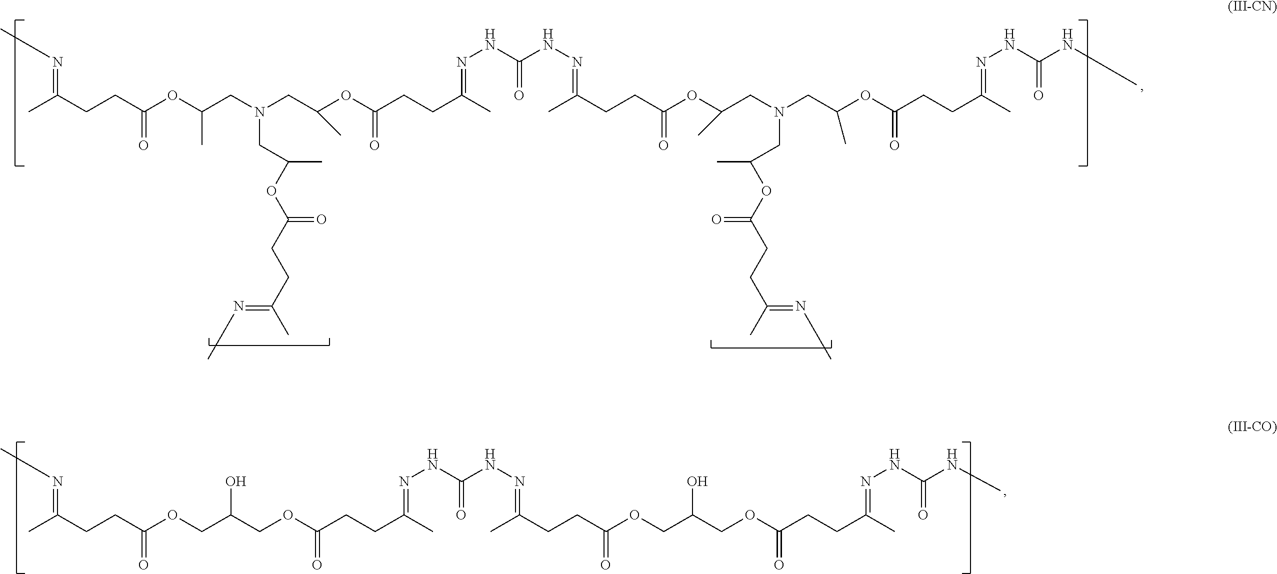

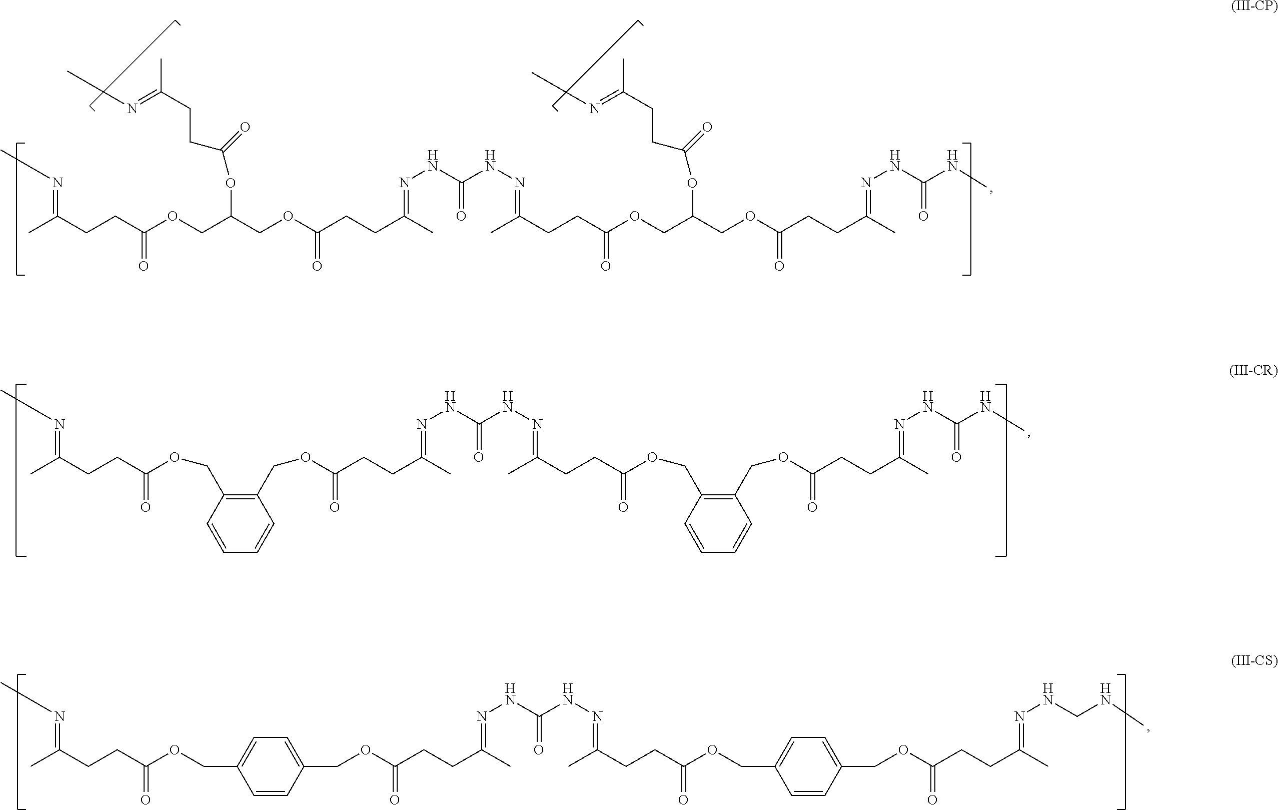

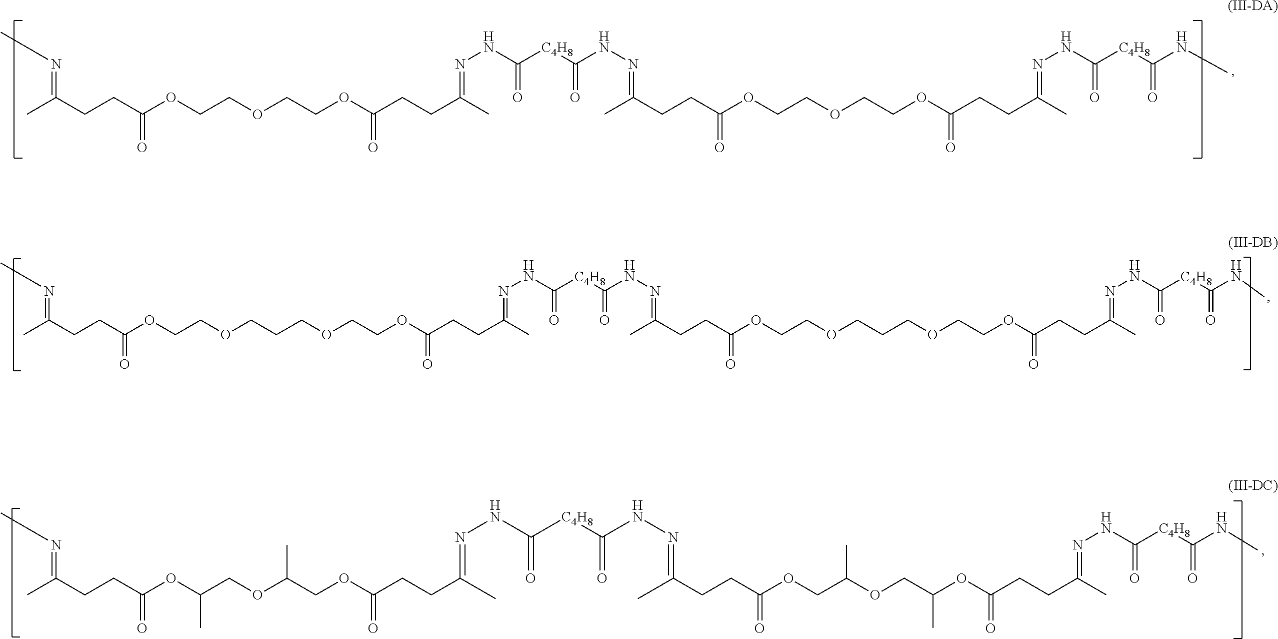

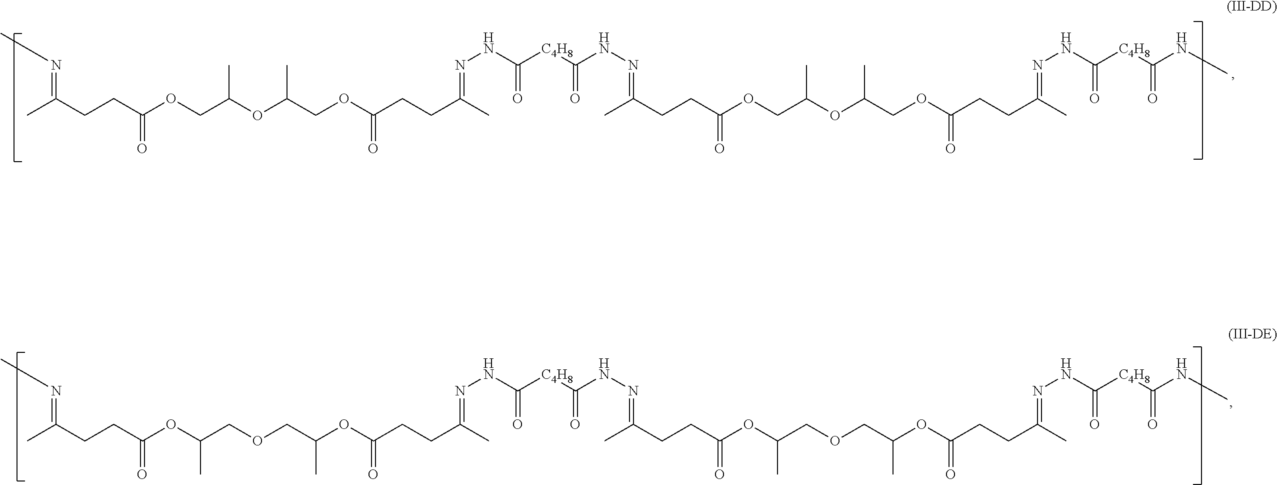

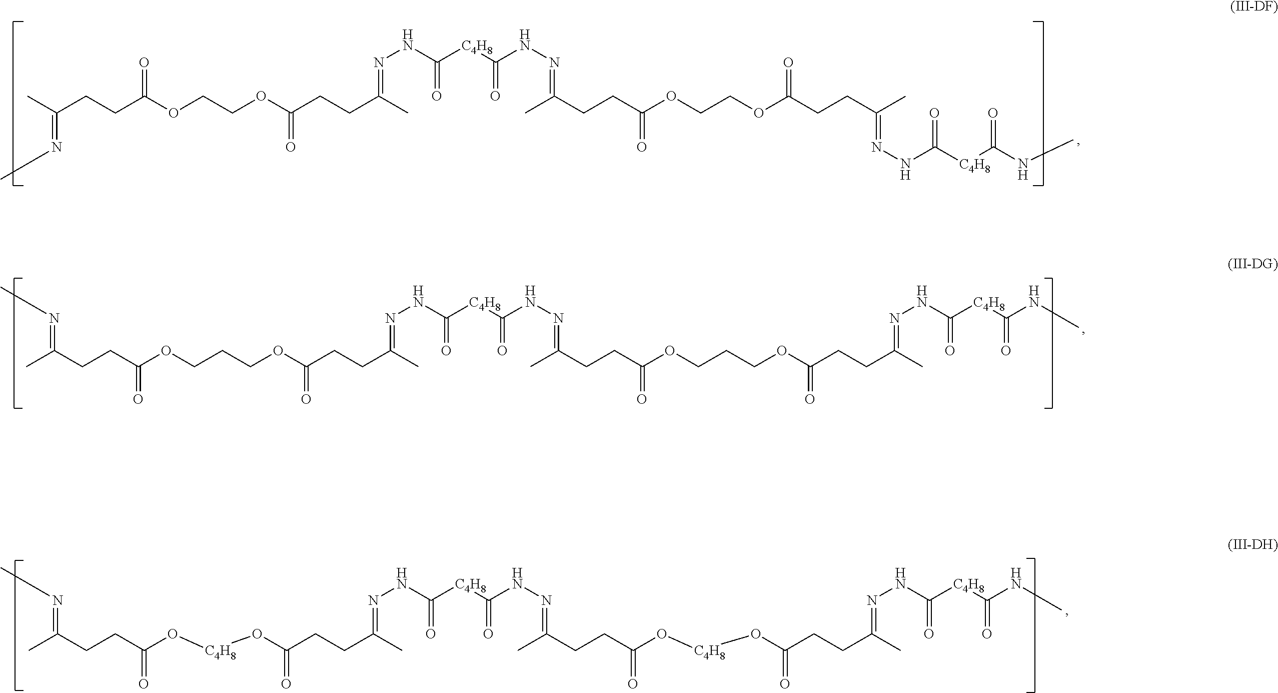

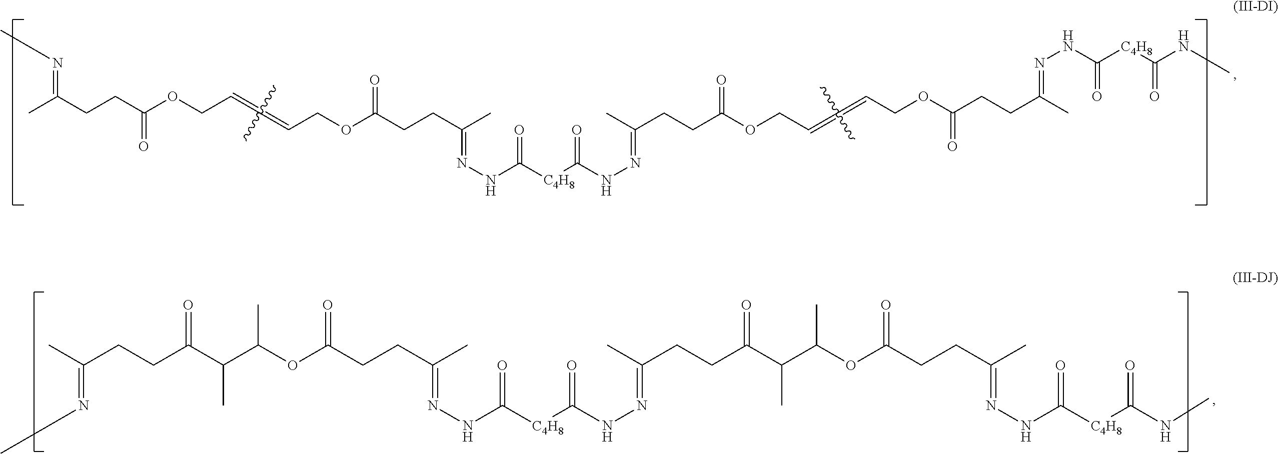

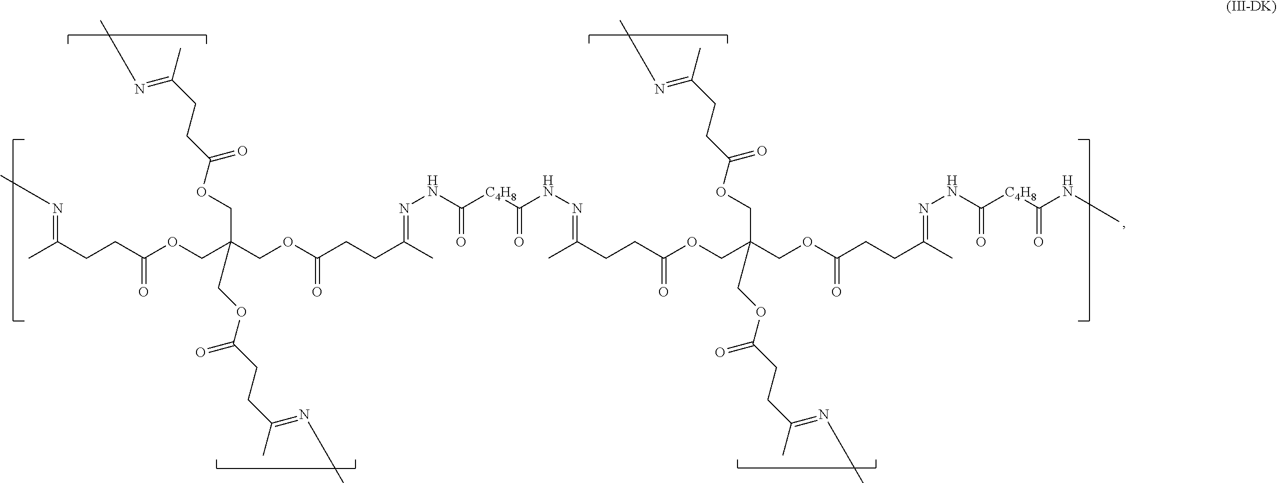

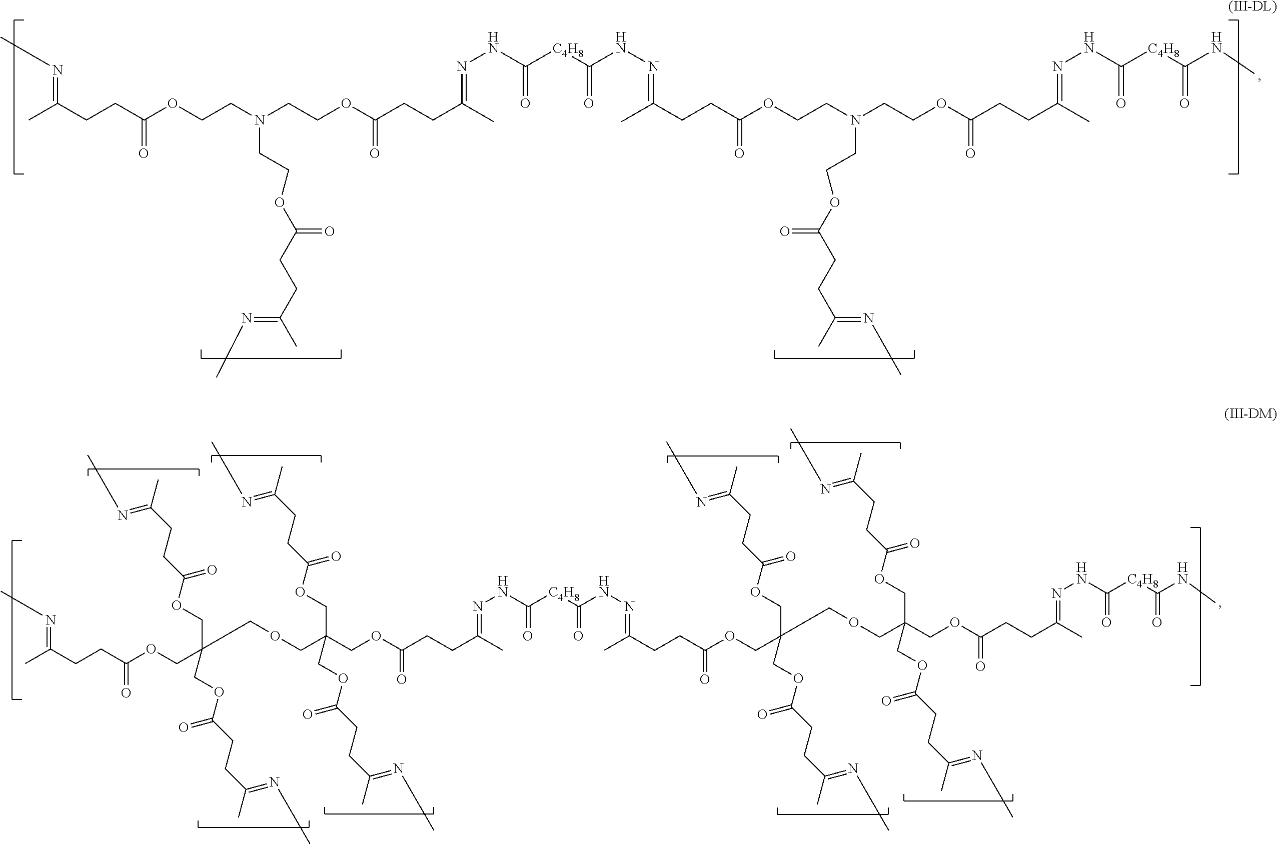

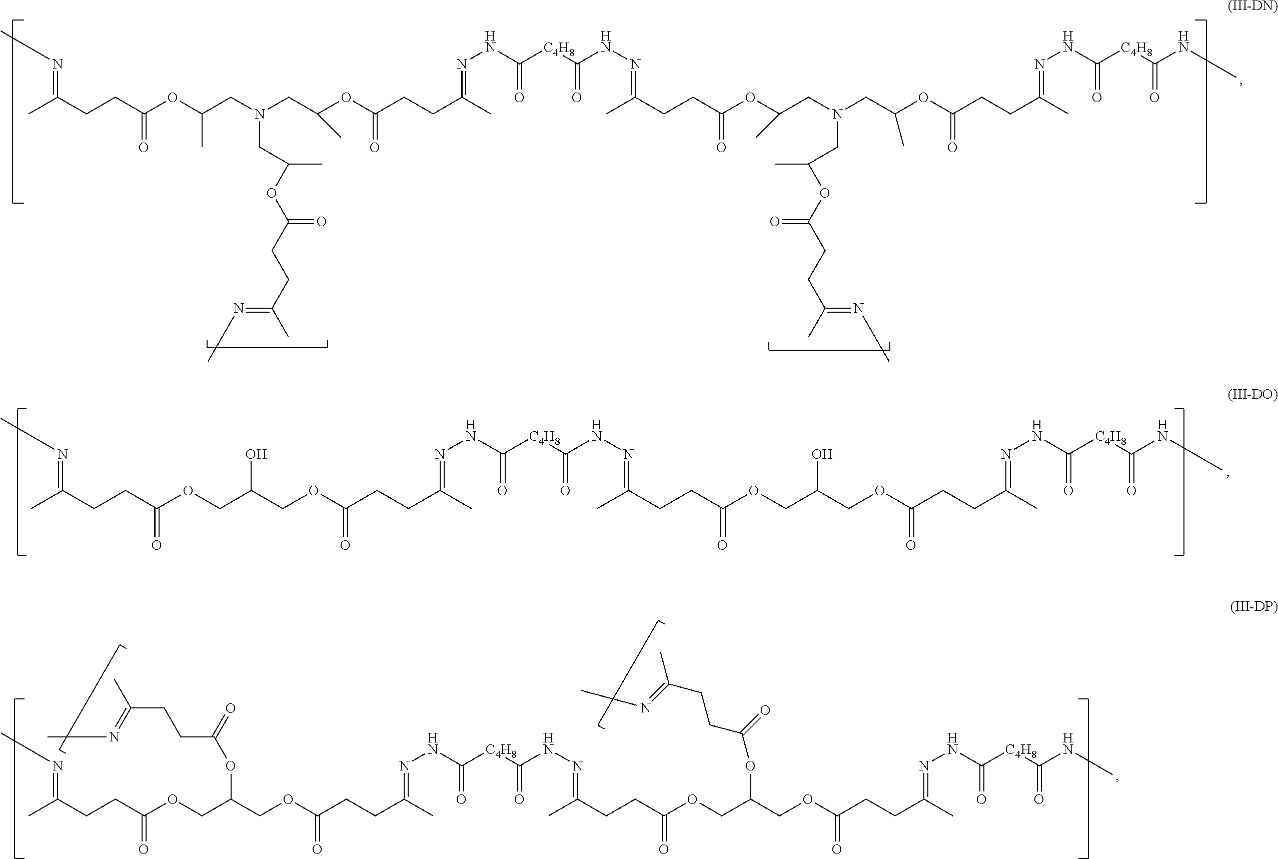

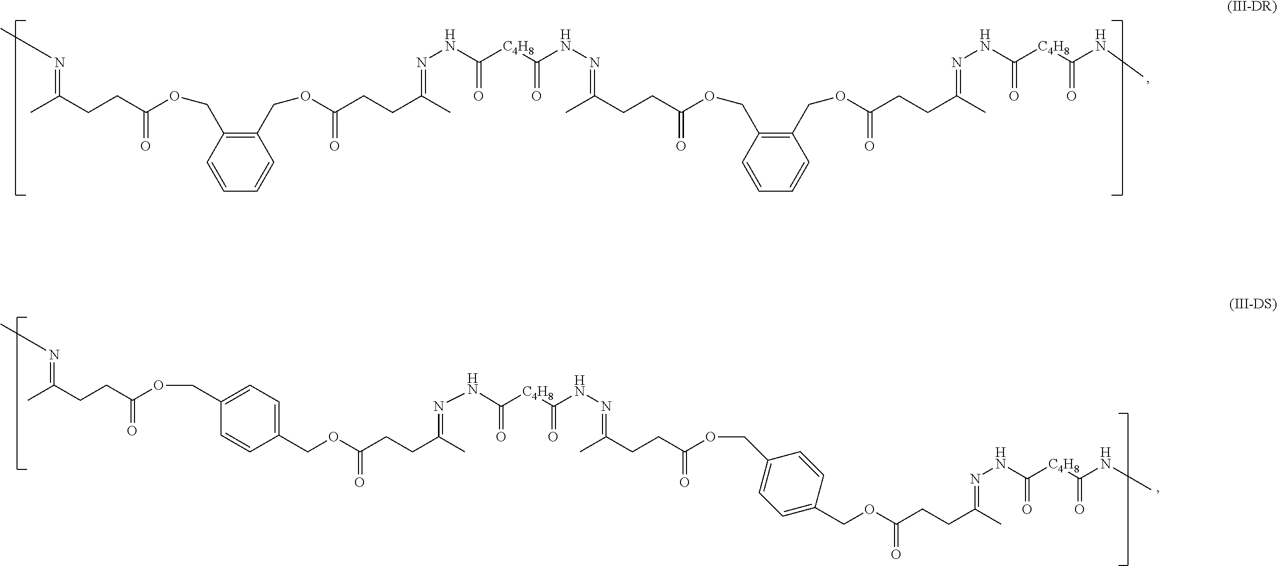

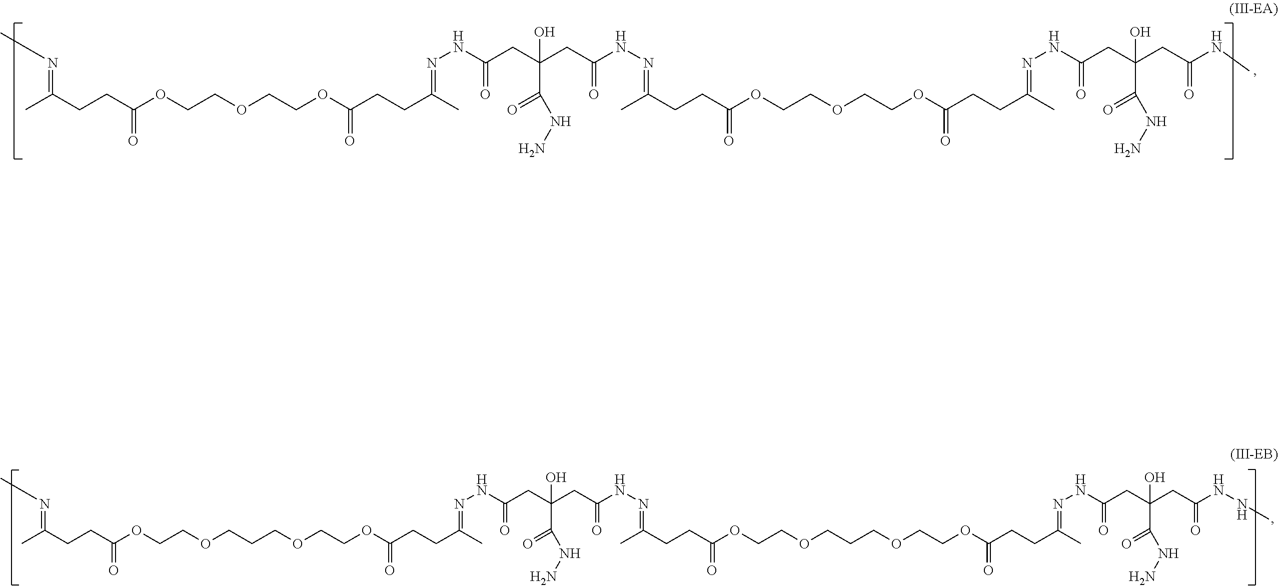

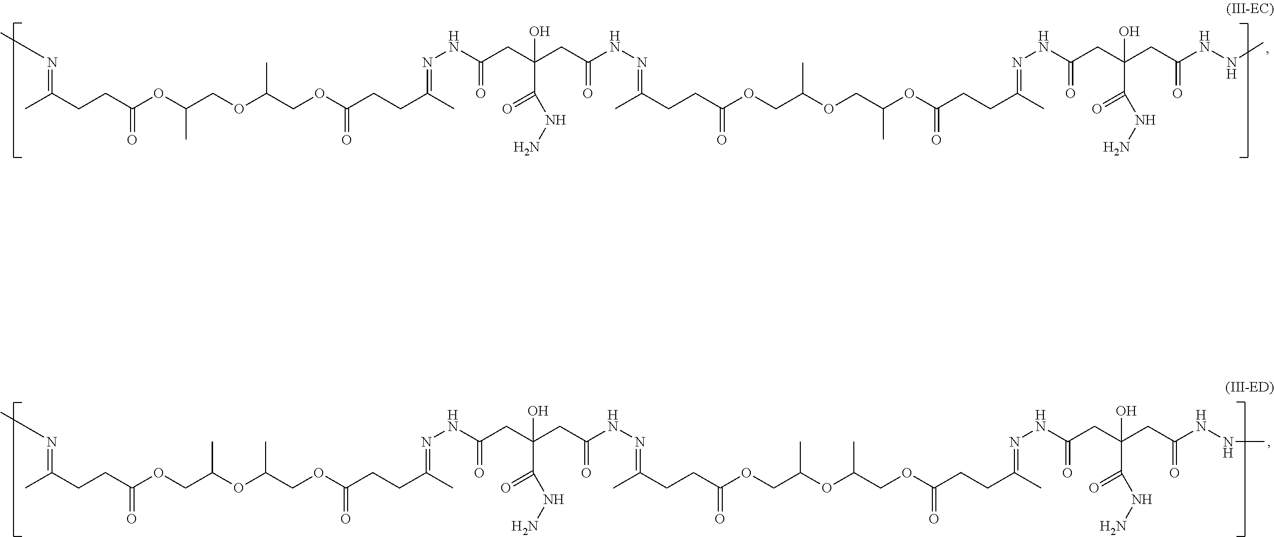

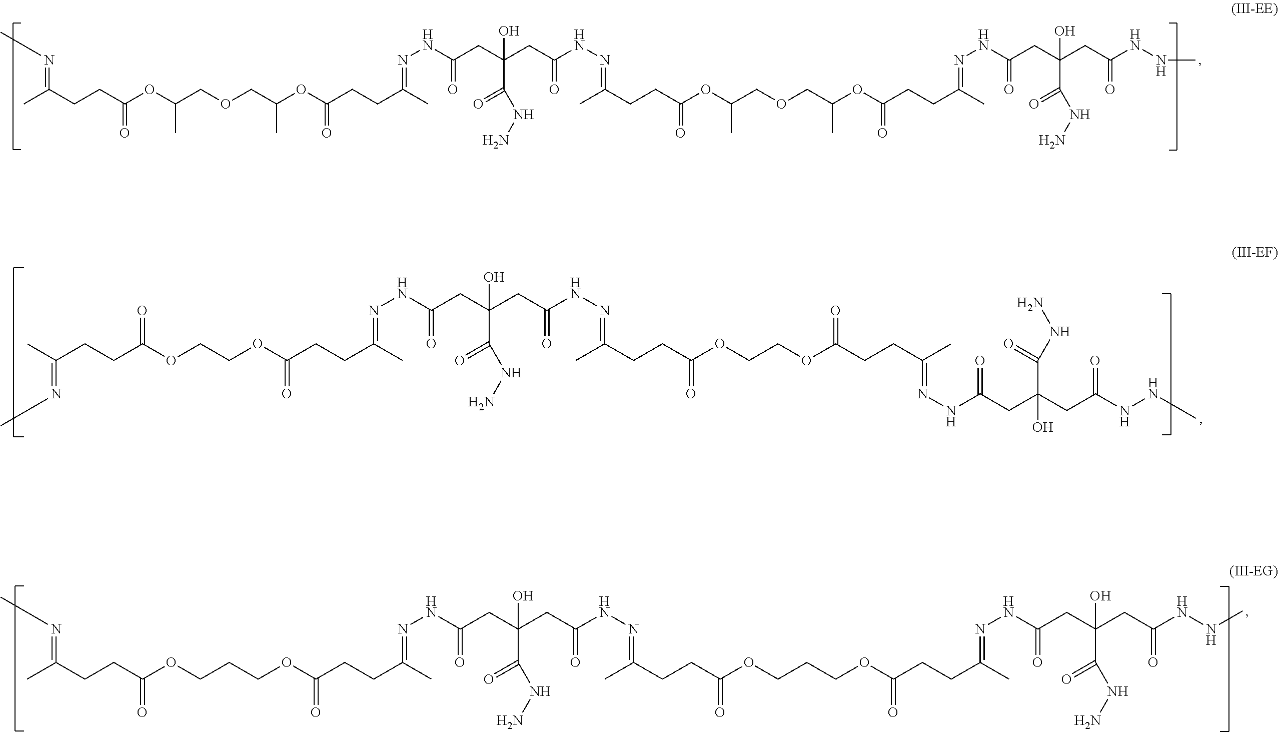

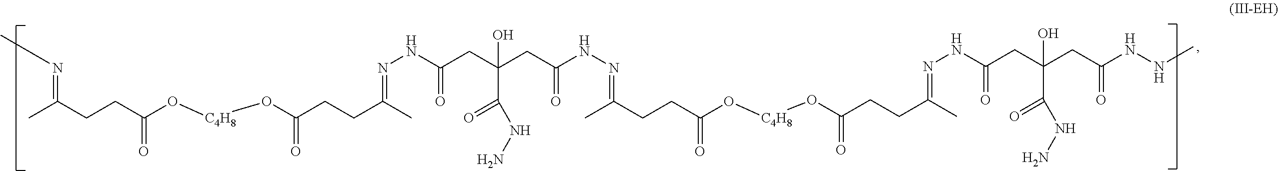

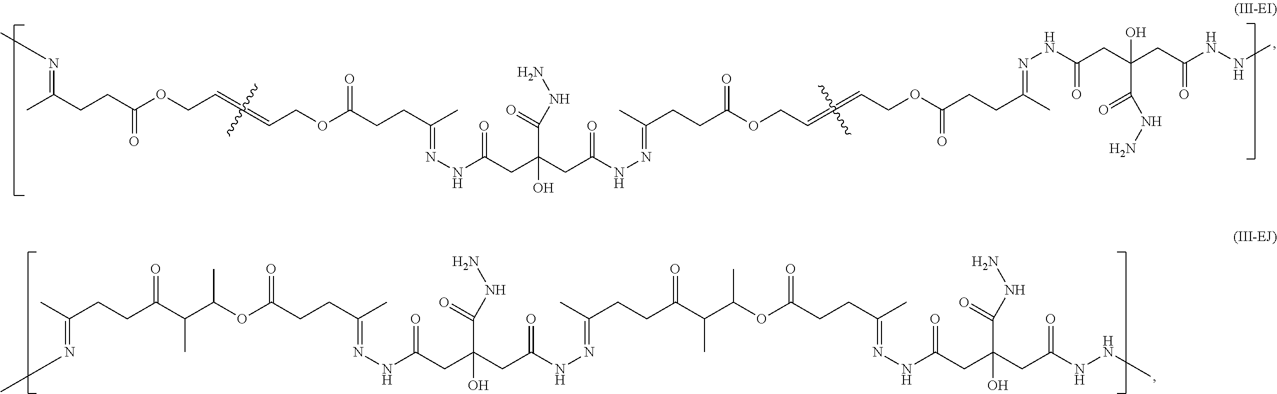

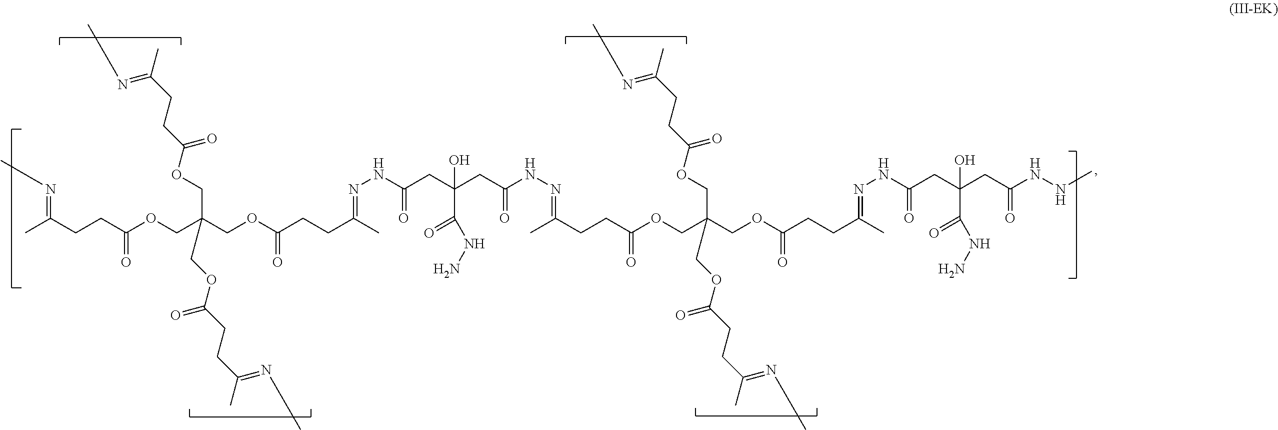

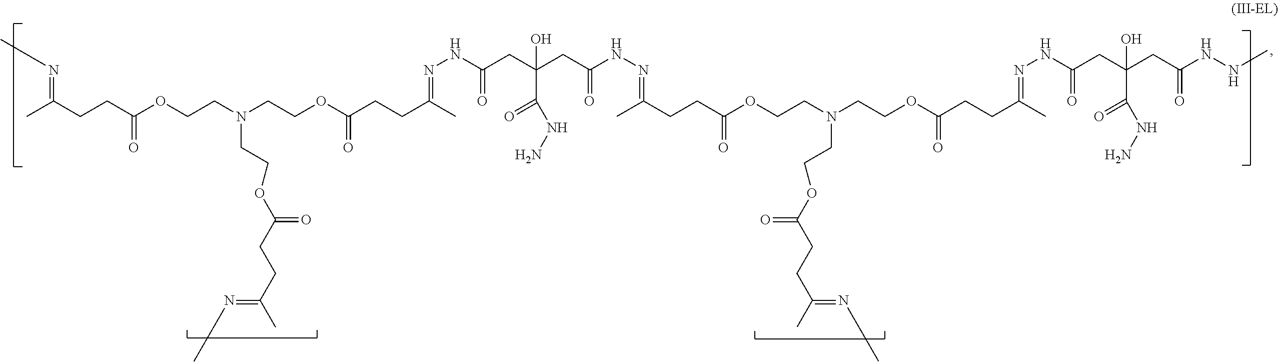

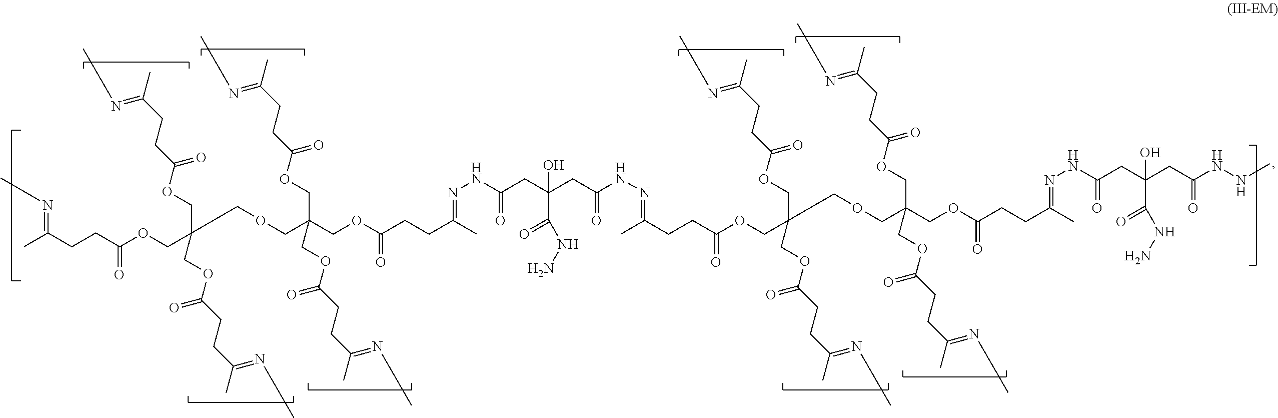

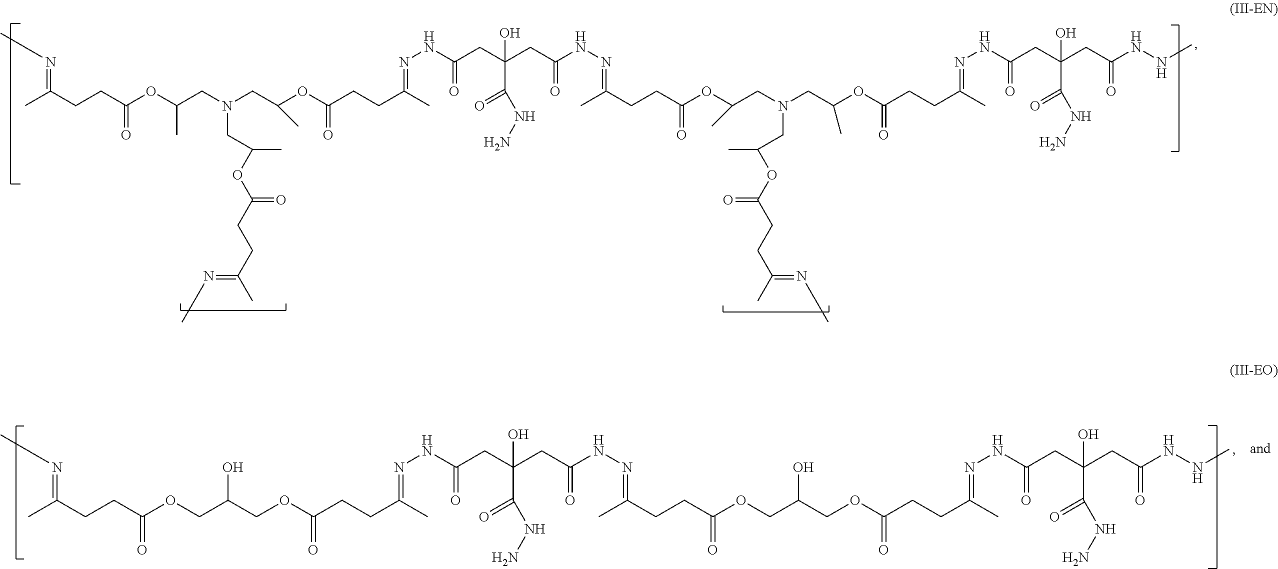

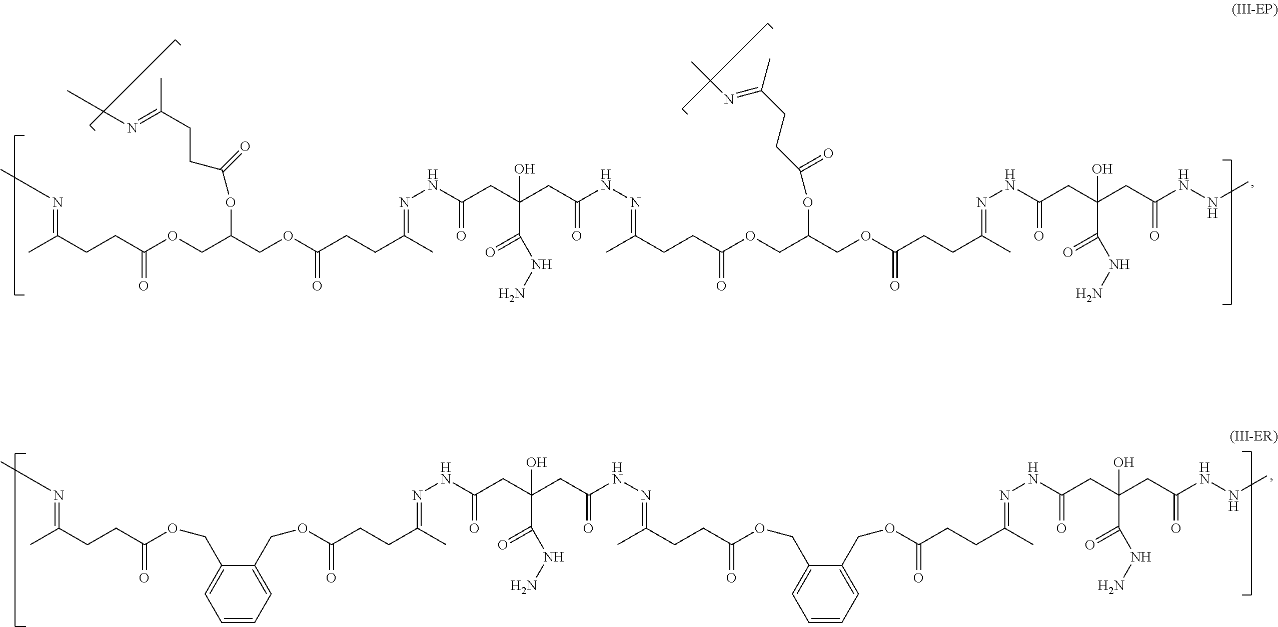

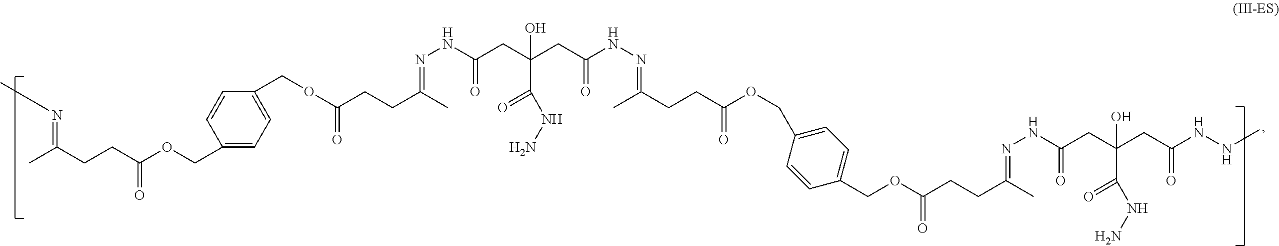

wherein

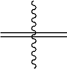

means E or Z carbon-carbon double bond isomers.

In an embodiment of any one of the first to fourth aspects of the invention, the polyketone as hereinbefore described may be derived from a renewable resource.

In an embodiment of any one of the first to fourth aspects of the invention, the composition comprising the acyl hydrazide and polyketone that forms the polyhydrazone compound is an aqueous composition, aqueous suspension, aqueous gel, or emulsion.

In an embodiment of any one of the first to fourth aspects of the invention, the composition comprising the acyl hydrazide and polyketone that forms the polyhydrazone compound is a composition, suspension, gel, or emulsion and is bio-degradable.

In an embodiment of any one of the first to fourth aspects of the invention, the polyhydrazones may be linear, branched, or macrocyclic in structure.

In an embodiment of any one of the first to fourth aspects of the invention, the composition comprising the acyl hydrazide and polyketone that forms the polyhydrazone compound is of low toxicity or is non-toxic.

In a further embodiment of any one of the first to fourth aspects of the invention, the composition comprising the acyl hydrazide and polyketone that forms the polyhydrazone compound may be a water-removable composition, suspension, gel, or emulsion.

In another embodiment of any one of the first to the fourth aspects of the invention, the composition comprising the acyl hydrazide and polyketone that forms the polyhydrazone compound may comprise colour pigments.

In some embodiments of any one of the first to fourth aspects of the invention, the composition comprising the acyl hydrazide and polyketone that forms the polyhydrazone compound is a gel. Preferably, the gel is formed in a solution or suspension of about 10 to about 80% w/v, of polyhydrazone. More preferably, the gel is formed in a solution or suspension of about 20 to about 60% w/v, of polyhydrazone.

In an embodiment of any one of the first to fourth aspects of the invention, the gel may be used as a surface coating and may be applied to a surface. Preferably the surface coating is selected from a paint composition and may contain a proportion of a co-film forming constituent such as an acrylic emulsion or waterborne latex system. It will be appreciated by those of skill in the art that paint systems may further include, but are not limited to one or more selected from additives, binders, biocides, dispersants, detergents, defoamers, pigments, resins, surfactants, thinners and combinations thereof

In an embodiment of any one of the first to fourth aspects of the invention, the gel may be used as a surface coating and may be applied to a surface. Preferably the surface is sealed or unsealed glass, wall board, plasterboard, pre-prepared timber or concrete substrate. Most preferably the surface is a sealed wall board substrate.

In an embodiment of any one of the first to fourth aspects of the invention, the composition is an aqueous gel, and the water evaporates from the gel once it has been applied to the surface. Preferably the gel dries to form a film. Preferably, the film forms at a temperature of about 0° C. to about 80° C. Even more preferably, the film forms at a temperature of about 10° C. to about 50° C. Preferably the film is a flexible film. Alternatively, preferably the film is a rigid film. Preferably, the film is a polyhydrazone film.

In an embodiment of any one of the first to fourth aspects of the invention, the gel forms the coating material by forming a film on the surface to which it is applied when the solvent evaporates.

In a further embodiment of any one of the first to fourth aspects of the invention, the composition comprising the acyl hydrazide and polyketone forms a film on drying which acts as coating material. Preferably, the film can be removed from the surface to which it is applied by washing. For example, the composition may find use in instances of drawing on the surface, vandalism, and/or graffiti on the surface to which the composition comprising has been applied. The film may be a flexible film. Alternatively the film may be a rigid film. Preferably, the film is a polyhydrazone film.

It will be appreciated by those of skill in the art that polyhydrazones formed from reaction between an acyl hydrazide and polyketone may be the principle film forming agent or it may be used in combination with one or more other film forming agents.

In a further embodiment of any one of the first to fourth aspects of the invention, the composition comprising the acyl hydrazide and polyketone is used as medical composition. The medical composition comprising the acyl hydrazide and polyketone may be a medical coating material. The medical coating material may form a protective barrier for wounds on the skin to assist in the healing of wounds and the prevention of infections. Preferably, the protective barrier is a film, even more preferably the film is a polyhydrazone film. The wounds to the skin may be as a result of eczema, scratches, grazes, burns, cuts, abrasions, punctures, lacerations, or surgery. The medical coating material may be used in drug delivery applications in a patient. The method of drug delivery to a patient may be made by a variety of routes, including but not limited to: parenterally, topically, rectally, nasally, buccally, intravenously, intra-muscularly, intra-dermally, subcutaneously or via an implanted reservoir.

It is considered that the compositions comprising the polyketone and the acyl hydrazide form polyhydrazone compounds in aqueous solution, and are hydrated gels, and that on application to a surface, the gel dehydrates forming highly cross-linked films of significantly higher molecular weight than observed in solution. This enhancement of Mw is evidenced by the inability to re-solubilize some films once dehydrated. The evaporation rate and partial re-wettability of the film-forming material provides an increased “open-time” compared to other coating formulations. This permits re-painting and film blending without disruption of the film surface, providing a clean smooth finish. The formation of a polyhydrazone is evidenced by a remarkable increase in the apparent solubility of the acylhydrazide in the solvent. The formation of the polyhydrazone is further evidenced by the remarkable increase in the viscosity of some of the solutions. It is considered that this is not a simple association of molecules enhancing solubility, nor is the acyl hydrazide soluble in the polyketone, that is demonstrated by spectral evidence showing reaction of the ketone. Furthermore, a decrease in NMR-resonances is observed and this is attributed to the ketone moiety forming multiple hydrazone species. While not wishing to be bound by theory, it is believed that the polyhydrazones formed from the compositions comprising the acyl hydrazide and polyketone could be kinetically locked under neutral conditions (Deng, Li et al. 2012). That is, while the formation of imines from aliphatic amines and aldehydes is rapid, so also is the hydrolysis. Previously synthesized hydrazones (and oximes) are reported to be stable excepting below pH 4 or at high temperatures where hydrolysis may proceed with appreciable rate (Nguyen and Ivan Huc 2003).

The films formed by the present invention may be re-suspended in water; however, re-suspension is highly dependent on the functional moieties present within the polyhydrazone compound, e.g., dependant on the substituents, their polarities and intramolecular hydrogen bonding and other electrostatic interactions. In some cases, the polyhydrazone compound while in solution forms a gel, and the gel dehydrates to further form a film. Often this film cannot be re-suspended in water, forming a water-resistant coating even though cast from a fully solvated aqueous solution. This irreversible solution chemistry is desirable for some coatings applications and those skilled in the art will recognise such behaviour is sometimes observed in other systems where a polymer cannot be redissolved once it has precipitated from its solvent.

An advantage of using the composition derived from a polyketone and an acyl hydrazide as discussed herein is that one component (e.g. polyketone) and an excipient can be solubilised and then cross-linked with an acylhydrazide. This permits formation of the ketone-matrix in an aqueous solution, and depending on the composition, can be completed either at room temperature or elevated temperatures using mixing shear if required. This is particularly useful for incorporating larger molecules into the matrix or suspended components, e.g. glucosaminoglycans and peptides and then crosslinking in a homogeneous manner with the hydrazide addition forming a uniform solution or gel.

While not wishing to be bound by theory, it is believed that the polyhydrazones formed from compositions comprising the acyl hydrazide and polyketone in aqueous solution are small, for example, the ethyleneglycol-linked dilevulinyl species reacted with ADH to give a polyhydrazone (III-F), and appears to have a compound of MW 810 as the major species in solution, which is made up of from about 4 monomeric units. The small molecular weight (of from about 800 to about 10,000 Da) is supported by aqueous-based size exclusion chromatography when compared to polyethylene glycol (PEG) polymer standards of known weight where the SEC major species as detected by refractive index were <2000 Mw.

A Mw of the major species in aqueous and organic solution being <2000 Mw is also further supported by NMR end group analysis and mass-spectral data. End group analysis by NMR and mass-spectral data was consistent with the major species for an aqueous solution of formula III-F being the species comprised of 4-monomeric units.

The Mw of the major species in aqueous and organic solution being <2000 Mw is also further supported by the observation by mass-spectral data of molecular ions consistent with macrocyclic species as well as open-chain linear species.

The low Mw in solution was further supported by the relatively low viscosity of the aqueous solutions where it was observed that polyhydrazone solutions were generally still free flowing at room temperature. Without wishing to be bound by theory, if the molecular weight was high, the composition would be far more viscous, especially at a concentration of ˜60% w/v. Those skilled in the art will recognise that the viscosity of the solution is highly dependent on the polymer solubility and composition, such that without appropriate standards, a true Mw is problematic to ascertain by viscosity measurement. The viscosity of 20-60% w/v aqueous solutions of polyhydrazones was typically between 5 and 50 centistokes (cSt) in comparison to poly(dimethylsiloxane) reference solutions.

It will be appreciated by those of skill in the art that the formation of the hydrazone linkage between an acyl hydrazide and a non-symmetric ketone results in both E and Z isomeric forms. For simplicity, the formulae drawn herein describe only the E isomer. However, it should be understood that the hydrazone linkage is a distribution of both E and Z isomers for all of the polymers described herein derived from levulinyl polyesters. Therefore, the invention includes both E and Z isomers of the polyhydrazone polymer and is not limited to the specific isomer drawn.

It will also be understood by those of skill in the art, that syn and anti amide linkage arrangements are possible. For simplicity, the formulae drawn herein describe only the syn isomer. However, it should also be understood that the amide linkage is a distribution of both syn and anti isomers for the polymers described herein that are derived from acyl hydrazides. Therefore, the invention includes both syn and anti isomers and is not limited to the specific isomer drawn.

Where the foregoing description reference has been made to integers having known equivalents thereof, those equivalents are herein incorporated as if individually set forth. Although the invention has been described in connection with specific preferred embodiments, it should be understood that the invention as claimed should not be unduly limited to such specific embodiments. It is appreciated that further modifications may be made to the invention as described herein without departing from the spirit and scope of the invention.

### DEFINITIONS

Unless the context clearly requires otherwise, throughout the description and the claims, the words “comprise”, “comprising” and the like, are to be construed in an inclusive sense as opposed to an exclusive or exhaustive sense, that is to say, in the sense of “including, but not limited to”.

As described herein, compounds of the invention may optionally be substituted with one or more substituents, such as are illustrated generally above, or as exemplified by particular classes, subclasses, and species of the invention. It will be appreciated that the phrase “optionally substituted” is used interchangeably with the phrase “substituted or unsubstituted.” In general, the term “substituted”, whether preceded by the term “optionally” or not, refers to the replacement of hydrogen radicals in a given structure with the radical of a specified substituent. Or, alternatively, the term refers to replacement of carbon radicals in a given structure with the radical of a specified substituent. Unless otherwise specified, an optionally substituted group may have a substituent at each substitutable position of the group, and when more than one position in any given structure may be substituted with more than one substituent selected from a specified group, the substituent may be either the same or different at every position. Combinations of substituents envisioned by this invention are preferably those that result in the formation of stable or chemically feasible compounds. Optional substituents include but are not limited to aliphatic, amino, (aliphatic)amino, amido, (aliphatic)amido, aryl, (aliphatic)aryl, cyano, carbonyl, heteroatoms (O, N, S, P, wherein the heteroatoms may be further substituted with hydrogen, aliphatic, amino, aryl, heteroaryl, heterocyclyl), hydroxy and thioaliphatic, wherein C₁₋₁₀ aliphatic means any independently selected, optionally substituted, branched or straight chain C₁₋₁₀ alkylene, C₂₋₁₀ alkenyl, C₂₋₁₀ alkynyl or C₃₋₁₂ carbocycle,

The term “aliphatic” or “aliphatic group” as used herein, means an un-branched or branched, straight-chain or cyclic, substituted or unsubstituted hydrocarbon that is completely saturated or contains one or more units of unsaturation. Suitable aliphatic groups include, but are not limited to, cyclic, linear or branched, substituted or unsubstituted alkyl, alkenyl, or alkynyl groups. Specific examples include, but are not limited to, methyl, methylene ethyl, iso-propyl, n-propyl, sec-butyl, vinyl, n-butenyl, ethynyl, and tert-butyl, cyclopropyl, cyclohexyl. Any aliphatic group may optionally be substituted with one or more substituents selected from aliphatic, amino, (aliphatic)amino, amido, (aliphatic)amido, aryl, (aliphatic)aryl, cyano, carbonyl, heteroatoms (O, N, S, P, wherein the heteroatoms may be further substituted with hydrogen, aliphatic, amino, aryl, heteroaryl, heterocyclyl), hydroxy and thioaliphatic, wherein C₁₋₁₀ aliphatic means any independently selected, optionally substituted, branched or straight chain C₁₋₁₀ alkylene, C₂₋₁₀ alkenyl, C₂₋₁₀ alkynyl or C₃₋₁₂ carbocycle.

The term “alkyl” as used herein means any saturated hydrocarbon radical having up to 30 carbon atoms and includes any C₁-C₂₅, C₁-C₂₀, C₁-C₁₅, C₁-C₁₀, or C₁-C₆ alkyl group, and is intended to include cyclic, straight-, branched- and unbranched-chain alkyl groups, and has a single point of attachment to the rest of the molecule. Examples of alkyl groups include but are not limited to: methyl group, ethyl group, n-propyl group, iso-propyl group, n-butyl group, iso-butyl group, sec-butyl group, t-butyl group, n-pentyl group, 1,1-dimethylpropyl group, 1,2-dimethylpropyl group, 2,2-dimethylpropyl group, 1-ethylpropyl group, 2-ethylpropyl group, n-hexyl group and 1-methyl-2-ethylpropyl group. Any alkyl group may optionally be substituted with one or more substituents selected from aliphatic, amino, (aliphatic)amino, amido, (aliphatic)amido, aryl, (aliphatic)aryl, cyano, carbonyl, heteroatoms (O, N, S, P, wherein the heteroatoms may be further substituted with hydrogen, aliphatic, amino, aryl, heteroaryl, heterocyclyl), hydroxy and thioaliphatic, wherein C₁₋₁₀ aliphatic means any independently selected, optionally substituted, branched or straight chain C₁₋₁₀ alkylene, C₂₋₁₀ alkenyl, C₂₋₁₀ alkynyl or C₃₋₁₂ carbocycle.

The term “lower alkyl” means any alkyl group as defined above having a straight-, branched- and unbranched saturated hydrocarbon radical having from 1 to 6 carbon atoms.

The term “alkylene” is intended to mean any saturated hydrocarbon radical having up to 30 carbon atoms, has two or more points of attachment to the rest of the molecule, includes any C₁-C₂₅, C₁-C₂₀, C₁-C₁₅, C₁-C₁₀, or C₁-C₆ alkylene group, and is intended to include but not limited to straight-, branched- and unbranched-groups. Examples of alkylene groups include, but are not limited to: methylene (—CH₂—) group, ethylene [—CH₂—CH₂—] group, n-propylene [(—CH₂—)₃] group, n-butylene group [(—CH₂—)₄], n-pentylene group [(—CH₂—)₅]. Any alkylene group may optionally be substituted with one or more substituents selected from the aliphatic, amino, (aliphatic)amino, amido, (aliphatic)amido, aryl, (aliphatic)aryl, cyano, carbonyl, heteroatoms (O, N, S, P, wherein the heteroatoms may be further substituted with hydrogen, aliphatic, amino, aryl, heteroaryl, heterocyclyl), hydroxy and thioaliphatic, wherein C₁₋₁₀ aliphatic means any independently selected, optionally substituted, branched or straight chain C₁₋₁₀ alkylene, C₂₋₁₀ alkenyl, C₂₋₁₀ alkynyl or C₃₋₁₂ carbocycle.

The term “alkenyl” means any hydrocarbon radical having at least one double bond, and having up to 30 carbon atoms, and includes any C₂-C₂₅, C₂-C₂₀, C₂-C₁₅, C₂-C₁₀, or C₂-C₆ alkenyl group, and is intended to include both straight- and branched-chain alkenyl groups. Such groups may have one or more points of attachment and may form terminal units or part of a chain. Examples of alkenyl groups include but are not limited to: ethenyl group, n-propenyl group, iso-propenyl group, n-butenyl group, iso-butenyl group, sec-butenyl group, t-butenyl group, n-pentenyl group, 1,1-dimethylpropenyl group, 1,2-dimethylpropenyl group, 2,2-dimethylpropenyl group, 1-ethylpropenyl group, 2-ethylpropenyl group, n-hexenyl group and 1-methyl-2-ethylpropenyl group. Any alkenyl group may optionally be substituted with one or more substituents selected from the group consisting of alkoxy, heteroatoms, hydroxy, halogen, amino, amido, aryl, heteroaryl, hydrazones or hydrazides. Any alkenyl group may optionally be substituted with one or more substituents selected from aliphatic, amino, (aliphatic)amino, amido, (aliphatic)amido, aryl, (aliphatic)aryl, cyano, carbonyl, heteroatoms (O, N, S, P, wherein the heteroatoms may be further substituted with hydrogen, aliphatic, amino, aryl, heteroaryl, heterocyclyl), hydroxy and thioaliphatic, wherein C₁₋₁₀ aliphatic means any independently selected, optionally substituted, branched or straight chain C₁₋₁₀ alkylene, C₂₋₁₀ alkenyl, C₂₋₁₀ alkynyl or C₃₋₁₂ carbocycle.

The term “lower alkenyl” means any hydrocarbon radical having at least one unit of double bond saturation, and having from 2 to 6 carbon atoms, and is intended to include both straight- and branched-chain alkenyl groups.

The term “alkynyl” means unsaturated hydrocarbon radicals having at least one triple bond and has up to 30 carbon atoms, and includes any C₂-C₂₅, C₂-C₂₀, C₂-C₁₅, C₂-C₁₀, or C₂-C₆ alkynyl group, and is intended to include but not limited to both straight- and branched-chain alkynyl groups. Such groups may form part of a chain as a divalent moiety [—C≡C—] or form the terminal end of a chain [—C≡CH]. Examples of alkynyl groups include but are not limited to: ethynyl group [—C≡C—], n-propynyl group [—H₂C—C≡C—]. Any alkynyl group may optionally be substituted with one or more substituents selected from aliphatic, amino, (aliphatic)amino, amido, (aliphatic)amido, aryl, (aliphatic)aryl, cyano, carbonyl, heteroatoms (O, N, S, P, wherein the heteroatoms may be further substituted with hydrogen, aliphatic, amino, aryl, heteroaryl, heterocyclyl), hydroxy and thioaliphatic, wherein C₁₋₁₀ aliphatic means any independently selected, optionally substituted, branched or straight chain C₁₋₁₀ alkylene, C₂₋₁₀ alkenyl, C₂₋₁₀ alkynyl or C₃₋₁₂ carbocycle.

The term “animal” is intended to mean human and non-human subjects. For example, humans; domesticated stock including cows, sheep, goats, horses, pigs; domesticated pets including cats, dogs; wild animals including monkeys, birds, amphibians, reptiles; and, aquatic life forms such as fish.

The term “aralkyl” or “alkaryl” means an aryl group which is attached to an alkylene moiety, where aryl and alkylene are as defined above. Examples include, but are not limited to a benzyl group.

The term “aryl” or “Ar” means an aromatic radical, having 4 to 18 carbon atoms and includes heteroaromatic radicals. Examples include but are not limited to monocyclic groups, as well as fused groups such as bicyclic groups and tricyclic groups. Examples include phenyl group, indenyl group, 1-naphthyl group, 2-naphthyl group, azulenyl group, heptalenyl group, biphenyl group, indacenyl group, acenaphthyl group, fluorenyl group, phenalenyl group, phenanthrenyl group, anthracenyl group, cyclopentacyclooctenyl group, and benzocyclooctenyl group, pyridyl group, pyrrolyl group, pyridazinyl group, pyrimidinyl group, pyrazinyl group, triazolyl group (including a 1-H-1,2,3-triazol-1-yl and a 1-H-1,2,3-triazol-4-yl group), tetrazolyl group, benzotriazolyl group, pyrazolyl group, imidazolyl group, benzimidazolyl group, indolyl group, isoindolyl group, indolizinyl group, purinyl group, indazolyl group, furyl group, pyranyl group, benzofuryl group, isobenzofuryl group, thienyl group, thiazolyl group, isothiazolyl group, benzothiazolyl group, oxazolyl group, and isoxazolyl group. The term “aryl” may be used interchangeably with the term “aryl ring”. The term “aryl” also includes heteroaryl ring systems as defined below.

The term “alkoxy” means an OR group, where R is alkyl as defined above. The term “lower alkoxy” means an OR^{#} group, where R^{#} is “lower alkyl” as defined above.

The term “alkenyloxy” means an OR′ group, where R′ is alkenyl as defined above.

The term “aryloxy” means an OR″ group, where R″ is aryl as defined above.

The term “acyl” means C(═O)R′″ group, where R′″ is alkyl as defined above.

The term “amine” or “amino” may be used interchangeably and means a nitrogen moiety having two further substituents where, for example, a hydrogen or carbon atom is attached to the nitrogen. For example, representative amino groups include —NH₂, —NHCH₃, —N(CH₃)₂, —NH(aliphatic)-, —N(aliphatic)₂, —NH(aryl)-, —NH(heteroaryl)-, —N(aryl)₂, —N(heteroaryl)₂, —NH(cycloalkyl), —NH(heterocycloalkyl) and the like. The further substituents on the nitrogen can themselves be substituted or unsubstituted and joined to the rest of the molecule. Unless indicated otherwise, the compounds of the invention containing amino moieties may include protected derivatives thereof. Suitable protecting groups for amino moieties include, but are not limited to, acetyl, tert-butoxycarbonyl, benzyloxycarbonyl, and those described under nitrogen protecting groups below. Exemplary protecting groups are detailed in Greene, T. W., Nuts, P. G in “Protective Groups in Organic Synthesis”, Fourth Edition, John Wiley & Sons, New York: 2006, and other editions of this book, the entire contents of which are hereby incorporated by reference.

The term “amide” includes both N-linked (—NHC(═O)R) and C-linked (—C(═O)—NHR) amides.

The term “carbonyl” is intended to mean a carbon atom (C) attached to an oxy (═O) forming a C═O group. Carbonyl groups may optionally be protected by carbonyl protecting groups, wherein “protecting groups” is defined below. Suitable protecting groups include, but are not limited to dioxolanes, dioxanes, and acetals. For example, dimethylacetals, 1,3-dioxolanes, 1,3-dioxanes. Exemplary protecting groups are detailed in Greene, T. W., Nuts, P. G in “Protective Groups in Organic Synthesis”, Fourth Edition, John Wiley & Sons, New York: 2006, and other editions of this book, the entire contents of which are hereby incorporated by reference.

The term “cycloaliphatic”, “carbocycle”, “carbocyclyl” or “cycloalkyl” and the like may be used interchangeably and refer to a monocyclic C₃-C₁₂ hydrocarbon or bicyclic C₆-C₁₂ hydrocarbon that is completely saturated or that contains one or more units of unsaturation which is not aromatic, and has a one or more points of attachment to the rest of the molecule. Cycloaliphatic includes, and is not limited, to bicyclic or tricyclic ring systems, wherein any individual ring in said bicyclic or tricyclic ring system has 3-7 members and may be fused or connected by a bond. Suitable cycloaliphatic groups include, but are not limited to, cycloalkyl and cycloalkenyl groups such as cyclopropyl, cyclobutane, cyclopentane, cyclohexyl, cyclohexene. Examples of bridged cycloaliphatic groups include, but are not limited to, bicyclo[3.3.2]decane, bicyclo[3.1.1]heptane, and bicyclo[3.2.2]nonane. Any carbocycle group may optionally be substituted with one or more substituents selected from aliphatic, amino, (aliphatic)amino, amido, (aliphatic)amido, aryl, (aliphatic)aryl, cyano, carbonyl, heteroatoms (O, N, S, P, wherein the heteroatoms may be further substituted with hydrogen, aliphatic, amino, aryl, heteroaryl, heterocyclyl), hydroxy and thioaliphatic wherein C₁₋₁₀ aliphatic means any independently selected, optionally substituted, branched or straight chain C₁₋₁₀ alkylene, C₂₋₁₀ alkenyl, C₂₋₁₀ alkynyl or C₃₋₁₂ carbocycle.

The terms E or Z are intended to mean the E or Z stereoisomer of the alkene. E means entgegen/opposite and Z means zusammen/together. Such terms are well understood by those of ordinary skill in the art.

The term “film” as used herein is intended to mean a covering or a coating that is applied to a surface. The film may be rigid film or a flexible film.

The term “gel” is intended to mean a polymer network or a non-fluid colloidal network that is expanded throughout its whole volume by a solvent. The gel may contain: a covalent polymer network, for example a network formed by crosslinking polymer chains or by non-linear polymerization or a polymer network formed through the physical interactions or physical aggregation of polymer chains, caused by hydrogen bonding, crystallization, helix formation, complexation, and other physical interactions that are understood by those of skill in the art.

The “glass transition temperature” or “T_{g}” is the temperature at which a liquid or gel undergoes a transition from a liquid-like fluid or semi-fluid/rubber-like state to a hard state to form a glass or a film.

The term “heteroatom” means one or more of oxygen, sulfur, nitrogen, phosphorus, boron and silicon including, any oxidised form of nitrogen, sulfur, phosphorus, or silicon; the quaternised form of any basic nitrogen or; a substitutable nitrogen of a heterocyclic ring, for example N as in 3,4-dihydro-2H-pyrrolyl, NH in pyrrolidinyl or NR+ in N-substituted pyrrolidinyl.

Aliphatic groups that have a C atom replaced with a heteroatom are referred to as “heteroaliphatic”, and as used herein, means aliphatic groups wherein one or two carbon atoms are independently replaced by one or more of oxygen, sulfur, nitrogen, phosphorus, or silicon. Heteroaliphatic groups may be substituted or unsubstituted, branched or un-branched, cyclic or acyclic, and include “heterocycle”, “heterocyclyl”, “heterocycloaliphatic”, or “heterocyclic” groups.

The term “heterocycle”, “heterocyclyl”, or “heterocyclic”, and the like, as used herein means non-aromatic, monocyclic, bicyclic, tricyclic or fused ring in which one or more ring members contain an independently selected heteroatom. In some embodiments, the “heterocycle”, “heterocyclyl”, or “heterocyclic” group has three to ten ring members in which one or more ring members is a heteroatom independently selected from oxygen, sulfur, nitrogen, phosphorus, boron and silicon and each ring in the system contains 3 to 7 ring members. Examples of suitable heterocycles include, but are not limited to, 3-1H-benzimidazol-2-one, 3-(1-alkyl)-benzimidazol-2-one, 2-tetrahydrofuranyl, 3-tetrahydrofuranyl, 2-tetrahydrothiophenyl, 3-tetrahydrothiophenyl, 2-morpholino, 3-morpholino, 4-morpholino, 2-thiomorpholino, 3-thiomorpholino, 4-thiomorpholino, 1-pyrrolidinyl, 2-pyrrolidinyl, 3-pyrrolidinyl, 1-tetrahydropiperazinyl, 2-tetrahydropiperazinyl, 3-tetrahydropiperazinyl, 1-piperidinyl, 2-piperidinyl, 3-piperidinyl, 1-pyrazolinyl, 3-pyrazolinyl, 4-pyrazolinyl, 5-pyrazolinyl, 1-piperidinyl, 2-piperidinyl, 3-piperidinyl, 4-piperidinyl, 2-thiazolidinyl, 3-thiazolidinyl, 4-thiazolidinyl, 1-imidazolidinyl, 2-imidazolidinyl, 4-imidazolidinyl, 5-imidazolidinyl, indolinyl, tetrahydroquinolinyl, tetrahydroisoquinolinyl, benzothiolane, benzodithiane, and 1,3-dihydro-imidazol-2-one.

The term “heteroaryl”, refers to monocyclic or bicyclic ring having a total of five to twelve ring members, wherein at least one ring in the system is aromatic, at least one ring in the system contains one or more heteroatoms, and wherein each ring in the system contains 3 to 7 ring members. The term “heteroaryl” may be used interchangeably with the term “heteroaryl ring” or the term “heteroaromatic”. Suitable heteroaryl rings include, but are not limited to, 2-furanyl, 3-furanyl, N-imidazolyl, 2-imidazolyl, 4-imidazolyl, 5-imidazolyl, benzimidazolyl, 3-isoxazolyl, 4-isoxazolyl, 5-isoxazolyl, 2-oxazolyl, 4-oxazolyl, 5-oxazolyl, N-pyrrolyl, 2-pyrrolyl, 3-pyrrolyl, 2-pyridyl, 3-pyridyl, 4-pyridyl, 2-pyrimidinyl, 4-pyrimidinyl, 5-pyrimidinyl, pyridazinyl (e.g., 3-pyridazinyl), 2-thiazolyl, 4-thiazolyl, 5-thiazolyl, tetrazolyl (e.g., 5-tetrazolyl), triazolyl (e.g., 2-triazolyl and 5-triazolyl), 2-thienyl, 3-thienyl, benzofuryl, benzothiophenyl, indolyl (e.g., 2-indolyl), pyrazolyl (e.g., 2-pyrazolyl), isothiazolyl, 1,2,3-oxadiazolyl, 1,2,5-oxadiazolyl, 1,2,4-oxadiazolyl, 1,2,3-triazolyl, 1,2,3-thiadiazolyl, 1,3,4-thiadiazolyl, 1,2,5-thiadiazolyl, purinyl, pyrazinyl, 1,3,5-triazinyl, quinolinyl (e.g., 2-quinolinyl, 3-quinolinyl, 4-quinolinyl), and isoquinolinyl (e.g., 1-isoquinolinyl, 3-isoquinolinyl, or 4-isoquinolinyl).

The term “hydroxy” or “hydroxyl” may be used interchangeably and mean the presence of a hydroxyl functional group (—OH). The H of the hydroxy may be replaced with an aliphatic group to form an alkoxy group as defined above. Unless indicated otherwise, the compounds of the invention containing hydroxy moieties may include protected derivatives thereof, wherein what is to be encompassed by “protected group” and protected derivative are discussed below. Suitable protecting groups for hydroxy moieties include, but are not limited to, tetrahydropyranyl (THP), methoxymethyl (MOM), tert-butyl (t-Bu), pivalyl (Piv), acetonides, acetals and tert-Butyldiphenylsilyl (TBDPS), tert-butyldimethylsilyl (TBDMS). Exemplary protecting groups are detailed in Greene, T. W., Nuts, P. G in “Protective Groups in Organic Synthesis”, Fourth Edition, John Wiley & Sons, New York: 2006, and other editions of this book, the entire contents of which are hereby incorporated by reference.

The term “hydrazone” means Compounds having the structure R₂C═NNR₂, formally derived from aldehydes or ketones by replacing ═O by ═NNH₂.

The term “hydrazides” means compounds derived from oxoacids by replacing —OH with —NRNR₂ (R groups are commonly H); suitable oxoacids would be understood by those of skill in the art. The term hydrazide includes compounds such as carbohydrazides, —C(═O)NHNH₂; sulfonohydrazides, S(═O)₂NHNH₂; and phosphonic dihydrazides, —P(═O)(NHNH₂)₂, monohydrazides, dihydrazides, trihydrazides and tetrahydrazides.

The term “macrocyclic” for the purposes of this invention refer to species that form a ring or cage structure. The macrocyclic structures formed are denoted as L-A (cyc).

The term “medical composition” is a composition that may be administered to a patient. The composition may be administered orally, parenterally, topically, rectally, nasally, buccally, intravenously, intra-muscularly, intra-dermally, subcutaneously or via an implanted reservoir. The medical composition may deliver an active pharmaceutical ingredient to the patient. The active ingredients include but are not limited to analgesics, anti-infective agents, anti-cancer agents, steroids, hormones, immunosuppressant, anti-psychotic agent. Alternatively, the medical composition may form a film to assist in the healing of a wound, abrasion, laceration, cut, graze, penetration to the skin.

The term “nitrogen protecting group”, as used herein, refers to an agent used to temporarily block one or more desired nitrogen reactive sites in a multifunctional compound. Preferred nitrogen protecting groups also possess the characteristics exemplified above, and certain exemplary nitrogen protecting groups are also detailed in Greene, T. W., Nuts, P. G in “Protective Groups in Organic Synthesis”, Fourth Edition, John Wiley & Sons, New York: 2006, the entire contents of which are hereby incorporated by reference. Examples of suitable nitrogen protecting groups include but are not limited to acetyl (Ac), benzyl (Bn), tert-butoxycarbonyl (BOC), 9-Fluorenylmethyl (FMOC), Tosyl (Ts). Exemplary protecting groups are detailed in Greene, T. W., Nuts, P. G in “Protective Groups in Organic Synthesis”, Fourth Edition, John Wiley & Sons, New York: 2006, and other editions of this book, the entire contents of which are hereby incorporated by reference.

The term “open time” as used herein is intended to mean the time duration that a liquid paint, gel or film can be blended with an additional liquid paints, gels or films and remain free from surface imperfections.

The term “protecting group”, as used herein, means to an agent used to temporarily block one or more desired reactive sites in a multifunctional compound to form a protected derivative. In certain embodiments, a protecting group has one or more, or preferably all, of the following characteristics:
a) reacts selectively in good yield to give a protected substrate that is stable to the reactions occurring at one or more of the other reactive sites; and
b) is selectively removable in good yield by reagents that do not attack the regenerated functional group. Exemplary protecting groups are detailed in Greene, T. W., Nuts, P. G in “Protective Groups in Organic Synthesis”, Fourth Edition, John Wiley & Sons, New York: 2006, and other editions of this book, the entire contents of which are hereby incorporated by reference.

The term “renewable” is intended to mean derived from a natural resource that is readily replenished without significant detrimental environmental impact, for example a plant source, which can be replaced by new plant growth.

The term “saturated”, as used herein, means that a moiety has no units of unsaturation.

The symbol “ [symbol] ” indicate points of attachment of a functional moiety to the remainder of the molecule.

The term “unsaturated”, as used herein, means that a moiety has one or more units of unsaturation.

The term “viscosity” is the measure of a fluid's or gel's resistance to flow due to the friction between neighbouring groups within the fluid or gel moving at different velocities. Such a term would be readily understood by those of skill in the art. For example, fluids that flow freely are of low viscosity, e.g. water; and fluids that are of high viscosity and flow poorly, e.g. tar.

The examples described herein are for purposes of illustrating embodiments of the invention. Other embodiments, methods, and types of analyses are within the capabilities of persons of ordinary skill in the art and need not be described in detail herein. Other embodiments within the scope of the art are considered to be part of this invention.

For purposes of this invention, the chemical elements are identified in accordance with the Periodic Table of the Elements, CAS version, Handbook of Chemistry and Physics, 75th Ed.

Additionally, general principles of organic chemistry are described in texts known to those of ordinary skill in the art, including, for example, “Organic Chemistry”, Thomas Sorrell, University Science Books, Sausalito: 1999, and “March's Advanced Organic Chemistry”, 5th Ed., Ed.: Smith, M. B. and March, J., John Wiley & Sons, New York: 2001, the entire contents of which are hereby incorporated by reference.

### ABBREVIATIONS

AcOH acetic acid
ACN Acetonitrile
ADH or A adipic acid diacylhydrazide
BP boiling point in ° C.
CDCl₃ deuterochloroform
cSt centistokes
DCE 1,2-dichloroethane
DCM methylene chloride
DMAc dimethylacetamide
DMF dimethylformamide
DMSO dimethylsulfoxide
DSC differential scanning calorimetry
ESI electrospray ionisation mass spectrometry
FTIR Fourier transform infrared spectroscopy
HPLC high performance liquid chromatography
LA Levulinic acid
L ethyleneglycol dilevulinyl
L-A (cyc) Macrocyclic structures
MS mass spectrometry or mass spectra
MPG Mono propylene glycol
Mw mass average molecular weight
NMP n-methylpyrollidine
NMR nuclear magnetic resonance
PTSA para-toluene sulfonic acid
SEC size exclusion chromatography
SM Starting material
T_{g} glass transition temperature in ° C.
TMS tetramethylsilane

The present invention relates to polyhydrazones, which are useful in the production of polymers that have properties useful in formulation films for different applications.

### EXPERIMENTAL EXAMPLES

The following examples further illustrate the invention. It is to be appreciated that the invention is not limited to the examples.

### General Procedures

Mass spectra (high and low-resolution MS) were recorded on Q-TOF mass spectrometer. NMR spectra are collected for ¹H and ¹³C at 500 and 125 MHz respectively and are in CDCl₃ unless otherwise stated. Chemical shifts are in ppm from the solvent resonances ¹H NMR δ(ppm) 7.26; ¹³C NMR δ(ppm) 77.08 ppm. Spectra for the calculation of end-group analysis and to assess the solution behaviour of polyhydrazone species were collected in D₂O (the water resonance at 4.7 ppm was used for reference for ¹H NMR). NMR end group analysis was calculated by approximating structures calculating the proportion of unreacted ketone functionality to the total of the number of hydrazone imine carbon species in the ¹³C NMR spectrum. Spectra were run with 10*T1 as delay and irradiation to suppress the nuclear Overhauser effect in order to provide ¹³C spectra suitable for integration. The table below provides guideline composition of end-groups in comparison to molecular weight for the linear species present in the mixture. (A=ADH, L=ethyleneglycol dilevulinyl species formula I-F).

Glass transition temperatures (T_{g}) are measured by differential scanning calorimetry (DSC). Samples were prepared by compressing 2-20 mg of material into a 40 μL pierced aluminium pan and were scanned between −40° and +180° C. at either 10° C./min or 5° C./min. The samples were heated and cooled three times and T_{g} data were obtained from the second and third sweep; ignoring the initial annealing and desolvating sweep. T_{g} were determined by observation of the rate of change of slope and baseline shift for the glass and plastic states.

Molecular weight was also approximated by comparison of retention times of polyethyleneglycol standards using high performance size exclusion chromatography (HPLC-SEC) coupled to a Waters 2410 Refractive Index (RI) detector and Waters 490E multi-wavelength Ultraviolet Visible spectrometer (UV/Vis).

Viscosity was measured on a Haake VT500 Viscometer coupled to a Haake DC5 temperature controller and Haake K20 recirculating glycol bath at 25° C. using a concentric cylinder (system NV) operating from an angular velocity of 27.05 to 2702 1/s measuring viscosity (μ) in mPas. Standard solutions of poly(dimethylsiloxane) (200 fluid, Aldrich) of 5, 50 and 500 cSt were used for reference.

### Synthesis of Demonstrative Levulinyl Polyketone Species

These examples demonstrate films with the following properties (Table 1):

A. Synthesis without production of dioxolane species, and formation of a soft well-adhered film.
B. Water soluble species that form a soft film that hardens with time.
C. Water soluble species but forms very hard shiny film with remarkably low propensity to re-suspend in water.
D. Unstable emulsion that forms a gel immediately on hydrazide addition demonstrating a stable extensively cross-linked network.
E. Unstable emulsion that forms an opaque solution on hydrazide addition and casts shiny hard films with good flex.
F. Clear solution before and after addition of hydrazide that gels immediately but returns to a free-flowing solution and casts flexible shiny films. This also demonstrates the reversible thermosetting behaviour that diminishes over time.

### Ethyleneglycol Dilevulinate (1)

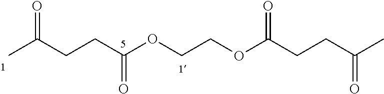 [SMILES: CC(=O)CCC(=O)OCCOC(=O)CCC(C)=O]

To diethylene glycol (5.0 g, 79.8 mmol) is added levulinic acid (SAFC Cat W26,270-6-K, LA, 24.1 g, 207.4 mmol, 1.3 eq), para toluenesulfonic acid (PTSA, 40 mg) and the mixture is heated under reduced pressure (85° C., 20 mBar, 2.5 hr.) before distilling off unreacted LA (135° C., <1 mBar) to recover a pale yellow oil (16.4 g, 80%): ¹H NMR δ(ppm) 2.16 (6H, s, H1), 2.58 (4H, t J=6.7 Hz, H4), 2.62 (4H, t J=6.7 Hz, H3), 4.23 (4H, s, H1′); ¹³C NMR δ(ppm) 27.8 (C4), 29.8 (C1), 37.8 (C3), 62.2 (C1′), 172.5 (C5), 206. (C2); HRMS found 281.1001, C₁₂H₁₈O₆Na [M+Na] calc. for 281.0994.

### Diethyleneglycol Dilevulinate (2)

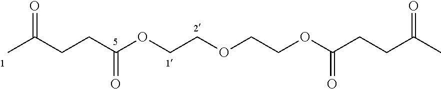 [SMILES: CC(=O)CCC(=O)OCCOCCOC(=O)CCC(C)=O]

To diethylene glycol (7.35 g, 68.6 mmol) is added LA (22.36 g, 192 mmol, 1.4 eq), PTSA (40 mg) and the mixture is heated under reduced pressure (135° C., 20 mBar, 4 hr.) before the pressure is decreased to <1 mBar unreacted LA is removed by distillation to recover a pale yellow oil (20.1 g, 97%): ¹H NMR δ(ppm) 2.16 (6H, s, H1), 2.58 (4H, t J=6.7 Hz, H4), 2.63 (4H, t J=6.7 Hz, H3), 3.67 (4H, m, H2′), 4.21 (4H, m, H1′); ¹³C NMR δ(ppm) 27.9 (C4), 29.8 (C1), 37.9 (C3), 63.7 (C1′), 69.0 (C2′), 172.7 (C5), 206.5 (C2); HRMS found 325.1263, C₁₄H₂₂O₇Na [M+Na] calc. for 325.1263.

### Glycerol Trilevulinate (3)

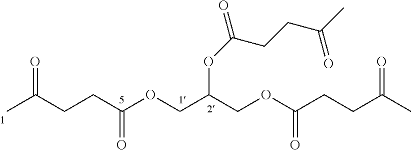 [SMILES: CC(=O)CCC(=O)OCC(COC(=O)CCC(C)=O)OC(=O)CCC(C)=O]

To glycerin (20.9, 54.0 mmol) is added LA (26.3 g, 227 mmol, 1.4 eq), PTSA (40 mg) and the mixture heated under reduced pressure (135° C., 20 mBar, 2 hr.) before decreasing the pressure to <1 mBar unreacted LA is removed by distillation to recover glycerol trilevulinate as a pale yellow oil (18.9 g, 90% with <5% glycerol dilevulinate but no dioxolane species): ¹H NMR δ(ppm) 2.16 (9H, s, H1), 2.57 (6H, m, H4), 2.71 (6H, m, H3), 4.20 (4H, ABX J=11.9_{A-B}, 4.2_{A-X}, 6.0_{B-X} Hz, H1′), 5.22 (1H, ABX, tt, J=6.0, 4.2 Hz, H2′); ¹³C NMR δ(ppm) 27.8 (C4), 29.8 (C1), 37.8 (C3), 62.3 (C1′), 69.2 (C2′), 171.9 (C5-C2′), 172.2 (C5-C1′), 206.3 (C2); HRMS found 387.1646, C₁₈H₂₇O₉ [M+1] calc. for 387.1655.

### Pentaerythritol Dilevulinate (4)

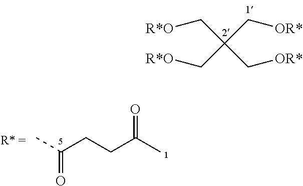

To pentaerythritol (6 g, 43.2 mmol) is added LA (27.1 g, 233 mmol, 1.35 eq) and PTSA (40 mg) and the mixture heated under reduced pressure (135° C., 20 mBar) until the white slurry had formed a uniform solution (15 min) before decreasing the pressure to <1 mBar to drive the reaction to completion and distil off unreacted LA (5 hr.) and recover a pale yellow oil in quantitative yield (23 g): ¹H NMR δ(ppm) 2.16 (12H, s, H1), 2.56 (8H, t, J=6.6 Hz, H4), 2.72 (8H, t, J=6.6 Hz, H-3), 4.09 (8H, s, H1′); ¹³C NMR δ(ppm) 27.8 (C4), 29.7 (C1), 37.9 (C3), 42.1 (C1′), 62.3 (C2′), 172.2 (C5), 206.3 (C2); HRMS found 551.2097, C₂₅H₃₆O₁₂Na [M+Na] calc. for 551.2104.

### Dipentaerythritol Dilevulinate (5)

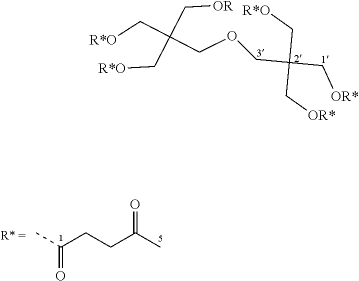

To pentaerythritol (5 g, 19.7 mmol) is added LA (17.1 g, 147 mmol, 125 eq) and PTSA (17 mg). The mixture is heated under reduced pressure (110° C., 20 mBar, 1 hr.) and a further portion of PTSA (40 mg) is added. The temperature is raised (130° C., 30 min) causing the white slurry to form a uniform solution. Increasing the temperature, decreasing the pressure (135° C., 1 mBar, 35 min) and addition of further aliquot of LA completes the reaction to recover an orange oil (14.7 g, 89%): ¹H NMR δ(ppm) 2.16 (18H, s, H1), 2.54 (12H, t, J=6.6 Hz, H4), 2.73 (12H, t, J=6.6 Hz, H-3), 3.39 (4H, brs, H3′), 4.06 (12H, brs, H1′); ¹³C NMR δ(ppm) 27.8 (C4), 29.8 (C1), 37.9 (C3), 43.0 (C2′), 62.6 (C1′), 69.7 (C3′), 172.2 (C5), 206.4 (C2); HRMS found 865.3477, C₄₀H₅₈O₁₉Na [M+Na] calc. for 865.3470.

### Triethanolamine Trilevulinate (6)

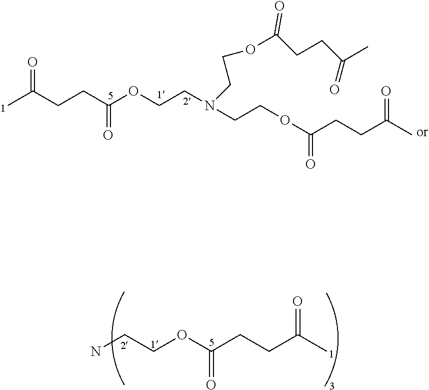

To triethanolamine (50 g, 328 mmol) is added LA (143 g, 1.23 mol, 1.1 eq), PTSA (50 mg) and the biphasic mixture is heated with toluene (150 mL), and rapidly forms a single phase. Azeotropic distillation of the water product over 16 hr. then evaporating to dryness, re-suspending in ethyl acetate ×2 (150 mL), washing with base (NaHCO₃, 3×25 mL), and concentration gives the product as a yellow oil (135 g, 93%): ¹H NMR δ(ppm) 2.17 (9H, s, H1), 2.56 (6H, t J=6.7 Hz, H4), 2.73 (6H, t, J=6.7 Hz, H3), 2.82 (6H, t, J=6.7 Hz, H2′), 4.11 (6H, t, J=6.7 Hz, H1′); ¹³C NMR δ(ppm) 27.9 (C4), 29.8 (C1), 37.9 (C3), 53.5 (C2′), 62.8 (C1′), 172.7 (C5), 206.6 (C2); HRMS found 466.2047, C₂₁H₃₃NO₉ [M+Na] calc. for 466.2053.

### 2,3-Butanediol Dilevulinate (7)

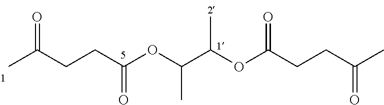 [SMILES: CC(=O)CCC(=O)OC(C)C(C)OC(=O)CCC(C)=O]

To 2,3-butandiol (6 g, 67 mmol) is added LA (21.7 g, 186 mmol, 1.4 eq), PTSA (40 mg) and the mixture heated for 4 hours at 135° C. then under reduced pressure for 1 hour at 135° C. A yellow oil was recovered (7.4 g, 39%): ¹H NMR δ(ppm) 1.18 (6H, d, J=6.4 Hz, H2′), 2.17 (6H, s, H1), 2.56 (4H, t, J=6.7 Hz, H4), 2.72 (4H, t, J=6.7 Hz, H3), 4.96 (2H, m, H1′); ¹³C NMR δ(ppm) 15.0 (C2′) 28.2 (C4), 29.8 (C1), 38.0 (C3), 71.5 (C1′), 172.0 (C5), 206.5 (C2); HRMS found 309.1314, C₁₄H₂₂O₆ [M+Na] calc. for 309.1309.

### 1,4-Dimethanolbenzene Dilevulinate (8)

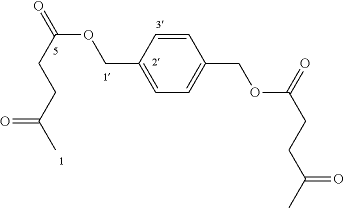 [SMILES: CC(=O)CCC(=O)OCc1ccc(COC(=O)CCC(C)=O)cc1]

To 1,4-dimethanolbenzene (500 mg, 3.6 mmol) is added LA (1.18 g, 10.2 mmol, 1.4 eq), PTSA (6 mg) and the mixture is heated for 1.5 h at 115° C. under reduced pressure. The reaction is diluted with CHCl₃ and washed with water (×2). The organic phase is concentrated under reduced pressure to afford a yellow oil (810 mg, 67% including 5% SM): ¹H NMR δ(ppm) 2.18 (6H, s, H1), 2.63 (4H, t, J=6.7 Hz, H4), 2.76 (4H, t, J=6.7 Hz, H3), 5.11 (s, 4H, H1′), 7.34 (s, 4H, H3′; ¹³C NMR δ(ppm) 28.0 (C4), 29.8 (C1), 37.9 (C3), 66.1 (C1′), 128.3 (C3′), 135.9 (C2′), 172.6 (C5), 206.6 (C2);); HRMS found C₁₈H₂₂O₆ 357.1310 [M+Na] calc. for 357.1314.

### 1,2-Dimethanolbenzene Dilevulinate (9)

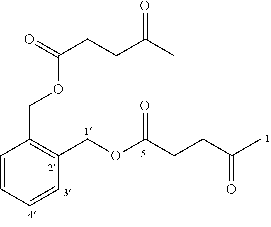 [SMILES: CC(=O)CCC(=O)OCc1ccccc1COC(=O)CCC(C)=O]

To 1,2-dimethanolbenzene (500 mg, 3.6 mmol) is added LA (1.18 g, 10.2 mmol, 1.4 eq), PTSA (6 mg) and the mixture is heated for 1.5 h at 115° C. under reduced pressure. The reaction is diluted with CHCl₃ and washed with water (×2). The organic phase is concentrated under reduced pressure to afford a yellow oil (1.13 g, 93% including 11% SM): ¹H NMR δ(ppm) 2.19 (6H, s, H1), 2.61 (4H, t, J=6.7 Hz, H4), 2.76 (4H, t, J=6.7 Hz, H3), 5.20 (s, 4H, H1′), 7.31-7.41 (m, 4H, H3′ and H4′); ¹³C NMR δ(ppm) 27.9 (C4), 29.8 (C1), 37.9 (C3), 64.0 (C1′), 128.7 (C4′), 129.7 (C3′), 134.4 (C2′), 172.4 (C5), 206.5 (C2);); HRMS found 357.1306, C₁₈H₂₂O₆ [M+Na] calc. for 357.1314.

### General Method for Preparation of a Composition Forming the Polyhydrazone Aqueous Gel

To a solution or dispersion of the polyketone (1 g in 5 mL of distilled water) is added hydrazide (0.9 stoichiometric equivalents of acyl hydrazide moiety compared to ketone functional group). The following observations were made regarding the composition of the initial aqueous polyketone solution, the changes on addition of the hydrazide, the form of the gel and its propensity to form a film when cast into a suitable container and the glass transition temperature as determined by DSC.

| | | Polyhydrazone | | |
|---|---|---|---|---|
| Polyketone | Polyketone in | from 0.9 eq ADH | | |
| compound | water at 20% w/v | addition | Cast material | Tg/° C. |
| (1) | Clear solution | Clear solution | Shiny soft well adhered | 37 |
| | | | film. | |
| (2) | Clear solution | Clear solution | Soft easily marked film that | 27 |
| | | | hardened over 5-days. | |
| (3) | Unstable emulsion | Gels upon | Hard shiny well adhered | 60 |
| | | standing | film that was resistant to | |
| | | | swelling or dissolution in | |
| | | | water at room | |
| | | | temperature. | |
| (4) | Unstable emulsion | Solid gel | No films. Cast as a | 91 |
| | | | permanent solid gel | |
| | | | material. | |
| (5) | Unstable emulsion | Opaque solution | Shiny very hard flexible | 104 |
| | | | film. | |
| (6) | Clear solution | Clear solution | Soft very flexible films with | 38 |
| | | Gels at higher | excellent elasticity and | |
| | | concentrations | shape retention on | |
| | | | deformation. | |
| (7) | Unstable emulsion | Opaque solution | Hard film | 121 |

Typical mass spectrometric analysis of polyhydrazone formed by reaction of (1) with ADH would show the following as representative structures present: L-A(cyc)+H=397.2, L-A(cyc)+Na=419.2, L-A+1=415.2, L-A+Na=437.2, L-A-L+1=655.3, L-A-L+Na=677.3, L-A-L-A(cyc)+Na=815.4, L-A-L-A-L+1=1051.6, L-A-L-A-L+Na=1073.5, L-A-L-A-L-A(cyc)+Na=1211.7

| | | Polyhydrazone | Polyhydrazone |
|---|---|---|---|
| | Polyketone in | from 0.9 eq | from 0.9 eq |
| Polyketone | water at | Formula II-B | Formula II-C |
| compound | 20% w/v | addition | addition |
| (1) | Clear solution | White precipitate | Clear solution |
| | | forms | initially then white |
| | | | precipitate forms |
| (2) | Clear solution | Cloudy solution, gel | Cloudy solution, |
| | | formation | oil forms. |
| (6) | Clear solution | No reaction | Forms white solid |

| Hydrazide | Polyhydrazone in 9:1 ACN/ | Polyhydrazone in 9:1 THF/water |
|---|---|---|
| compound | water at 20% w/v | at 20% w/v |
| Formula | Clear solution | Clear solution |
| II-C | | |
| Formula | White solid formed | White solid formed |
| II-A | | |

| | | Polyhydrazone | Polyhydrazone |
|---|---|---|---|
| | Polyhydrazone | from | from 0.9 eq. |
| Polyketone | from 0.9 eq ADH in | 0.9 eq ADH in | Formula II-C in |
| compound | ACN at 50% w/v | water at 50% w/v | ACN at 50% w/v |
| (7) | Pale yellow solid | Pale yellow gel | Yellow oil |
| | formed | formed | formed |
| (8) | Yellow oil formed | Pale yellow gel | N/A |
| | | formed | |

When the oil of the polyhydrazone formed from (7) and formula II-C is cast, it forms a strong brittle film, T_{g} (initial) 38.5° C.; (annealed) 20° C.

### General Method for Preparation of a Coating System Containing Polyhydrazones

The coating system forms when the mixture of the polyketone and acyl hydrazide (0.9 eq) in a 50% w/v aqueous solution is mixed with an acrylic resin at 30-50% v/v incorporation. This is then used as the resin portion of the formulation outlined below to prepare, upon draw-down, a uniform, water resilient, medium gloss coating with good substrate adhesion.

| | |
|---|---|
| Ingredient | % weight |

LET DOWN:

| | |
|---|---|
| Resin | 42 |
| MPG, defoamer, coalescent, wetting | 7 |
| agent, high/mid sheer rheology modifier, | |
| water | |

MILLBASE:

| | |
|---|---|
| Water | 9 |
| MPG, pH modifier, dispersants, | 6 |
| defoamers, biocides, low sheer rheology | |
| modifier | |
| TiO₂ | 22 |
| CaCO₃ | 2 |
| Diatomaceous earth | 3 |
| Acrylic beads | 3 |

ADD MILLBASE TO LETDOWN

| | |
|---|---|
| Wash MB vat with water | 3 |
| Wetting agents, biocides, defoamers, | 3 |
| MPG, rheology modifiers, silicone | |
| emulsion | |

### REFERENCES

Amarasekara, A. S. and S. A. Hawkins (2011). Synthesis of levulinic acid glycerol ketal ester oligomers and structural characterization using NMR spectroscopy. European Polymer Journal 47(12): 2451-2457.
Chandra, R. and R. Rustgi (1998). “Biodegradable polymers.” Progress in Polymer Science 23(7): 1273-1335.
Chow, C.-F., S. Fujii, et al. (2007). “Metallodynamers: Neutral Dynamic Metallosupramolecular Polymers Displaying Transformation of Mechanical and Optical Properties on Constitutional Exchange.” Angewandte Chemie 119(26): 5095-5098.
Deng, G., F. Li, et al. (2012). “Dynamic Hydrogels with an Environmental Adaptive Self-Healing Ability and Dual Responsive Sol-Gel Transitions.” ACS Macro Letters 1(2): 275-279.
Deng, G., C. Tang, et al. (2010). “Covalent Cross-Linked Polymer Gels with Reversible Sol-Gel Transition and Self-Healing Properties.” Macromolecules 43(3): 1191-1194.
Esser, R. J., J. E. Devona, et al. (1999). “Waterbased crosslinkable surface coatings.” Progress in Organic Coatings 36(1-2): 45-52.
Hachihama, Y. and I. Hayashi (1953). “Studies on the preparation of plasticizers from carbohydrate sources.” Technology reports of the Osaka University 3: 191-200.
Katrizky, A. R., P. Barczynski, et al. (1987). “Mechanisms of heterocycle ring formation. Part 5. A carbon-13 nuclear magnetic resonance study of pyrazolinone synthesis by the reaction of [small beta]-ketoesters with substituted hydrazines.” Journal of the Chemical Society, Perkin Transactions 2 0(8): 969-975.
Kessel, N., D. Illsley, et al. (2008). “The diacetone acrylamide crosslinking reaction and its influence on the film formation of an acrylic latex.” Journal of Coatings Technology and Research 5(3): 285-297.
Leonard, R. (1956). “Levulinic Acid as a Basic Chemical Raw Material.” Industrial & Engineering Chemistry 48(8): 1330-1341.
Lehn, J.-M. (2007). “From supramolecular chemistry towards constitutional dynamic chemistry and adaptive chemistry.” Chemical Society Reviews 36(2): 151-160.
Levrand, B., W. Fieber, et al. (2007). “Controlled Release of Volatile Aldehydes and Ketones from Dynamic Mixtures Generated by Reversible Hydrazone Formation.” Helvetica Chimica Acta 90(12): 2281-2314.
Maeda, T., H. Otsuka, et al. (2009). “Dynamic covalent polymers: Reorganizable polymers with dynamic covalent bonds.” Progress in Polymer Science 34(7): 581-604.
Nakayama, Y. (2004). “Development of novel aqueous coatings which meet the requirements of ecology-conscious society: novel cross-linking system based on the carbonyl-hydrazide reaction and its applications.” Progress in Organic Coatings 51(4): 280-299.
Ono, T., S. Fujii, et al. (2007). “Soft-to-hard transformation of the mechanical properties of dynamic covalent polymers through component incorporation.” Chemical Communications 0(1): 46-48.
Skene, W. G. and J.-M. Lehn (2005). “Dynamers: Polyacylhydrazone reversible covalent polymers, component exchange, and constitutional diversity.” PNAS 101(22): 5.

### INDUSTRIAL APPLICABILITY

The present invention relates to novel waterborne polyhydrazones which are useful in the preparation of coating compositions.

1. A composition having a principle film forming component formed from:
at least one polyketone; and
at least one acyl hydrazide;
wherein, the polyketone comprises at least two levulinic acid moieties.

2. The composition according to claim 1 having a polyketone comprising Formula (I) 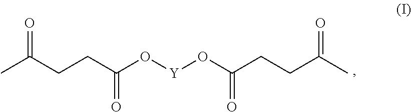
wherein Y is a C₂₋₃₀ alkylene, C₂₋₁₀ alkenyl, C₃₋₁₂ carbocycle or C₅₋₁₂ aryl, wherein any one of the C₂₋₃₀ alkylene, C₂₋₁₀ alkenyl, C₃₋₁₂ carbocycle or C₅₋₁₂ aryl, and wherein Y may be independently optionally substituted with any one or more substituents selected from R;
R is selected from C₁₋₁₀ aliphatic; amino, (C₁₋₁₀ aliphatic)amino; amido; (C₁₋₁₀ aliphatic)amido; aryl; (C₁₋₁₀ aliphatic)aryl; cyano; carbonyl; heteroatoms selected from O, N, S, P, wherein the heteroatoms may be further substituted with hydrogen, aliphatic, amino, aryl, heteroaryl, heterocyclyl, hydroxy, and wherein aliphatic means any independently selected, optionally substituted, branched or straight chain C₁₋₁₀ alkylene, C₂₋₁₀ alkenyl, C₂₋₁₀ alkynyl.

3. The composition according to claim 2, wherein Y is selected from:

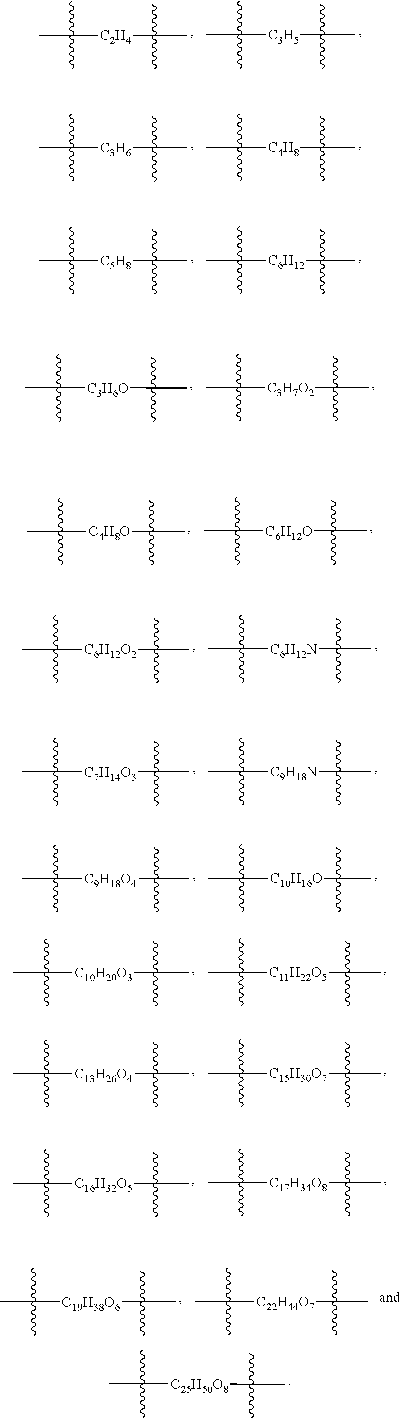

4. The composition according to claim 2 wherein Y of the polyketone is selected from: 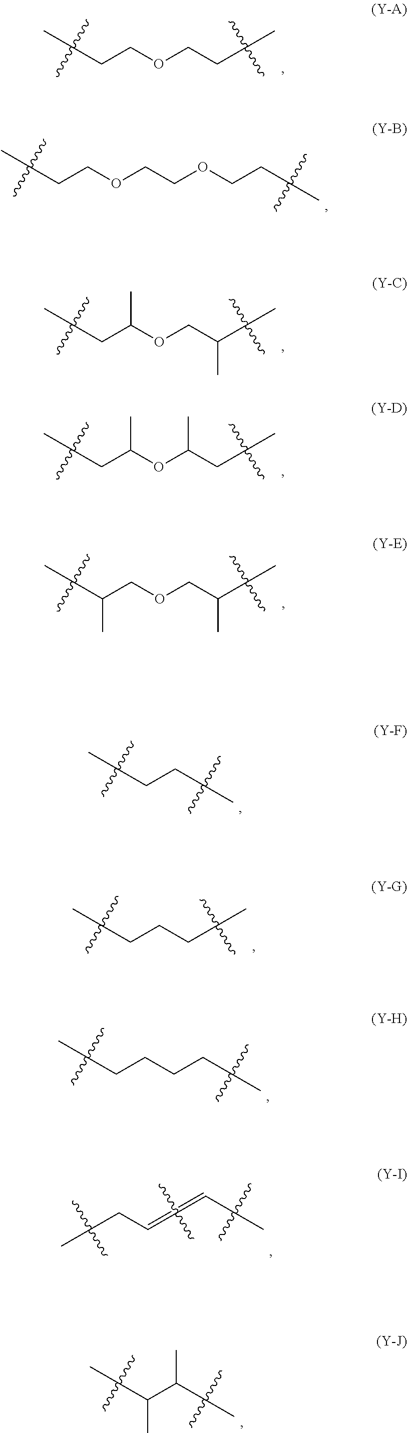 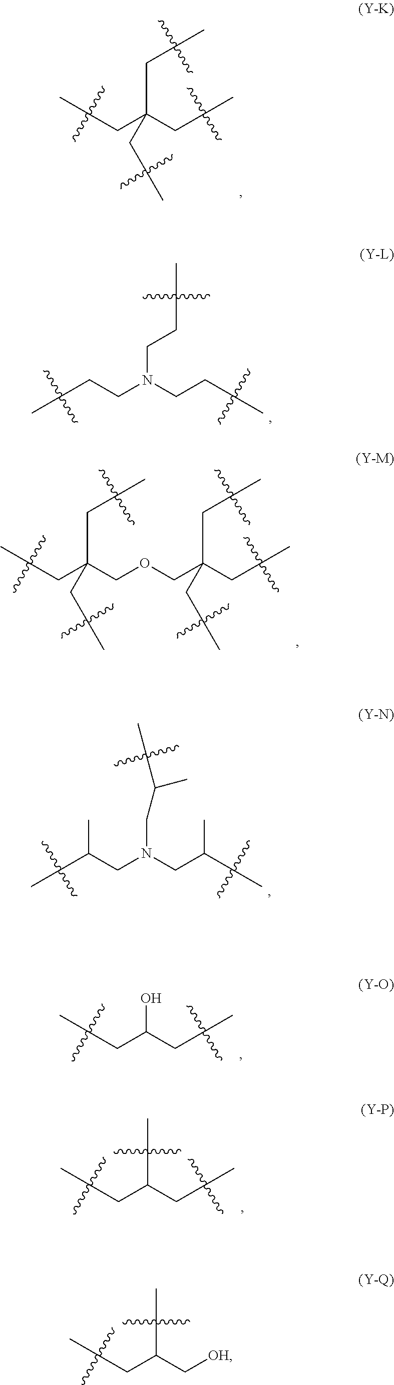 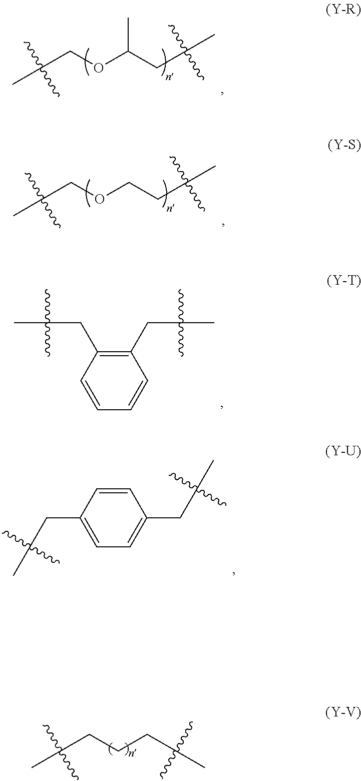
wherein n′ is from 3 to 8 repeating units and 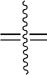
means E or Z carbon-carbon double bond isomers.

5. The composition according to claim 1, wherein the polyketone is a compound selected from: 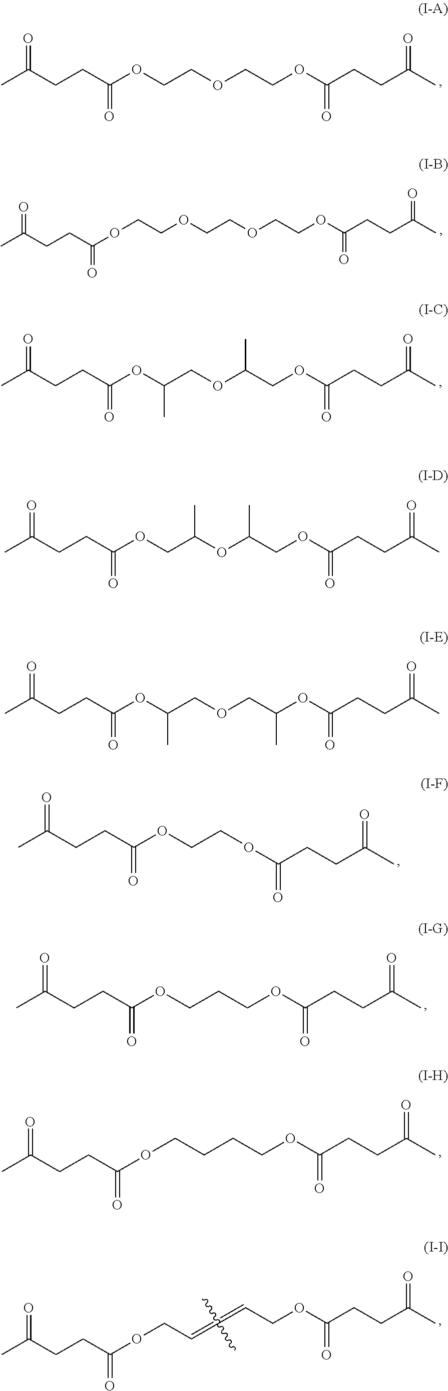 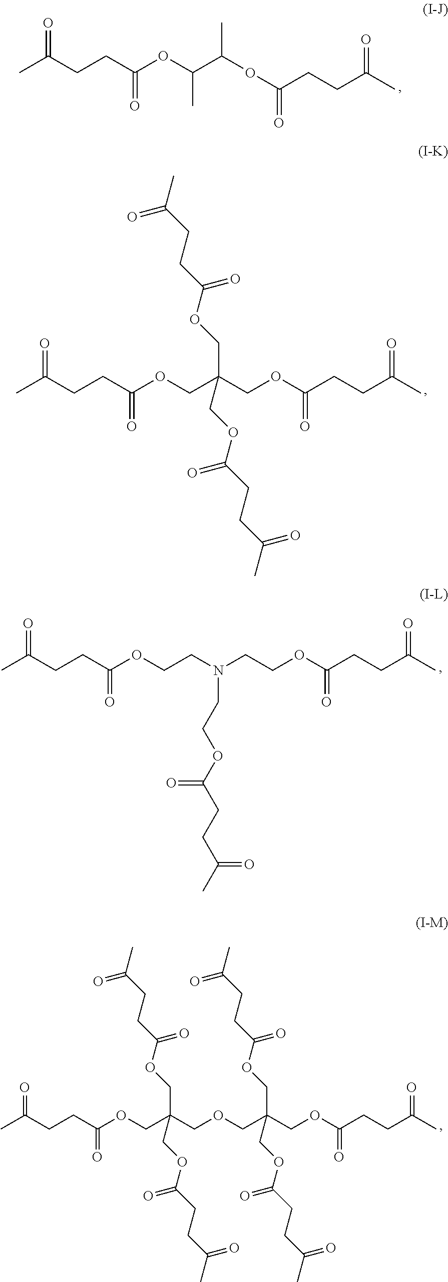 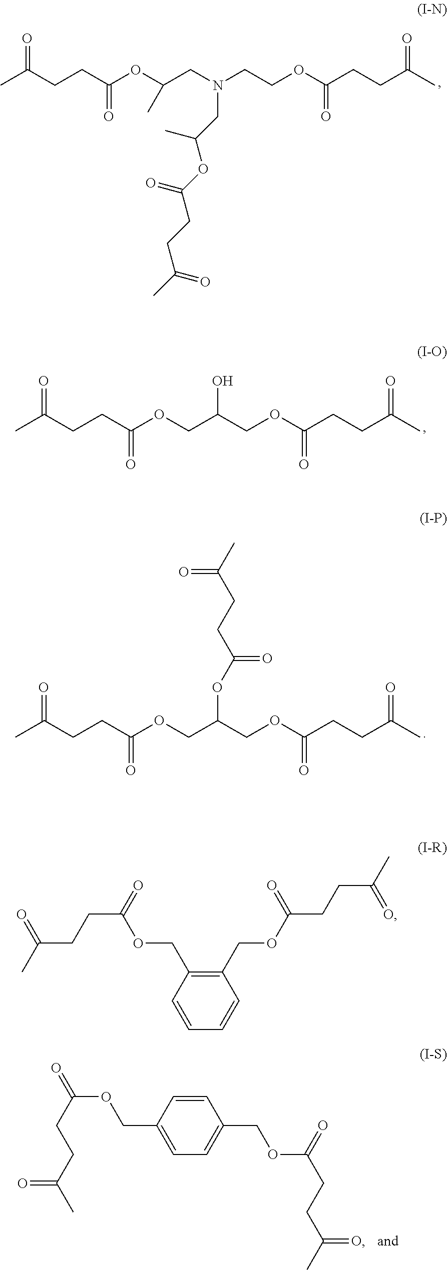 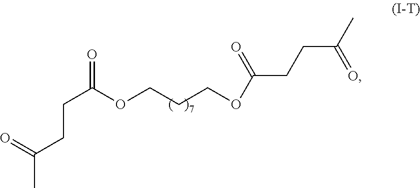
wherein 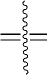
means E or Z carbon-carbon double bond isomers.

6. The composition of claim 1, wherein the acyl hydrazide is of general Formula (II) 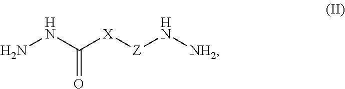
wherein X is absent, or is selected from a branched, straight chain C₁₋₂₀ alkylene, C₂₋₂₀ alkenyl, C₃₋₁₂ carbocycle or C₅₋₁₂ aryl and may be optionally substituted with any one or more substituents selected from R, wherein R is defined in claim 2; and Z is absent or C═O.

7. (canceled)

8. The composition of claim 1, wherein the acyl hydrazide of is selected from:

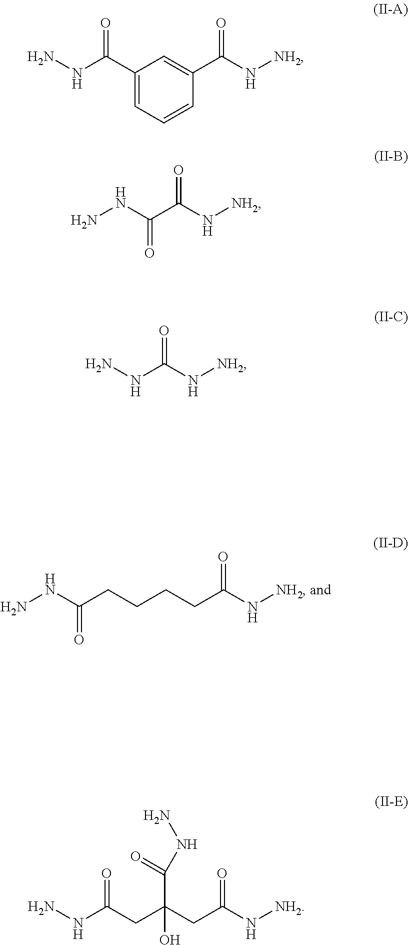 [SMILES: NNC(=O)c1cccc(C(=O)NN)c1 ; NNC(=O)C(=O)NN ; NNC(=O)NN ; NNC(=O)CCCCC(=O)NN ; NNC(=O)CC(O)(CC(=O)NN)C(=O)NN]

9. The composition according to claim 1, wherein the composition comprises a solvent selected from acetonitrile, dioxane, DMSO, DMAc, DMF, diethylene glycol, ethylene glycol, trimethyl-1,3-pentanediol monoisobutyrate, tetrahydrofuran, water or combinations thereof.

10. The composition according to claim 9, wherein the solvent is water.

11. The composition according to claim 9, wherein the composition forms a gel.

12. The composition according to claim 1, wherein the composition comprises a reactive group ratio of acyl hydrazide:
polyketone of about 90:10 to about 10:90.

13. The composition according to claim 1, wherein the composition comprises a reactive group ratio of acyl hydrazide: polyketone of about 47:53.

14. The composition according to claim 1, wherein the polyketone and acyl hydrazide form a polyhydrazone.

15. The composition according to claim 11, wherein the gel is formed in a solution of about 10% w/v to about 80% w/v.

16. The composition according to claim 1, wherein on drying, the composition forms a film when the applied to a surface.

17. The composition according to claim 16, wherein the film has a glass transition temperature (T_{g}) of about 20° C. to about 130° C.

18. The composition according to claim 1, wherein the composition is used as a coating composition.

19. A process for preparing a composition having a principle film forming component formed from wherein, a process comprising contacting:
i) at least one polyketone; and
ii) at least one acyl hydrazide, and
wherein the polyketone comprises at least two levulinic acid moieties.

20. The use of a composition according to claim 1, as a coating material.

21. The use according claim 20, wherein the coating material forms a protective film.

22. The use according to claim 21, wherein the protective film forms at a temperature of about 0° C. to about 80° C. on a surface.

23. A gel having a principle film forming component consisting of:
i) at least one polyketone; and
ii) at least one acyl hydrazide, and
wherein, the polyketone comprises at least two levulinic acid moieties, and wherein the polyketone and acyl hydrazide are defined in any one of claims 2 to 8.

24. A film having a principle film forming component formed from:
i) at least one polyketone; and
ii) at least one acyl hydrazide; and
wherein, the polyketone comprises at least two levulinic acid moieties, and wherein the polyketone and acyl hydrazide are defined in any one of claims 2 to 8.

25. A polyhydrazone compound according to claim 14 comprising structural formula (III): 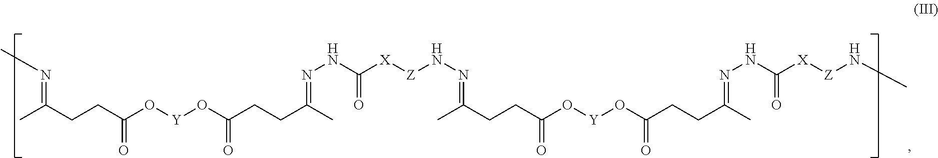
wherein Y, X and Z are defined in any one of claims 2 to 8.

27. The polyhydrazone according to claim 25, wherein the polyhydrazone forms a film.
